(19) United States
(12) Patent Application Publication
(10) Pub. No.: US 2024/0286170 A1
(43) Pub. Date: Aug. 29, 2024

(54) METHODS OF COATING METAL SUBSTRATES AND MAKING METAL PACKAGING, COATED METAL SUBSTRATES, METAL PACKAGING, AND POWDER COATING COMPOSITION SYSTEMS

(71) Applicant: SWIMC LLC, Cleveland, OH (US)

(72) Inventors: Charles I. SKILLMAN, Zelienople, PA (US); Richard D. JOSLIN, Moon Township, PA (US); Joseph DESOUSA, Pittsburgh, PA (US); Kevin M. ROMAGNOLI, Coraopolis, PA (US); Eric Carl STELTER, Lexington, KY (US)

(21) Appl. No.: 18/289,785

(22) PCT Filed: May 19, 2022
(86) PCT No.: PCT/US2022/030120

§ 371 Date: Nov. 7, 2023

Related U.S. Application Data
(60) Provisional application No. 63/190,768, filed on May 19, 2021.

(51) Int. Cl. B05D 7/14; B05C 19/06; B05D 1/00; C09D 5/03

(52) U.S. Cl. CPC B05D 7/14; B05C 19/06; B05D 1/007; C09D 5/031; B05D 2401/32

(57) ABSTRACT

Methods of coating powder coating compositions, particularly metal packaging powder coating compositions, and methods of making a metal packaging container, a portion thereof, or a metal closure for a container, as well as coated substrates and metal packaging, and powder coating composition systems.

### CROSS-REFERENCE TO RELATED APPLICATIONS

The present application claims priority to U.S. Provisional Application Ser. No. 63/190,768, filed on May 19, 2021, which is incorporated herein by reference.

### BACKGROUND

A wide variety of liquid applied coating compositions have been used to provide hardened coatings on the surfaces of metal packaging articles (e.g., food and beverage cans, metal closures). For example, metal cans are sometimes coated with liquid coating compositions using “coil coating” or “sheet coating” operations, i.e., a planar coil or sheet of a suitable substrate (e.g., steel or aluminum metal) is coated with a suitable liquid coating composition, which is subsequently hardened (e.g., cured). The coated substrate then is formed into the can end or body. Alternatively, liquid coating compositions may be applied (e.g., by spraying, dipping, rolling, etc.) to the formed article and then hardened (e.g., cured) to form a continuous coating.

Metal packaging coatings should preferably be capable of high-speed application to the substrate and provide the necessary properties when hardened to perform in this demanding end use. For example, the hardened coating should preferably be safe for food contact, not adversely affect the taste of the packaged food or beverage product, have excellent adhesion to the substrate, resist staining and other coating defects such as “popping,” “blushing” and/or “blistering,” and resist degradation over long periods of time, even when exposed to harsh environments. In addition, the hardened coating should generally be capable of maintaining suitable film integrity during can fabrication and be capable of withstanding the processing conditions to which the can may be subjected during product packaging. The hardened coating should also generally be capable of surviving routine can drop events (e.g., from a store shelf) in which the underlying metal substrate is dented, without rupturing or cracking.

Liquid packaging coatings largely satisfy the needs of the rigid metal packaging market today, but there are some notable disadvantages associated with their use. Liquid coatings contain large volumes of water and/or organic solvents that contribute to shipping costs. Then as the liquid coating composition is applied, a significant amount of energy must be expended, often in the form of burning fossil fuels, to remove the water or solvent during the coating hardening process. Once organic solvent is driven out of the hardening film, it either contributes to Volatile Organic Content (VOC) generation or it must be mitigated by large, energy-consuming, thermal oxidizers. Additionally, these processes can emit significant volumes of carbon dioxide.

One alternative to conventional liquid packaging coatings is the use of laminate coatings. In this process, a laminated or extruded plastic film is adhered to the metal via a heating step. The product is a coated metal substrate that can then be used to produce various food and beverage can parts. The process required to produce laminate films is only compatible with a limited number of thermoplastic materials (e.g., the materials must have the tensile strength required to be stretched into thin films). There is also a limit on the extent to which such films can be stretched, restricting how thin the final coating can be applied on the substrate. There can also be a significant capital investment required to retrofit an existing can-making line to accept laminated steel or aluminum.

Another alternative, powder coating, has seen narrow utility in rigid metal packaging (e.g., powdered side seam stripes for welded can bodies). Its use is limited, however, because the relatively large particle size of traditionally ground powders (greater than 30 microns) is not amenable to the low film thickness required for packaging coatings (typically less than 10 microns). Although smaller particles (e.g., 5 microns) can be formed using grinding/milling techniques, the low molecular weights of these polymeric materials (a limitation of the properties required for such intense grinding) are not believed to be amenable to forming films having the performance standards required of metal packaging coatings needed in the food and beverage industry. For example, U.S. Pat. No. 7,481,884 (Stelter et al.) and U.S. Pat. No. 6,342,273 (Handel et al.) disclose methods for applying powder coatings to a substrate, wherein the powder particles are formed by grinding/milling.

There are methods available to produce finer particle sizes other than mechanical methods such as grinding (i.e., chemically produced powders), but traditional powder application of such fine powders often results in inconsistent or otherwise low-quality films.

What is needed is an improved coating composition for rigid metal packaging applications, which overcomes the above disadvantages associated with conventional liquid, powder, and laminate packaging coating compositions.

### SUMMARY

The present disclosure provides methods of coating powder coating compositions, particularly metal packaging powder coating compositions, on metal substrates, and methods of making a metal packaging container, a portion thereof, or a metal closure for a container, as well as the coated metal substrates, metal packaging. The present disclosure also provides powder coating systems, and methods and apparatus for delivering the powder coating compositions to a coating apparatus used to coat a metal substrate.

In all embodiments, a preferred metal packaging powder coating composition (prior to contact with a metal substrate) comprises: powder polymer particles comprising a polymer having a number average molecular weight of at least 2000 Daltons, wherein the powder polymer particles have a particle size distribution having a D50 of less than 25 microns; and preferably includes (i) one or more charge control agents in contact with the powder polymer particles, and/or (ii) one or more magnetic carrier particles, which may or may not be in contact with the powder polymer particles. The powder polymer particles are preferably chemically produced. The powder polymer particles preferably have a shape factor of 100-140 (e.g., spherical and potato shaped), and more preferably 120-140 (e.g., potato shaped). The powder coating composition preferably includes at least 40 weight percent (wt-%), more preferably at least 50 wt-%, even more preferably at least 60 wt-%, still more preferably at least 70 wt-%, still more preferably at least 80 wt-%, and most preferably at least 90 wt-% of the powder polymer particles, based on the total weight of the powder coating composition.

Powder coating compositions are advantageous over liquid coating compositions, at least because energy costs could be markedly reduced due to the lack of need to volatilize off the liquid carrier, as well as reduced shipping costs due to decreased shipping volume and weight. There are also fewer coating defects, such as blisters, in powder coatings, which can occur due to solvent outgassing during cure.

The present disclosure further provides methods and apparatus for delivering one or more powder coating compositions to a coating apparatus used to coat a metal substrate that can be used to, e.g., make metal packaging, etc. The powder coating compositions can be transported, stored, and dispensed using a sealed cartridge that may be fully enclosed during the filling process as well as during transport, storage, and dispensing to limit unwanted escape of the powder coating composition from the cartridges. The cartridges could be filled at the site where the powder coating is manufactured and then used to transport the powder coating compositions (as needed over, e.g., road/rail/water/air) to facilities where the cartridges are used to dispense the powder coating compositions for use in powder coating processes and equipment. After dispensing the powder coating compositions contained therein, the cartridges can preferably be refilled to reduce waste. In some instances, the cartridges may be returned to the powder coating composition manufacturer where they can be cleaned (if needed) before refilling. Refilling of the cartridges can make the delivery process cyclical to reduce waste associated with delivery of the powder coating compositions. In addition to reducing waste, limiting (or preventing) unwanted escape of the powder coating compositions from cartridges during transport, storage, and dispensing can be beneficial from a worker-exposure standpoint. The small particle sizes of at least some of the powder coating compositions described herein can be an inhalation hazard. Use of the cartridge-based system described herein can limit any such hazards.

In some embodiments, the cartridges used in the cartridge-based delivery systems and methods described herein may be convertible between an expanded configuration (used for delivering and dispensing the powder coating compositions described herein) and a smaller collapsed configuration (used for storage and transport of the cartridges). The smaller collapsed configuration may help reduce the cost of transporting the cartridges for, e.g., refilling, to further reduce the energy needed to transport and use the powder coating compositions described herein (as well as reduce the storage space requirements between uses).

In some embodiments, a method of coating a metal substrate suitable for use in forming metal packaging (e.g., a food, beverage, aerosol, or general packaging container (e.g., can or cup), portion thereof, or metal closure, or pull tab for an easy open end), is provided that includes coating powder on powder. This powder-on-powder coating method includes: providing a metal substrate; providing multiple metal packaging powder coating compositions, wherein each powder coating composition comprises powder polymer particles (preferably, chemically produced powder polymer particles, such as by spray drying or limited coalescence), and at least two of the multiple metal packaging powder coating compositions are different; directing each of the multiple powder coating compositions (preferably using an application process including a conductive or semiconductive transporter (e.g., a metallic drum)) to at least a portion of the metal substrate such that at least one powder coating composition is deposited on another different powder coating composition (prior to or after hardening the one or more different underlying powder coating composition); and providing conditions effective for the multiple powder coating compositions to form a hardened, preferably continuous, adherent coating on at least a portion of the metal substrate.

In some embodiments, a packaging coating system is provided that includes: multiple metal packaging powder coating compositions, wherein at least two of the multiple metal packaging powder coating compositions are different; wherein each powder coating composition comprises powder polymer particles comprising a polymer having a number average molecular weight of at least 2000 Daltons, wherein the powder polymer particles have a particle size distribution having a D50 of less than 25 microns.

In some embodiments, a method of coating a metal substrate suitable for use in forming metal packaging (e.g., a food, beverage, aerosol, or general packaging container (e.g., can or cup), portion thereof, metal closure, or pull tab for an easy open end), is provided that includes forming a patterned coating. This patterned coating method includes: providing a metal substrate; providing a metal packaging powder coating composition, wherein the powder coating composition comprises powder polymer particles (preferably, chemically produced powder polymer particles, such as by spray drying or limited coalescence); selectively applying the powder coating composition (preferably using an application process including a conductive or semiconductive transporter) on at least a portion of the metal substrate to form a patterned coating; and providing conditions effective for the powder coating composition to form a hardened adherent patterned coating (which may or may not be continuous) on at least a portion of the metal substrate.

In some embodiments, coated metal substrates and metal packaging (e.g., a metal packaging container such as a food, beverage, aerosol, or general packaging container (e.g., can or cup), a portion thereof, a metal closure, or pull tab) are provided that include such coated metal substrates having a surface at least partially coated with a coating prepared by the powder-on-powder and/or patterned coating methods described herein.

In some embodiments, a method of making metal packaging (e.g., a metal packaging container such as a food, beverage, aerosol, or general packaging container (e.g., can or cup), a portion thereof, or a metal closure such as for a metal packaging container or a glass jar) in one location and/or in one continuous manufacturing line or process is provided. The method comprises: providing a metal substrate; providing a metal packaging powder coating composition, wherein the powder coating composition comprises powder polymer particles (preferably, chemically produced powder polymer particles, such as those prepared by spray drying or limited coalescence); directing the powder coating composition (preferably using an application process including a conductive or semiconductive transporter) to at least a portion of the metal substrate; providing conditions effective for the powder coating composition to form a hardened, preferably continuous, adherent coating on at least a portion of the metal substrate; and forming the at least partially coated metal substrate into at least a portion of a metal packaging container (e.g., a food, beverage, aerosol, or general packaging container (e.g., can or cup)), a portion thereof, or a metal closure (e.g., for a metal packaging container or a glass jar). Such method may involve forming a patterned coating. Such method may involve using multiple different metal packaging powder coating compositions.

Herein, “metal packaging” coating compositions refer to coating compositions that are suitable for coating on rigid metal directly, or indirectly on a pre-treatment layer or a primer layer that is not derived from a free-standing film (i.e., a film formed before being applied to another substrate, such as by lamination) overlying a substrate. Although the metal packaging coating compositions of the present disclosure are particularly useful on a food-contact surface of a metal substrate, they may also be useful on other types of substrates for packaging foods, beverages, or other products such as glass (e.g., glass bottles), rigid and flexible plastic, foil, paper, paperboard, or substrates that are a combination thereof. Metal packaging typically does not include a free-standing plastic film of at least 10 microns thick, paper or other fibrous material, or metal foil, which is then applied (e.g., adhered) to rigid metal packaging). Thus, by way of example, a powder coating composition applied either to a paper layer overlying a metal substrate, or to a laminated plastic layer overlying a metal substrate, is not a metal packaging coating composition as used herein.

The particle sizes referred to herein may be determined by laser diffraction particle size analysis for starting materials (e.g., primary polymer particles, charge control agents, lubricants, etc.), using a Beckman Coulter LS 230 Laser Diffraction Particle Size Analyzer or equivalent, calibrated as recommended by the manufacturer.

The “D-values”—D50, D90, D95, and D99—are the particle sizes which divide a sample's volume into a specified percentage when the particles are arranged on an ascending particle size basis. For example, for particle size distributions the median is called the D50 (or ×50 when following certain ISO guidelines). The D50 is the particle size in microns that splits the distribution with half above and half below this diameter. The Dv50 (or Dv0.5) is the median for a volume distribution. The D90 describes the particle size where ninety percent of the distribution has a smaller particle size and ten percent has a larger particle size. The D95 describes the particle size where ninety five percent of the distribution has a smaller particle size and five percent has a larger particle size. The D99 describes the particle size where ninety nine percent of the distribution has a smaller particle size and one percent has a larger particle size. Unless specified otherwise herein, particle size of a particular material refers to the D50, and the D50, D90, D95, and D99 refer to Dᵥ50, Dᵥ90, Dᵥ95, and Dᵥ99, respectively. The D-values specified herein may be determined by laser diffraction particle size analysis.

A “powder coating composition” refers to a composition that includes powder particles and does not include a liquid carrier, although it may include trace amounts of water or an organic solvent that may have been used in the preparation of the powder particles. The powder coating composition is typically in the form of finely divided free-flowing powder polymer particles, which may or may not be in the form of agglomerates. The powder coating composition (prior to contact with a metal substrate) may or may not include one or more charge control agents, one or more magnetic carriers in the form of particles (i.e., magnetic carrier particles), or both.

The phrase “metal packaging powder coating composition” does not imply that metal is necessarily included in the coating composition. That is, the term “metal,” as used in the context of a metal packaging coating composition, refers to the type of packaging and does not require the presence of any metal in the coating composition.

Herein, an agglomerate (or cluster) is an assembly of particles, the latter of which are referred to as primary particles.

A “hardened” coating refers to one wherein particles are covalently cured via a crosslinking reaction (e.g., a thermoset coating) or the particles are simply fused in the absence of a crosslinking reaction (e.g., a thermoplastic coating), and adhered to a metal substrate, thereby forming a coated metal substrate. The term “hardened” does not imply anything related to the relative hardness or softness (Tg) of a coating. The term “hardened” also does not refer to powder simply being dusted on a substrate.

An “adherent” coating refers to a hardened coating that adheres (i.e., bonds) to a substrate, such as a metal substrate, preferably according to the Adhesion Test described in the Test Methods. Preferably, an adhesion rating of 9 or 10, preferably 10, is considered to be adherent.

A “continuous” coating refers to a hardened coating that is free of coating defects (preferably, free of pinholes) that result in exposed substrate (i.e., regions of the substrate exposed through the hardened coating). Such film imperfections/failures are preferably indicated by a current flow measured in milliamps (mA) using the Flat Panel Continuity Test described in the Test Methods. For purposes of this application, a continuous coating preferably passes less than 200 mA when evaluated according to this test. A continuous coating may be an all-over coating, completely covering the substrate, or it may only cover parts of the substrate, e.g., as in a patterned coating.

A “patterned” coating (i.e., a multi-portion coating) refers to a hardened coating printed in two or more regions on a substrate surface, which may or may not have “blank” regions between and/or surrounding the printed (i.e., coated) regions, wherein “blank” regions have no coating thereon. A “patterned” coating refers to any coating having one or more of the following: (i) two or more hardened coating portions of a same chemical composition, which are not directly contiguous, disposed on different regions of a same substrate surface and present in a same overall multi-portion coating; (ii) two or more hardened coating portions of different chemical compositions (e.g., having different color, gloss level, etc.) disposed on different regions of a same substrate surface and present in a same overall multi-portion coating; or (iii) two or more hardened coating portions of a same chemical composition of different thicknesses or textures, which may or may not be directly contiguous, disposed on different regions of a same substrate surface and present in a same overall multi-portion coating. A patterned coating is distinct from an all-over coating (i.e., a conventionally applied liquid or powder coating with substantially uniform/homogeneous coating (with inherent thickness variation resulting from the conventional coating process) that typically covers an entire surface of a substrate). This definition of a patterned coating also excludes: (a) a substrate coated at only the edges; (b) a substrate coated everywhere but the edge; and (c) a coating that does not exhibit any of (i), (ii), or (iii). The patterned coating may include a regular or irregular pattern of coated regions, which may be in a variety of shapes (e.g., stripes, diamonds, squares, circles, ovals). The terms “pattern” and “patterned” does not require any repetition in design elements, although such repetition may be present. The coated regions of the patterned coating are preferably “continuous” as defined above (in the areas intended to be coated by the pattern), in that they are free of pinholes and other coating defects that result in exposed substrate if an underlying coating is not present.

The term “substantially free” of a particular component means that the compositions or hardened coatings of the present disclosure contain less than 1,000 parts per million (ppm) of the recited component, if any. The term “essentially free” of a particular component means that the compositions or hardened coatings of the present disclosure contain less than 100 parts per million (ppm) of the recited component, if any. The term “essentially completely free” of a particular component means that the compositions or hardened coatings of the present disclosure contain less than 10 parts per million (ppm) of the recited component, if any. The term “completely free” of a particular component means that the compositions or hardened coatings of the present disclosure contain less than 20 parts per billion (ppb) of the recited component, if any. The preceding terms of this paragraph when used with respect to a composition or hardened coating that may contain a recited component, if any, means that the composition or hardened coating contains less than the pertinent ppm or ppb maximum threshold for the component regardless of the context of the component in the composition or hardened coating (e.g., regardless of whether the compound is present in unreacted form, in reacted form as a structural unit of another material, or a combination thereof).

The term “bisphenol” refers to a polyhydric polyphenol having two phenylene groups that each include six-carbon rings and a hydroxyl group attached to a carbon atom of the ring, wherein the rings of the two phenylene groups do not share any atoms in common. By way of example, hydroquinone, resorcinol, catechol, and the like are not bisphenols because these phenol compounds only include one phenylene ring.

The term “food-contact surface” refers to a surface of an article (e.g., a food or beverage can) intended for prolonged contact with food product. When used, for example, in the context of a metal substrate of a food or beverage container (e.g., can), the term generally refers to an interior metal surface of the container that would be expected to contact food or beverage product in the absence of powder coating composition applied thereon. By way of example, a base layer, intermediate layer, and/or polymer top-coat layer applied on an interior surface of a metal food or beverage can is considered to be applied on a food-contact surface of the can.

The term “on,” when used in the context of a coating applied on a surface or substrate, includes both coatings applied directly (e.g., virgin metal or pre-treated metal such as electroplated steel) or indirectly (e.g., on a primer layer) to the surface or substrate. Thus, for example, a coating applied to a pre-treatment layer (e.g., formed from a chrome or chrome-free pretreatment) or a primer layer overlying a substrate constitutes a coating applied on (or disposed on) the substrate.

The terms “polymer” and “polymeric material” include, but are not limited to, organic homopolymers, copolymers, such as for example, block, graft, random and alternating copolymers, terpolymers, etc., and blends and modifications thereof. Furthermore, unless otherwise specifically limited, the term “polymer” shall include all possible geometrical configurations of the material. These configurations include, but are not limited to, isotactic, syndiotactic, and atactic symmetries.

The term “aryl group” (e.g., an arylene group) refers to a closed aromatic ring or ring system such as phenylene, naphthylene, biphenylene, fluorenylene, and indenyl, as well as heteroarylene groups (e.g., a closed aromatic or aromatic-like ring hydrocarbon or ring system in which one or more of the atoms in the ring is an element other than carbon (e.g., nitrogen, oxygen, sulfur, etc.)). Suitable heteroaryl groups include furyl, thienyl, pyridyl, quinolinyl, isoquinolinyl, indolyl, isoindolyl, triazolyl, pyrrolyl, tetrazolyl, imidazolyl, pyrazolyl, oxazolyl, thiazolyl, benzofuranyl, benzothiophenyl, carbazolyl, benzoxazolyl, pyrimidinyl, benzimidazolyl, quinoxalinyl, benzothiazolyl, naphthyridinyl, isoxazolyl, isothiazolyl, purinyl, quinazolinyl, pyrazinyl, 1-oxidopyridyl, pyridazinyl, triazinyl, tetrazinyl, oxadiazolyl, thiadiazolyl, and so on. When such groups are divalent, they are typically referred to as “arylene” or “heteroarylene” groups (e.g., furylene, pyridylene, etc.).

The term “phenylene” as used herein refers to a six-carbon atom aryl ring (e.g., as in a benzene group) that can have any substituent groups (including, e.g., halogens (which are not preferred), hydrocarbon groups, oxygen atoms, hydroxyl groups, etc.). Thus, for example, the following aryl groups are each phenylene rings: —C₆H₄—, —C₆H₃(CH₃)—, and —C₆H(CH₃)₂Cl—. In addition, for example, each of the aryl rings of a naphthalene group are phenylene rings.

The term “multiple” or “multi” means two or more of the referenced item (e.g., material, component, composition, coating portion).

In the context of powder coating compositions, “different” means that the powder coating compositions are different (i.e., dissimilar) in one or more chemical/physical ways (e.g., monomer types/amounts, molecular weight of polymer, color of coating composition, additive types/amounts) thereby providing one or more different functions (e.g., hardness, flexibility, corrosion resistance, aesthetic, tactile).

The term “cartridge” is a powder coating composition container, which is distinct from a food or beverage packaging container, and is not limited by size or shape.

Herein, the term “comprises” and variations thereof do not have a limiting meaning where these terms appear in the description and embodiments. Such terms will be understood to imply the inclusion of a stated step or element or group of steps or elements but not the exclusion of any other step or element or group of steps or elements. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially, and derivatives thereof).

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure.

In this application, terms such as “a,” “an,” and “the” are not intended to refer to only a singular entity, but include the general class of which a specific example may be used for illustration. The terms “a,” “an,” and “the” are used interchangeably with the term “at least one” and “one or more” and include one, two, three, etc., including all of the items these terms modify. The phrases “at least one of” and “comprises at least one of” as well as “one or more” and “comprises one or more” followed by a list refers to any of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

Also herein, all numbers are assumed to be modified by the term “about” and in certain embodiments, preferably, by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, 5, etc.) and any sub-ranges (e.g., 1 to 5 includes 1 to 4, 1 to 3, 2 to 4, etc.).

As used herein, the term “room temperature” refers to a temperature of 20° C. to 25° C.

The term “in the range” or “within a range” (and similar statements) includes the endpoints of the stated range.

Reference throughout this specification to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout this specification are not necessarily referring to the same embodiment of the disclosure. Furthermore, the particular embodiments, including features, configurations, compositions, or characteristics may be combined in any suitable manner in one or more embodiments.

The above summary of the present disclosure is not intended to describe each disclosed embodiment or every implementation of the present disclosure. The description and figures that follow more particularly exemplify illustrative embodiments. In several places throughout the application, guidance is provided through lists of examples, which examples may be used in various combinations. In each instance, the recited list serves only as a representative group and should not be interpreted as an exclusive list. Thus, the scope of the present disclosure should not be limited to the specific illustrative structures described herein, but rather extends at least to the structures described by the language of the embodiments, and the equivalents of those structures. Any of the elements that are positively recited in this specification as alternatives may be explicitly included in the embodiments or excluded from the embodiments, in any combination as desired. Although various theories and possible mechanisms may have been discussed herein, in no event should such discussions serve to limit the claimable subject matter.

### BRIEF DESCRIPTION OF THE DRAWINGS

FIG. 1A is a scanning electron microscope (SEM) image of conventional milled polyester powder coating particles, which are too large and too angular for use in electromagnetic fields.

FIGS. 1B and 1C are SEM images of chemically produced polymer particles.

FIGS. 1D, 1E, and IF are examples of prior art processes used to manufacture chemically produced polymer particles.

FIG. 2 is a schematic of a Spray Drying Apparatus (figure reproduced from Büchi B290 spray dryer product literature, BÜCHI Labortechnik AG, Flawil, Switzerland).

FIGS. 3A,3B, 3C, 3D, and 3E are line drawings of application devices capable of delivering a powder coating composition to a substrate.

FIG. 4A to 4B are schematic diagrams of illustrative embodiments of application systems including multiple application devices as described herein.

FIG. 5 is a schematic diagram of one illustrative system of transporting, storing, and dispensing the powder coating compositions as described herein.

FIG. 6 depicts one illustrative embodiment of a stacked pair of cartridges containing a powder coating composition as described herein.

FIG. 7 depicts one illustrative embodiment of a cartridge as described herein during filling of the cartridge.

FIG. 8 depicts one illustrative embodiment of a cartridge as described herein with a discharge tube connected to the dispensing port of the cartridge.

FIG. 9 depicts one illustrative embodiment of a set of stacked convertible cartridges in the collapsed configuration as described herein.

FIG. 10 depicts one illustrative embodiment of a convertible cartridge during cleaning of the cartridge in its expanded configuration.

FIG. 11 provides schematics of representative examples of assemblies that include multilayer coatings in the rigid metal packaging industry.

FIG. 12 is a schematic of an electrographic patterned coating on a food or beverage can end.

FIG. 13 is a schematic of an electrographic patterned coating on a lug cap.

FIG. 14 is a schematic of an indexed variable thickness coating.

FIG. 15 is a representation of an all-in-one-location method.

### DETAILED DESCRIPTION OF ILLUSTRATIVE EMBODIMENTS

The present disclosure provides methods of coating powder coating compositions (i.e., coating compositions), particularly metal packaging powder coating compositions, on metal substrates, and methods of making a metal packaging container, a portion thereof, or a metal closure for a container, as well as the coated metal substrates and metal packaging. The present disclosure also provides powder coating composition systems (e.g., systems containing multiple different powder coating compositions) used to achieve different colors, different coating performance properties, etc.

Such methods can be referred to as electrographic powder coating (EPC) processes. In an EPC process, an electrically charged fine powder, and typically a triboelectrically charged fine powder, is applied to a substrate. EPC processes typically use a conductive or semiconductive transporter for the electrically charged fine powder and move the electrically charged powder from the transporter utilizing an electric or electromagnetic field directly to the substrate, or to another imaging member, or to a series of imaging members, and ultimately to the substrate. Electrography includes: electrophotography or xerography, which prints a latent electrostatic image on a photoconductor; ionography, which prints a latent electrostatic image written by an ion head on an insulative or semiconductive imaging member; electrostatic master printing, which prints on portions of a drum or belt that are electrically biased and/or debossed to attract charged powder; electrostatic screen printing, in which charged powder is printed through a screen; electrostatic stencil printing, in which charged powder is printed through a stencil; and electrostatic bias development of powder from the conductive or semiconductive transporter to form a uniform powder layer on the substrate.

Electrographic powder coating methods can deposit the powder onto the substrate, with or without using an intermediate transfer member or transfuser in a final process step. For transfer of particles, the final process for applying the particles to the substrate is typically performed with an electric field. For transfusion of particles, the final process for applying the particles to the substrate is typically performed with heat, and possibly also with an electric field, as described, for example, in U.S. Pat. No. 6,650,860 (Brodin et al.).

A conductive or semiconductive transporter typically includes a metallic roller, polymeric conductive roller, polymeric semiconductive roller, metallic belt, polymeric conductive belt, or polymeric semiconductive belt. In general, a conductive or semiconductive transporter is any member that can be utilized to transport a powder coating composition and can be utilized to apply an electric field or electromagnetic field to move powder particles from the transporter. The conductive or semiconductive transporter can have an insulative or semiconductive coating on all of its surface or on a portion of its surface. The conductive or semiconductive transporter can be conductive or semiconductive on its entire surface or only on a portion of its surface. The transporter may contain permanent magnets that are stationary or that rotate.

Examples of materials that can be used to form conductive or semiconductive transporters include metals as well as filled organic polymers (such as polyurethane or polyimide), as described in U.S. Pat. No. 5,707,743 (Janes et al.) and U.S. Pat. No. 5,434,653 (Takizawa et al.).

An intermediate transfer member can be in the form of a thin flexible belt or an elastomeric belt or an elastomeric roller. In general, an intermediate transfer member is any member that can be utilized to transport a powder coating composition and can also be utilized to apply an electric field or electromagnetic field to move powder particles to the substrate. Compliant rollers or belts with one or more compliant backup rollers are preferably used. The electric or electromagnetic field used for transfer of the charged particles can be applied from electrodes in the compliant roller, in the belt, or in the one or more backup rollers. Compliance and semiconductive characteristics are needed for components of the intermediate transfer system so that the electric or electromagnetic field for transfer does not exceed the breakdown voltage for air of approximately 3 Volts/micron when the transfer member is being brought into contact with the substrate.

Consequently, a large variety of materials can be used for intermediate transfer members. For the configuration using a thin, flexible belt, an insulating or semiconductive polymeric material can be used, such as polyimide or filled polyimide, with a compliant semiconductive backing roller or rollers. For the configuration using a compliant elastomeric belt on a conductive metal belt, or a compliant elastomeric roller blanket on a conductive metal core, semiconductive elastomers are used, such as polyurethane or silicone rubber filled with conductive particles, antistatic agents, or charge control agents. All of the intermediate transfer members in these configurations can have a non-conductive or semiconductive coating that functions as a release layer and often contains a fluorocarbon. Release agents can also be incorporated directly into the compliant polymeric material. Conversely, the base material of the intermediate transfer member can be a fluorinated polymer.

U.S. Pat. No. 5,370,961 (Zaretsky et al.) describes a transfer intermediate (i.e., intermediate transfer member) that can be used, which has a base having a Youngs modulus of 10⁷ Newtons/m² or less and a thin overcoat or skin which has a Youngs modulus of 5×10⁷ Newtons/m² or more. The surface of the intermediate transfer member preferably has a roughness average equal to 20% or less of the mean diameter of the toner particles. A transfer roller or drum can be used that has a relatively thick layer of filled or doped polyurethane, for example, 0.6 cm thick, containing an appropriate amount of antistatic material to make it of at least intermediate conductivity, formed on an aluminum base. For positively charged particles on an imaging member at 0 volts, an electrical bias applied to the intermediate transfer drum of typically −400 to −1,000 volts will effect substantial transfer of the charged particles to the transfer drum. To then transfer the toner image onto a substrate, a bias, for example, of −3,000 volts or less and pressure of 20 psi or 138 kPa can be supplied to urge the positively charged particles to transfer to the substrate. For this example, the intermediate drum has a 0.2-inch (0.5-cm) polyurethane base on an aluminum core. The polyurethane base can be overcoated with a 5-micron coating of a hard urethane resin sold under the tradename PERMUTHANE by Permuthane, Inc., a division of ICI, Inc., and having a Young's modulus of 10⁸ Newtons per square meter and a volume resistivity of approximately 10¹² ohm-cm or 10¹⁰ ohm-m.

U.S. Pat. No. 4,729,925 (Chen et al.), U.S. Pat. No. 5,212,032 (Wilson et al.), U.S. Pat. No. 5,978,639 (Masuda et al.), U.S. Pat. No. 8,668,976 B2 (Wu et al.), and U.S. Pat. No. 10,125,218 (Wu et al.) describe compositions, overcoats, conductive urethanes, polyimides, and silicone rubbers, as well as other characteristics of intermediate transfer members.

An electric field results in a force on an electrically charged object. Electric fields result from electric charges, voltage differences in space, and time-varying magnetic fields. An electromagnetic field is an electric field with a magnetic field. Magnetic fields result from electric currents, permanent magnet materials, subatomic particle spins, and time-varying electric fields.

Examples of metal packaging containers include food, beverage, aerosol, and general metal packaging containers. Examples of metal closures include twist-off caps or lids with threads or lugs and crowns that are crimped on bottles. Such closures are metal but useful on metal or non-metal packaging containers. Metal packaging also includes pull tabs for an easy open can ends.

The metal packaging powder coating compositions are particularly useful on food-contact surfaces of such metal packaging containers and metal closures, but may also be used on exterior surfaces of such metal packaging containers and metal closures. Although the metal packaging powder coating compositions of the present disclosure are particularly useful on a food-contact surface of a metal substrate, they may also be useful on other types of substrates for packaging foods, beverages, or other products such as glass (e.g., glass bottles), rigid and flexible plastic, foil, paper, paperboard, or substrates that are a combination thereof.

The resultant coated food-contact surfaces of metal packaging containers and metal closures of the present disclosure are particularly desirable for packaging liquid-containing products. Packaged products that are at least partially liquid in nature (e.g., wet) place a substantial burden on coatings due to intimate chemical contact with the coatings. Such intimate contact can last for months, or even years. Furthermore, the coatings may be required to resist pasteurization or cooking processes during packaging of the product. In the food or beverage packaging realm, examples of such liquid-containing products include beer, alcoholic ciders, alcoholic mixers, wine, soft drinks, energy drinks, water, water drinks, coffee drinks, tea drinks, juices, meat-based products (e.g., sausages, meat pastes, meat in sauces, fish, mussels, clams, etc.), milk-based products, fruit-based products, vegetable-based products, soups, mustards, pickled products, sauerkraut, mayonnaise, salad dressings, and cooking sauces.

Many coatings that are used to package dry products do not possess the stringent balance of coating properties necessary for use with the above “wet” products. For example, it would not be expected that a coating used on the interior of a decorative metal tin for individually packaged cookies would exhibit the necessary properties for use as an interior soup can coating.

Although containers of the present disclosure may be used to package dry powdered products that tend to be less aggressive in nature towards packaging coatings (e.g., powdered milk, powdered baby formula, powdered creamer, powdered coffee, powdered cleaning products, powdered medicament, etc.), due to the higher volumes in the marketplace, more typically the coatings will be used in conjunction with more aggressive products that are at least somewhat “wet” in nature. Accordingly, packaging coatings formed from powder coating compositions of the present disclosure are preferably capable of prolonged and intimate contact, including under harsh environmental conditions, with packaged products having one or more challenging chemical features, while protecting the underlying metal substrate from corrosion and avoiding unsuitable degradation of the packaged product (e.g., unsightly color changes or the introduction of odors or off flavors). Examples of such challenging chemical features include water, acidity, fats, salts, strong solvents (e.g., in cleaning products, fuel stabilizers, or certain paint products), aggressive propellants (e.g., aerosol propellants such as certain dimethyl-ether-containing propellants), staining characteristics (e.g., tomatoes), or combinations thereof.

Accordingly, preferably, the metal packaging powder coating compositions, and preferably, the hardened coatings, of the present disclosure are substantially free of each of bisphenol A, bisphenol F, and bisphenol S; the powder coating compositions, and preferably, the hardened coatings, of the present disclosure are essentially free of each of bisphenol A, bisphenol F, and bisphenol S; the powder coating compositions, and preferably, the hardened coatings, of the present disclosure are essentially completely free of each of bisphenol A, bisphenol F, and bisphenol S; or the powder coating compositions, and preferably, the hardened coatings, of the present disclosure are completely free of each of bisphenol A, bisphenol F, and bisphenol S.

More preferably, the metal packaging powder coating compositions, and preferably the hardened coatings, of the present disclosure are substantially free of all bisphenol compounds; the powder coating compositions, and preferably the hardened coatings, of the present disclosure are essentially free of all bisphenol compounds; the powder coating compositions, and preferably the hardened coatings, of the present disclosure are essentially completely free of all bisphenol compounds; or the powder coating compositions, and preferably the hardened coatings, of the present disclosure are completely free of all bisphenol compounds.

Preferably, tetramethyl bisphenol F (TMBPF) is not excluded from the powder coating compositions or hardened coatings of the present disclosure. TMBPF is 4-[(4-hydroxy-3,5-dimethylphenyl)methyl]-2,6-dimethylphenol, shown below, made by the following reaction:

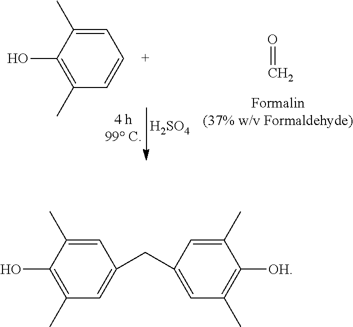

For example, a powder coating composition is not substantially free of bisphenol A that includes 600 ppm of bisphenol A and 600 ppm of the diglycidyl ether of bisphenol A (BADGE)—regardless of whether the bisphenol A and BADGE are present in the composition in reacted or unreacted forms, or a combination thereof.

The amount of bisphenol compounds (e.g., bisphenol A, bisphenol F, and bisphenol S) can be determined based on starting ingredients; a test method is not necessary and parts per million (ppm) can be used in place of weight percentages for convenience in view of the small amounts of these compounds.

Although with the notable exception of TMBPF, the intentional addition of many bisphenol compounds is now generally undesirable due to shifting consumer perceptions, it should be understood that non-intentional, trace amounts of bisphenol A, may potentially be present in compositions or coatings of the present disclosure due to, e.g., environmental contamination.

Although the balance of scientific evidence available to date indicates that the small trace amounts of bisphenol compounds, such as bisphenol A, that might be released from existing coatings does not pose any health risks to humans, these compounds are nevertheless perceived by some people as being potentially harmful to human health. Consequently, there is a desire by some to eliminate these compounds from coatings on food-contact surfaces.

Also, it is desirable to avoid the use of components that are unsuitable for such surfaces due to factors such as taste, toxicity, or other government regulatory requirements.

For example, in preferred embodiments where the coating constitutes a food-contact surface, the powder coating composition is “PVC-free.” That is, the powder coating composition preferably contains, if any, less than 2% by weight of vinyl chloride materials and other halogenated vinyl materials, more preferably less than 0.5% by weight of vinyl chloride materials and other halogenated vinyl materials, and even more preferably less than 1 ppm of vinyl chloride materials and other halogenated vinyl materials, if any.

As a general guide to minimize potential, e.g., taste and toxicity concerns, a hardened coating formed from the powder coating composition preferably includes, if it includes any detectable amount, less than 50 ppm, less than 25 ppm, less than 10 ppm, or less than 1 ppm, extractables, when tested pursuant to the Global Extraction Test described in the Test Methods. An example of these testing conditions is exposure of the hardened coating to 10 wt-% ethanol solution for two hours at 121° C., followed by exposure for 10 days in the solution at 40° C.

Such reduced global extraction values may be obtained by limiting the amount of mobile or potentially mobile species in the hardened coating. In this context, “mobile” refers to material that may be extracted from a cured coating according to the Global Extraction Test of the Test Methods. This can be accomplished, for example, by using pure, rather than impure reactants, avoiding the use of hydrolyzable components or bonds, avoiding or limiting the use of low molecular weight additives that may not efficiently react into the coating, and using optimized cure conditions optionally in combination with one or more cure additives. This makes the hardened coatings formed from the powder coating compositions described herein particularly desirable for use on food-contact surfaces.

The powder coating composition includes preferably at least 40 weight percent (wt-%), more preferably at least 50 wt-%, even more preferably at least 60 wt-%, still more preferably at least 70 wt-%, still more preferably at least 80 wt-%, and most preferably at least 90 wt-%, of the powder polymer particles, based on the total weight of the powder coating composition. The powder coating composition includes preferably up to 100 wt-%, more preferably up to 99.99 wt-%, even more preferably up to 95 wt-%, and most preferably up to 90 wt-%, of the powder polymer particles, based on the total weight of the powder coating composition. Various optional additives (e.g., charge control agent, lubricant, pigment, magnetic carrier particles, etc.) can be present in an amount up to 50 wt-%, based on the total weight of the powder coating composition. Where not otherwise disfavored due to the food-contact considerations, additives to the powder polymer particles may be similar to additives used in dry toner for electrophotography. See “Dry Toner Technology” by P. Julien and R. Gruber in Handbook of Imaging Materials, ed. A. Diamond and D. Weiss 2^{nd} ed., 2002, pp. 173-205.

In some embodiments of the present disclosure, the powder polymer particles are preferably in contact with one or more charge control agents. More preferably, one or more charge control agents are on a surface of the powder polymer particles. Even more preferably, one or more charge control agents are adhered to a surface of the powder polymer particles.

When used, one or more charge control agents are preferably present in an amount of at least 0.01 weight percent (wt-%), at least 0.1 wt-%, or at least 1 wt-%, based on the total weight of the powder coating composition (e.g., the charge control agent(s) and powder polymer particles). Furthermore, preferably, one or more charge control agents are present in an amount of up to 10 wt-%, up to 9 wt-%, up to 8 wt-%, up to 7 wt-%, up to 6 wt-%, up to 5 wt-%, up to 4 wt-%, or up to 3 wt-%, based on the total weight of the powder coating composition (e.g., the charge control agent(s) and powder polymer particles).

In some embodiments of the present disclosure, the powder polymer particles are preferably in contact with one or more magnetic carriers (i.e., magnetic carrier particles). The magnetic carrier particles may be provided in the powder coating composition, or the powder coating particles may be provided separately therefrom.

When used, one or more magnetic carriers are preferably present in an amount of at least 70 weight percent (wt-%), at least 80 wt-%, or at least 97 wt-%, based on the total weight of the powder coating composition (e.g., the powder polymer particles, magnetic carrier particles, optional charge control agent(s), and other optional additives). Furthermore, preferably, one or more magnetic carriers are present in an amount of up to 75 wt-%, up to 80 wt-%, up to 90 wt-%, or up to 95 wt-%, based on the total weight of the powder coating composition (e.g., the powder polymer particles, magnetic carrier particles, optional charge control agent(s), and other optional additives).

All other amounts of the components of a powder coating composition herein are reported in percentages based on the total weight of the coating composition absent any magnetic carrier particles that may be present. Thus, the concentrations of the various components in the hardened coating are equivalent to the concentrations of the respective starting materials in the powder coating composition, absent any magnetic carrier particles that may be present.

Preferred powder coating compositions herein are “dry” powder coating compositions. That is, the powder particles are not dispersed in a liquid carrier, but rather are present in dry powder form. It should be understood, however, that the dry powder may contain a de minimis amount of water or organic solvent (e.g., less than 2 wt-%, less than 1 wt-%, less than 0.1 wt-%, etc.). Even when subjected to drying processes, powders will typically include at least some residual liquid, for example, such as might be present from atmospheric humidity.

### Powder Coating Compositions and Methods of Making

According to the present disclosure, a metal packaging (e.g., a food, beverage, or aerosol can or cup) powder coating composition (i.e., a coating composition in the form of a free-flowing powder) is provided. Such compositions can form a hardened adherent coating on a substrate, such as a metal substrate. In particular, such compositions may also be useful for coating food, beverage, or aerosol cans, general metal packaging cans or other containers, portions thereof, or metal closures for metal packaging containers or other containers (e.g., closures for glass jars). The powder coating composition prior to application to the metal substrate includes powder polymer particles and preferably (i) one or more charge control agents in contact with the powder polymer particles (e.g., present on, and typically adhered to, surfaces of the powder polymer particles), and/or (ii) magnetic carrier particles.

Herein, if magnetic carrier particles are used, it is understood that the discussion of the powder coating composition prior to application to a substrate may or may not include the magnetic carrier particles. Preferably, however, the powder coating composition would include the magnetic carrier particles. If magnetic carrier particles are used, however, the magnetic carrier is not considered to be part of the powder coating composition described herein, after application to the metal substrate. That is, the magnetic carrier particles do not remain in the powder coating composition after deposition on the metal substrate, and a hardened coating does not include magnetic carrier particles.

### Polymer Particles

The molecular weight of the polymer in the powder coating composition may be described by a few key metrics given that a typical polymer covers a range of molecular weights. Number average molecular weight (Mn) is determined by dividing the total weight of a sample by the total number of molecules in that sample. Weight average molecular weight (Mw) is determined by calculating the sum of each distinct molecular weight in the sample multiplied by the weight fraction of the sample at that molecular weight. Polydispersity index (Mw/Mn) is used to express how broad the molecular weight range is of the sample. The higher the polydispersity index, the broader the molecular weight range. The Mn, Mw, and Mw/Mn can all be determined by Gel Permeation Chromatography (GPC), measured against a set of polystyrene standards of varying molecular weights.

The Mn of the polymer of the powder particles is at least 2,000 Daltons, preferably at least 5,000 Daltons, more preferably at least 10,000 Daltons, and even more preferably at least 15,000 Daltons. The Mn of the polymer of the powder particles may be in the millions (e.g., 10,000,000 Daltons), such as can occur with emulsion polymerized acrylic polymers or certain other emulsion polymerized latex polymers, although the Mn may be up to 10,000,000 Daltons, or up to 1,000,000 Daltons, or up to 100,000 Daltons, or even up to 20,000 Daltons. In certain embodiments, the Mn of the polymer of the polymer particles is at least 2,000 Daltons and up to 10,000,000 Daltons, or at least 5000 Daltons and up to 1,000,000 Daltons, or at least 10,000 Daltons and up to 100,000 Daltons, or at least 15,000 Daltons and up to 20,000 Daltons.

The powder polymer particles may be made from a polymer having a polydispersity index of less than 4, less than 3, less than 2, or less than 1.5. It may be advantageous, however, for the polymer to have a polydispersity index outside the preceding ranges. For example, without intending to be bound by theory, it may be desirable to have a higher polydispersity index to achieve the benefits of both higher molecular weight (e.g., for flexibility and other mechanic properties) and lower molecular weight (e.g., for flow and leveling) in the same material.

In preferred embodiments, the powder polymer particles have a particle size distribution having a D50 of less than 25 microns, preferably less than 20 microns, more preferably less than 15 microns, and even more preferably less than 10 microns. In preferred embodiments, the powder polymer particles have a particle size distribution having a D90 of less than 25 microns, less than 20 microns, less than 15 microns, or less than 10 microns. In more preferred embodiments, the powder polymer particles have a particle size distribution having a D95 of less than 25 microns, less than 20 microns, less than 15 microns, or less than 10 microns. In even more preferred embodiments, the powder polymer particles have a particle size distribution having a D99 of less than 25 microns, less than 20 microns, less than 15 microns, or less than 10 microns.

Preferably, the powder coating composition as a whole (i.e., all of the particles of the overall powder coating composition or the overall composition) has a particle size distribution having a D50 of less than 25 microns, less than 20 microns, less than 15 microns, or less than 10 microns. In preferred embodiments, the powder coating composition as a whole has a particle size distribution having a D90 of less than 25 microns, less than 20 microns, less than 15 microns, or less than 10 microns. In more preferred embodiments, the powder coating composition as a whole has a particle size distribution having a D95 of less than 25 microns, less than 20 microns, less than 15 microns, or less than 10 microns. In even more preferred embodiments, the powder coating composition as a whole has a particle size distribution having a D99 of less than 25 microns, less than 20 microns, less than 15 microns, or less than 10 microns.

The particle size distributions described herein (e.g., D50, D90, D95, D99, etc.) are not restricted on the lower particle size end. However, the D50 (in preferred embodiments, the D90, D95, or D99) may be greater than 1 micron, greater than 2 microns, greater than 3 microns, or greater than 4 microns.

The above particle size distributions (e.g., D50, D90, D95, and D99) should be interpreted to factor in any additional materials that may optionally be present on the surface of some, or all, of the polymer particles. Thus, by way of example, if the polymer particles have a D50 of 6.5 microns prior to application of an optional charge control agent, and a D50 of 7 microns after application of the optional charge control agent, as well as in the fully formulated powder coating composition, then 7 microns is the pertinent D50 for the final polymer particles.

In preferred embodiments in which one or more charge control agents are present on the surface of the polymer particles, the above particle size distributions (e.g., D50, D90, D95, and D99, as determined by laser diffraction particle size analysis) apply to the overall polymer particles inclusive of the charge control agent(s) present on the polymer particles.

Although the powder polymer particles, and optionally also the overall coating composition (i.e., powder coating composition as a whole), preferably have a narrow or very narrow distribution of particle sizes in an effort to get a very smooth coating (e.g., as opposed to an orange-peel appearance), as well as to minimize the amount of applied coating material and thus cost, it is contemplated that powder coating compositions of the disclosure may include polymer particles having particle sizes outside the particle size parameters described above. Preferably, the total amount of such optional “larger” and/or “smaller” polymer particles or other particles included in the powder coating composition is sufficiently low so that the desired properties of the powder coating composition and/or hardened coating are substantially preserved (e.g., the desired application properties of the powder coating composition; the desired adhesion, flexibility, chemical resistance, coating aesthetics, etc., of the cured coating). In such embodiments, preferably a substantial majority, by volume %, (e.g., 65% or more, 80% or more, 90% or more, 95% or more, 99% or more, etc.) of the total particles present in the powder coating composition exhibit a particle size pursuant to the particle size parameters described above.

Laser size diffraction analysis is a useful method for determining particle sizes of the primary polymer particles before agglomeration and other starting materials (e.g., charge control agents, lubricants, etc.), the powder polymer particles, which may or may not be agglomerated, or the powder coating compositions. An exemplary device for such analysis is a Beckman Coulter LS 230 Laser Diffraction Particle Size Analyzer or equivalent, calibrated as recommended by the manufacturer. It is believed that the particle size analysis of this analyzer embodies the principles of International Standard ISO 13320:2009(E).

Samples for laser diffraction particle size analysis can be prepared, for example, by diluting the samples in a substantially non-swelling solvent (such as cyclohexanone or 2-butoxyethanol) and shaking them until evenly dispersed. The choice of a suitable solvent will depend upon the particular particles to be tested. Solvent screening tests may need to be conducted to identify a suitable substantially non-swelling solvent. By way of example, a solvent in which a polymer particle swells by about 1% or less (as determined by laser diffraction particle size analysis) would be considered a substantially non-swelling solvent.

It will be understood by those skilled in the art that the particle size of the primary particles can be measured prior to the coating process, but this cannot be readily determined once agglomerates are formed. That is, the particle size of the primary particles that form agglomerates is determined based on the starting materials. Furthermore, to measure the particle size of agglomerates, a sample of the agglomerates is collected during the coating production process (e.g., during a spray drying process). Once the coating is formed, an accurate determination of the particle size of the agglomerates cannot be readily determined.

Powder polymer particles of the disclosure may be of any suitable shape, including, for example, flake, sheet, rod, globular, potato-shaped, spherical, or mixtures thereof. For example, precipitated polymer particles are typically spherical. Preferably, the particles are potato-shaped or spherical, or a mixture thereof.

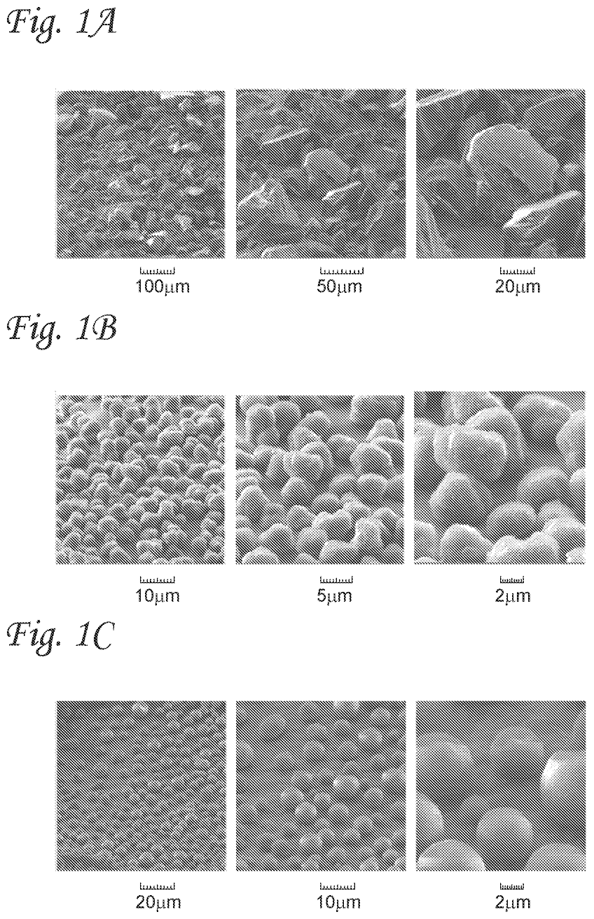

While any suitable powder polymer particles may be used, preferred polymer particles are chemically produced polymer particles. Chemically produced powders can be generically defined as fine powders prepared by methods other than mechanical processing (e.g., other than by traditional grinding). Such polymer particles have surface morphologies and/or particle shapes that are distinct from those typically achieved via mechanical processing means (e.g., grinding, milling, and the like). Such mechanical techniques entail taking larger size solid masses of polymer material and breaking them up in some manner to produce smaller size polymer particles. Such processes, however, typically yield irregular, angular particle shapes and rough, irregular surface morphologies and result in wide particle size distributions, thereby necessitating additional filtering to achieve a desired particle size distribution, which results in waste and additional cost. The polymer particles resulting from such mechanical processes are often referred to as “pulverized” or “ground” (conventionally prepared) particles. By way of example, see FIG. 1A, which shows a scanning electron microscope (SEM) image of conventional milled polyester powder coating particles that are angular, irregular, and have a broad particle size distribution.

In contrast, chemically produced polymer particles tend to have more regular and smooth surface morphologies and more regular and consistent particle shapes and sizes. In addition, the particle size distribution can be more exactly targeted and controlled, without generating appreciable waste. While not intending to be bound by theory, it is believed the enhanced homogeneity and regularity of chemically produced particles (e.g., in terms of shape, surface morphology, and particle size distribution) relative to mechanically produced particles will lead to better and more predictable and efficient transfer and application onto substrate and ultimately better coating performance properties for hardened adherent packaging coatings produced therefrom. By way of example, see FIGS. 1B (generally potato shaped particles) and 1C (generally spherical particles), which show chemically produced polymer particles having a generally narrow particle size distribution.

Examples of chemical processes for producing polymer particles include polymerization, such as interfacial polymerization, polymerization in organic solution, emulsion or dispersion polymerization in aqueous medium; dispersion of polymers in surfactants (e.g., in disperse or continuous phases) using low molecular weight or polymeric hydrophilic, hydrophobic, or fluorophilic surfactants; precipitation of polymers, such as controlled precipitation; melt blending polymers; particle aggregation; microencapsulation; recrystallization; core-shell formation; and limited coalescence, as well as other processes that form “composite” powder polymer particles. An example of a melt-blending approach for use in forming polymer particles is the melt-blending dispersion techniques taught in U.S. Pat. No. 8,349,929 (Kainz et al.), U.S. Pat. No. 9,598,601 (Malotky et al.), and U.S. Pat. No. 9,416,291 (Wilbur et al.). In the practice of limited coalescence, a dispersant aid and nano-scale inorganic colloid, as described in U.S. Pat. No. 4,833,060 (Nair), or a nanoscale organic colloid, as described in U.S. Pat. No. 4,965,131 (Nair), are used to disperse organic polymer solution, which utilize highly volatile and water immiscible solvents, into an aqueous medium, to a target particle size. Target particle size is controlled by concentration of various components in this dispersion. Volatiles are then removed from the solution any number of heating and evaporation processes such as heating, waterfall evaporator, etc. After removal of organic solvents, particles are filtered, washed, and dried, via means suitable to the particle composition. Optionally, particles can also be treated to remove, at least in part, the inorganic colloids if desired.

In terms of particle shapes, morphologies, sizes, and distributions, the polymer particles made for powder coatings may be similar to chemically produced toner (CPT) made for electrophotography and may be made with similar processes. Chemically produced toner is also referred to as chemically prepared toner, chemical toner, polymerized toner, polymer toner, in-situ polymerized toner, suspension polymerized toner, emulsion polymerized toner, emulsion aggregation toner, controlled agglomeration, capsule toner, microcapsule toner, encapsulated toner, microencapsulation toner, microencapsulated toner, core-shell toner, and also by other names. Work on the creation of polymer particles of controlled size can be traced back to the 1930's in the patent literature, including U.S. Pat. No. 2,108,044 (Crawford et al.).

The basic manufacturing methods for CPT are Suspension Polymerization (used by Canon and Zeon), Emulsion Aggregation (used by Konica Minolta, Xerox/Fuji Xerox, Mitsubishi and Fujifilm), and Solvent Methods of which there are a number of variants (used by companies including Ricoh, Xerox, and Kodak). Examples of each of the three types of processes in the prior art are shown in FIGS. 1D (showing the Suspension Polymerization Process), 1E (showing the Emulsion Aggregation Process, and IF (showing a Solvent Method, the Solution Inversion Process). CPT manufacturing methods are typically based on the production of toner particles by growth in a liquid of some sort, and typically include similar final stages of washing, dewatering, and drying. More information can be obtained from Graham Galliford, “Manufacturing Color Toner” in Imaging World, No. 119 (2021) pp. 33-37, June 2021 by Comexposium Recycling Times Exhibition Services Limited.

FIG. 1D depicts a prior art suspension polymerization process that includes placing a monomer, initiator, and pigment in an organic phase vessel 1002 and also placing water and an emulsifier in an aqueous phase vessel 1004. Quantitative feed pumps are used to deliver the contents of the organic phase vessel 1002 and the aqueous phase vessel 1004 into a disperser 1006 where monomer droplets are formed by emulsification. The contents of the disperser 1006 are delivered to a reactor 1008 where free radical polymerization occurs. The contents of the reactor 1008 are delivered to a washer 1010, followed by delivery to a dehydrator 1012 and, finally, to a dryer 1014.

FIG. 1E depicts a prior art emulsion aggregation process that includes emulsion polymerization including placing a monomer, water, water soluble initiator and surfactant (e.g., latex prepared <1 micron) in a vessel 1102 and also placing an aqueous pigment dispersion and wax dispersion in a vessel 1104. The contents of vessels 1102 and 1104 are delivered to vessel 1106 for mixing and aggregation to form toner sized particles (chemically controlled). The contents of vessel 1106 are delivered to vessel 1108 for coalescence of toner at a temperature of Tg (which enables resin flow and particle consolidation). The contents of the vessel 1108 are delivered to a washer 1110, followed by delivery to a dehydrator 1112 and, finally, to a dryer 1114.

FIG. 1F depicts a prior art solution inversion method using solvent (sometimes referred to as “Ricoh PxP”) for preparing CPT that includes placing pigment dispersed in a solution of urethane modified polyester prepolymer with reactive sites in a vessel 1202 and placement of a wax dispersion in a vessel 1204. Water and a size control agent are placed in a vessel 1206. The contents of vessels 1202, 1204, and 1206 are delivered to a high shear reactor vessel 1208 where solvent is removed and particles are formed in emulsion involving simultaneous coalescence and ester elongation. The contents of the vessel 1208 are delivered to vessel 1210 for filtering and washing to remove the dispersion agent. The contents of vessel 1210 are delivered to vessel 1212 for filtration and the contents of vessel 1212 are delivered to vessel 1214 for drying.

The basic manufacturing methods for CPT can also be summarized into the categories in the table below, shown with typical binders used for toner.

Various types of CPT processes and binder choice:

| CPT | Resin Pzn Method | Toner Binder |
|---|---|---|
| Suspension | Suspension | Styrene- |
| | | Acrylate |
| Emulsion | Emulsion | Styrene- |
| Aggregation | | Acrylate |
| (EA) | | |
| Encapsulation | Suspension/Emulsion | Styrene- |
| | Step Growth | Acrylate, |
| | | Polyester |
| PxP | Step Growth | Polyester |
| Dispersion Pzn | Step Growth* | Polyester |
| Precipitation | Step Growth* | Polyester |
| Solvent | Step Growth* | Polyester |
| Dispersion | | |
| Chemical Milling | Step Growth* | Polyester |

*Pre-Formed Polyester

Solvent-based processes offer the advantage of being able to make powder coating particles from a wide variety of materials, not just polyester. For example, the Kodak Limited Coalescence (LC) process has the advantage of being able to use any soluble polymer as a toner resin or to use monomers that are suitable for additional polymerization for making linear or crosslinked toners. This particle manufacturing process does not require any heating. Therefore, the process is not constrained by the Tg of the material or by the boiling temperature of aqueous solutions or solvents. This process and similar solvent-based processes can make powder coating particles using materials that are significantly different from typical low molecular weight polyester electrophotographic toners. More information can be obtained from Dinesh Tyagi, “Polyester-Based Chemically Prepared Toner for High-Speed Digital Production Printing” in NIP23 and Digital Fabrication 2007 Final Program and Proceedings, pp. 270-273, The Society for Imaging Science and Technology, IS&T.

The powder polymer particles (preferably, all the particles of the overall powder coating composition) may have a shape factor of at least 100, or at least 120. For instance, using ground or pulverized particles, the shape factor may be up to 165, or up to 155, or up to 140. Accordingly, the particles may be spherical (having a shape factor of from 100 to less than 120) or potato shaped (having a shape factor of from at least 120 up to 140) or a mixture of spherical and potato shaped. In contrast, conventional mechanically produced polymer particles typically have a shape factor of greater than 145. The powder polymer particles are preferably potato shaped. The shape factor can be determined using the following equation:

$$Shape Factor = ( {( M L )}^{2} / A ) \times ( π / 4 ) \times 100$$

wherein: ML=Maximum Length of Particle (sphere=2r); and
   A=Projected Area (sphere=πr²).

Shape factor can be determined using dynamic image analysis (DIA) using a flow-type particle dynamic image analyzer CAMSIZER X2. Particle shape parameters include convexity, sphericity, symmetry, and aspect ratio (ratio of length to width).

For shape analysis, typically particles below 1 micron in particle size are typically ignored. Without being bound by theory, it is believed that such small particles will have a similar shape as the large particles and/or the shape of the large particles will control the performance of the ultimate coating formed.

DIA uses a flow of particles passing a camera system in front of an illuminated background. A dynamic image analysis system measures free falling particles and suspensions, and also features dispersion by air pressure for those particles that are inclined to agglomerate. A wide range of shape parameters are measured using particle images.

Powder samples for DIA can be prepared, for example, by dispersing a sample of the powder to be measured in an appropriate fluid. The prepared samples can then be measured in a dynamic image analyzer such as the CAMSIZER X2, which employs a dynamic imaging technique. Samples are dispersed by pressurized air and passed through a gap illuminated by two bright, pulsed LED light sources. The images of the dispersed particles (more specifically of their shadows, or projections) are then recorded by two digital cameras and analyzed for shape in order to determine a variety of length and width descriptors for the particles, as required, e.g., by ISO test method 13322-2 (2006) (on particle size analysis via dynamic imaging).

The powder polymer particles (preferably, all the particles of the overall powder coating composition) preferably have a compressibility index of at least 1, and, in certain embodiments, up to 50, or up to 30, or up to 20. More preferably, in certain embodiments, the compressibility index may be 1 to 10, 11 to 15, or 16 to 20. The compressibility index can be determined using the following equation:

$$Compressibility Index = ( ( Tap Density - Bulk Density ) / ( Tap Density ) ) \times 100$$

wherein the tap density and the bulk are each determined pursuant to ASTM D7481-18 (2018).

The powder polymer particles (preferably, all the particles of the overall powder coating composition) preferably have a Haussner Ratio of at least 1.00, and, in certain embodiments, up to 2.00 or up to 1.25. More preferably, in certain embodiments, the Haussner Ratio is 1.00 to 1.11, 1.12 to 1.18, or 1.19 to 1.25. The Haussner Ratio can be determined using the following equation:

$$Haussner Ratio = Tap Density / Bulk Density$$

wherein tap density and bulk density are as defined/determined above.

Preferably, the powder polymer particles have at least fair flow characteristics (e.g., have a compressibility index of 16 to 20 and a Haussner Ratio is 1.19 to 1.25), or at least good flow characteristics (e.g., have a compressibility index of 11 to 15 and a Haussner Ratio is 1.12 to 1.18), or excellent flow characteristics (e.g., have a compressibility index of 1 to 10 and a Haussner Ratio is 1.00 to 1.11).

Similar to the particle size distributions (e.g., D50 and the like) discussed above for the powder polymer particles, the shape factor, compressibility index, and Haussner Ratio, should be inclusive of any additional materials (e.g., charge control agent) that may optionally be present on the surface of the polymer particles in the final powder coating composition, except for magnetic carrier particles, if they are present in the powder coating compositions. That is, if magnetic carrier particles are present in a powder coating composition, for purposes of these characteristics, they would be omitted from the calculations. By way of example, if a polymer coating composition includes magnetic carrier particles, the stated D50 for the polymer coating composition does not include the particle size of the magnetic carrier particles. If the magnetic carrier particles are in a powder sample that is measured, the measurement will show a bimodal particle size distribution attributable to two D50's—one for the powder polymer particles and one for the magnetic carrier particles, but only the D50 for the powder polymer particles is used to describe the particle size distribution for the powder coating composition.

In preferred embodiments, the overall powder coating composition exhibits one or more of, two or more of, three or more of, four or more of, five or more of, and preferably all of, a D50, a D90, a D95, a D99, a shape factor, a compressibility index, and a Haussner Ratio falling within the ranges disclosed above for the powder polymer particles. These ranges are for the powder coating compositions without magnetic carrier particles, if they are present in the powder coating compositions.

In preferred embodiments, the powder polymer particles are in the form of agglomerates (i.e., assemblies of primary polymer particles). The agglomerates (i.e., clusters) may have a particle size of up to 25 microns, up to 20 microns, up to 15 microns, or up to 10 microns. Although the lower size range of the agglomerate particle sizes is not restricted, typically the particle sizes will be at least 1 micron, at least 2 microns, at least 3 microns, or at least 4 microns. Preferably, the primary polymer particles have a primary particle size of at least 0.05 micron, and up to 8 microns, up to 5 microns, up to 3 microns, up to 2 microns, or up to 1 micron. The primary particle size may be determined by laser diffraction particle size analysis of the starting material, and the particle size of the polymer agglomerates (e.g., of the agglomerates collected during a spray drying process) may also be determined by laser diffraction particle size analysis.

Agglomerated particles are typically formed by spray drying. Agglomerates are assemblies of primary particles, the latter of which are formed by a polymerization process. The spray drying process typically involves forming liquid droplets, wherein each droplet includes primary particles therein, using a spray nozzle. The droplets are then dried to form agglomerates (i.e., each of which is a cluster or assembly of the primary particles that were in each droplet). The particle size of an agglomerate, which may be referred to as the secondary particle size, is determined by the number of primary particles within the agglomerate. This can be controlled by the size of the liquid droplet and/or the concentration of primary particles within each droplet. For example, small agglomerates may be formed by increasing the spray nozzle pressure to form a fine mist of small droplets. Also, small agglomerates may be formed by reducing the concentration of the primary particles in the liquid, but using lower spray nozzle pressure and forming larger droplets.

Each powder polymer particle may be formed from a single type of polymer material or may include two or more different types of polymer materials. In addition to one or more types of polymer materials, if desired, the powder polymer particles, which may or may not be agglomerated, may incorporate up to 50 wt-% of one or more optional additives, based on the total weight of the powder polymer particles. Thus, preferably, the powder polymer particles include one or more polymers in an amount of at least 40 wt-%, based on the total weight of the powder polymer particles. More preferably, the powder polymer particles include one or more polymers in an amount of at least 50 wt-%, at least 60 wt-%, at least 70 wt-%, at least 80 wt-%, at least 90 wt-%, at least 95 wt-%, at least 98 wt-%, at least 99 wt-%, or 100 wt-%, based on the total weight of the powder polymer particles.

Such optional additives may include, for example, lubricants, adhesion promoters, crosslinkers, catalysts, colorants (e.g., pigments or dyes), ferromagnetic pigments, degassing agents, levelling agents, wetting agents, surfactants, flow control agents, heat stabilizers, anti-corrosion agents, adhesion promoters, inorganic fillers, metal driers, and combinations thereof. Such optional additives may additionally, or alternatively, be present in other particles that are included in the powder coating composition in addition to the powder polymer particles.

The polymer particles may include any suitable combination of one or more thermoplastic polymers, one or more thermoset polymers, or a combination thereof. For certain preferred applications, the polymer particles may include any suitable combination of one or more thermoplastic polymers. The term “thermoplastic” refers to a material that melts and changes shape when sufficiently heated and hardens when sufficiently cooled. Such materials are typically capable of undergoing repeated melting and hardening without exhibiting appreciable chemical change. In contrast, a “thermoset” refers to a material that is crosslinked and does not “melt.”

The polymer material preferably has a melt flow index greater than 15 grams/10 minutes, greater than 50 grams/10 minutes, or greater than 100 grams/10 minutes. The polymer material preferably has a melt flow index of up to 200 grams/10 minutes, or up to 150 grams/10 minutes. The powder coating composition as a whole may exhibit such a melt flow index. The “melt flow index” referred to herein is measured pursuant to ASTM D1238-13 (2013) at 190° C. and with a 2.16-kilogram weight.

In certain embodiments, the polymer particles are made from semi-crystalline, crystalline polymers, amorphous polymers, or combinations thereof. Suitable semi-crystalline or crystalline polymers may exhibit any suitable percent crystallinity. In some embodiments, the powder coating composition of the disclosure includes at least one semi-crystalline or crystalline polymer having a percent crystallinity (on a weight basis) of at least 5%, at least 10%, or at least 20%. By way of example, the percent crystallinity for a given polymer may be assessed via differential scanning calorimetry (DSC) testing using the following equation:

$$Percent crystallinity ( \% ) = [ A / B ] \times 100$$

wherein: “A” is the heat of fusion of the given polymer (i.e., the total area “under” the melting portion of the DSC curve) in Joules per gram (J/g); and
“B” is the heat of fusion in J/g for the 100% crystalline state of the polymer.

For many polymers, a theoretical B value may be available in the scientific literature and such value may be used. For polyester polymers, for example, if such a B value is not available in the literature, then a B value of 145 J/g may be used as an approximation, which is the heat of fusion for 100% crystalline polybutylene terephthalate (PBT) as reported in: Cheng, Stephen; Pan, Robert; and Wunderlich, Bernard; “Thermal analysis of poly(butylene terephthalate) for heat capacity, rigid-amorphous content, and transition behavior,” Macromolecular Chemistry and Physics, Volume 189, Issue 10 (1988): 2443-2458.

Preferably, at least one polymer material of the polymer particles (and more preferably substantially all, or all, of the polymer material present in the polymer particles) is at least semi-crystalline (e.g., semi-crystalline or crystalline). The polymer particles may include amorphous polymer material or a blend of at least semi-crystalline polymer material and amorphous polymer material. ASTM-D3418-15 (2015) is an example of a useful methodology for assessing the crystallization properties (crystallization peak temperature) of polymers.

The polymers used may exhibit any suitable glass transition temperature (Tg) or combinations of Tg's. The powder polymer particles are preferably made from a polymer having a glass transition temperature (Tg) of at least 40° ° C., at least 50° C., at least 60° C., or at least 70° C. and a Tg of up to 150° C., up to 125° C., up to 110° C., up to 100° C., or up to 80° C.

In some embodiments, lower Tg polymers (e.g., having a Tg lower than 40° C., such as those with a Tg of at least 0° C. or at least 30° C.) may be used in making the powder polymer particles used herein as long as the particles include at least one polymer with a higher Tg (e.g., at least 40° C.). Alternatively, the lower Tg polymer(s) and the higher Tg polymer(s) may be in different layers, such as described in the multilayer description elsewhere in the current disclosure.

The polymer particles may additionally be of a core-shell morphology (i.e., the outer portion, or shell, of the polymer particle is of a different composition than the inner portion, or core). In such cases, the shell ideally comprises 10% by weight or greater of the total polymer particles, and the Tg preferences above would only apply to the shell of the polymer particle. In other words, the shell of the polymer particle is preferably made from a polymer having a Tg of at least 40° C., at least 50° C., at least 60° ° C., or at least 70° C., and a Tg of up to 150° C., up to 125° C., up to 110° C., up to 100° C., or up to 80° C.

In embodiments incorporating a crystalline or semi-crystalline polymer, the powder polymer particles are preferably made from a crystalline or semi-crystalline polymer having a melting point of at least 40° C., and a melting point of up to 300° C.

In preferred embodiments, substantially all (i.e., more than 50 wt-%) of the polymer material of the polymer particles exhibits such a melting point or Tg. Classic amorphous polymers do not, for example, exhibit any discernible melting point (e.g., do not exhibit a DSC melting peak) nor include any crystalline regions. Thus, such classic amorphous polymers would be expected to exhibit a percent crystallinity of 0%. Accordingly, powder coating compositions of the disclosure may include one or more amorphous polymers having a percent crystallinity of 0% or substantially 0%. If desired, however, powder coating compositions of the disclosure may include one or more “amorphous” polymers having a percent crystallinity other than 0 (e.g., less than 5%, less than 2%, less than 1%, less than 0.5%, less than 0.1%, etc.).

The one or more polymers of the polymer particles may be aliphatic or aromatic, or a combination of one or more aliphatic polymers and one or more aromatic polymers. Similarly, the one or more polymer may be saturated or unsaturated, or a combination of one or more saturated polymers and one or more unsaturated polymers.

Suitable polymer particles can be prepared from water (e.g., latex polymers) or from organic solvents (e.g., nonane, decane, dodecane, or isohexadecane), or combinations thereof. Water-based polymers are preferred because of cost considerations, to keep VOC levels down during processing, and to keep residual organic solvents out of the powder coating compositions.

The powder polymer particles may be emulsion, suspension, solution, or dispersion polymerized polymer particles (i.e., particles made from an emulsion, suspension, solution, or dispersion polymerization process). Typically, water-dispersible polymers include self-emulsifiable groups (e.g., carboxylic, sulphonic, phosphonic acid groups, or salts thereof), although this is not a requirement. Neutralizing agents (e.g., amines, ammonia, or ammonium hydroxide), particularly volatile ones, can also be used in making such polymer particles, as is well-known to those skilled in the art. Conversely, if desired, base groups that are neutralized with acids may also be used. Non-ionic polar groups may also alternatively or additional be used.

The powder polymer particles may be precipitated polymer particles (i.e., particles made from a precipitation process). The powder polymer particles can be formed via polymerization in liquid media followed by a suitable drying process (e.g., spray drying, vacuum drying, fluid bed drying, radiant drying, flash drying, and the like.) The powder polymer particles can also be formed via melt-blending (e.g., using a kneader, mixer, extruder, etc.) optionally coupled to a dispenser such as used for emulsification (see, e.g., U.S. Pat. No. 6,512,024 (Pate et al.) for a description of such process equipment). Preferably, however, the powder polymer particles are not ground polymer particles or polymer particles formed from other similar fracturing or pulverization processes. More preferably, the powder polymer particles are spray dried particles.

The polymer of the powder polymer particles may be a polyacrylic (i.e., acrylic or acrylate or polyacrylate) (e.g., a solution-polymerized acrylic polymer, an emulsion polymerized acrylic polymer, or combination thereof), polyether, polyolefin, polyester, polyurethane, polycarbonate, polystyrene, or a combination thereof (i.e., copolymer or mixture thereof such as polyether-acrylate copolymer). The polymers may be engineering plastics. Engineering plastics are a group of thermoplastic materials that have better mechanical and/or thermal properties than the more widely used commodity plastics (such as polystyrene, polypropylene, and polyethylene). Examples of engineering plastics include acrylonitrile butadiene styrene (ABS), polycarbonates, and polyamides. Preferably, the polymer of the powder polymer particles is a polyacrylic, a polyether, a polyolefin, a polyester, or a combination thereof (e.g., a polyether-acrylate copolymer, a polyester-acrylate copolymer, and the like).

Individual particles may be made of one polymer or two or more polymers. Individual particles may be uniform throughout or have a “core-shell” configuration having 1, 2, 3, or more “shell” layers or have a gradient architecture (e.g., a continuously varying architecture). Such “core-shell” particles may include, for example, multi-stage latexes created via the emulsion polymerization of two or more different stages, emulsion polymerizations conducted using a polymeric surfactant, or combinations thereof. Populations of particles may include mixtures of polymers, including mixtures of uniform and core-shell particles.

In preferred embodiments, the inclusion of a sufficient number of cyclic groups, and preferably aryl and/or heteroaryl groups (e.g., phenylene groups), in the polymers is an important factor for achieving suitable coating performance for food-contact packaging coatings, especially when the product to be packaged is a so called “hard-to-hold” food or beverage product. Sauerkraut is an example of a hard-to-hold product. Although cyclic groups providing such performance are often aryl or heteroaryl groups, suitable aliphatic cyclic groups such as, e.g., aliphatic bridged bicyclic (e.g., norbornane or norbornene groups), aliphatic bridged tricyclic groups (e.g., tricyclodecane groups), cyclobutane groups (e.g., as provided using structural units derived from 2,2,4,4-tetramethyl-1,3-cyclobutanediol), cyclobutene groups, or spirobicyclic groups (e.g., as provided using 3,9-bis(1,1-dimethyl-2-hydroxyethyl)-2,4,8,10-tetraoxaspiro[5.5]undecane (PSG)) may provide such performance.

For example, when the polymer particles are formed from certain polyether or polyester polymers, cyclic groups, and more preferably aryl and/or heteroaryl groups, preferably constitute at least 25 wt-%, more preferably at least 30 wt-%, even more preferably at least 35 wt-%, and optimally at least 45 wt-% of such polymers. The upper concentration of cyclic groups (e.g., aryl/heteroaryl groups) is not particularly limited, but preferably the amount of such groups is configured such that the Tg of the polymer is preferably within the Tg ranges discussed herein. The total amount of cyclic groups (e.g., aryl and/or heteroaryl groups) in such polymers will typically constitute less than about 80 wt-%, more preferably less than 75 wt-%, even more preferably less than about 70 wt-%, and optimally less than 60 wt-% of the polyether polymer. The total amount of cyclic groups (e.g., aryl and/or heteroaryl groups) in such polymers can be determined based on the weight of cyclic group-containing polymerizable compound (e.g., aryl- or heteroaryl-containing polymerizable compound) incorporated into the polymers and the weight fraction of such polymerizable compound that constitutes cyclic groups (e.g., aryl or heteroaryl groups).

Preferred aryl or heteroaryl groups include less than 20 carbon atoms, more preferably less than 11 carbon atoms, and even more preferably less than 8 carbon atoms. The aryl or heteroaryl groups preferably have at least 4 carbon atoms (e.g., a furanylene group), more preferably at least 5 carbon atoms, and even more preferably at least 6 carbon atoms. Substituted or unsubstituted phenylene groups are preferred aryl or heteroaryl groups.

Alternatively, at least some, or even all, of the cyclic groups are polycyclic groups (e.g., bicyclic, tricyclic, or polycyclic groups having 4 or more rings).

The powder polymer particles may include a polyester polymer. Suitable polyesters include polyesters formed from one or more suitable polycarboxylic acid components (e.g., dicarboxylic acid components, tricarboxylic acid components, tetracarboxylic acid components, etc.) and one or more suitable polyol components (e.g., diol components, triol components, polyols having four hydroxyl groups, etc.). One or more other comonomers may optionally be used, if desired. Dicarboxylic acid components and diol components are preferred.

Suitable dicarboxylic acid components include, for example, aromatic dicarboxylic acids such as terephthalic acid, isophthalic acid, phthalic acid, naphthalenedicarboxylic acid (e.g., 2,6-napthalene dicarboxylic acid), and furandicarboxylic acid (e.g., 2,5-furandicarboxylic acid); aliphatic dicarboxylic acids such as adipic acid, cyclohexane dicarboxylic acid, sebacic acid and azelaic acid; unsaturated acids such as maleic anhydride, itaconic acid, and fumaric acid; and mixtures thereof. Examples of other suitable polycarboxylic acids (or anhydrides) include benzene-pentacarboxylic acid; mellitic acid; 1,3,5,7 napthalene-tetracarboxylic acid; 2,4,6 pyridine-tricarboxylic acid; pyromellitic acid; trimellitic acid; trimesic acid; 3,5,3′,5′-biphenyltetracarboxylic acid; 3,5,3′,5′-bipyridyltetracarboxylic acid; 3,5,3′,5′-benzophenonetetracarboxylic acid; 1,3,6,8-acridinetetracarboxylic acid; 1,2,4,5-benzenetetracarboxylic acid; nadic anhydride; trimellitic anhydride; pyromellitic anhydride, and mixtures thereof. Anhydrides or esters of the aforementioned acids and mixtures of such acids, anhydrides or esters may also be used.

Suitable diol components include, for example, polymethylene glycols represented by the formula HO—(CH₂)ₙ—OH (where n is about 2 to 10) such as ethylene glycol, propylene glycol, butanediol, hexanediol and decamethylene glycol; branched glycols represented by the formula HO—CH₂—C(R₂)—CH₂—OH (where R is an alkyl group having 1 to 4 carbon atoms) such as neopentyl glycol; diethylene glycol and triethylene glycol; diols having a cyclohexane ring such as cyclohexane dimethanol (CHDM); 2-methyl-1,3 propane diol; diols having a cyclobutane ring such as 2,2,4,4-tetramethyl-1,3-cyclobutanediol; isosorbide; tricyclodecanedimethanol; spirobicyclic diols (e.g., 3,9-bis(1,1-dimethyl-2-hydroxyethyl)-2,4,8,10-tetraoxaspiro[5.5]undecane (PSG)); and mixtures thereof. Glycerol, trimethylol propane (TMP), and other suitable trifunctional or higher polyols may also be used alone or in combination with any other suitable polyol.

The polyester polymer particles are preferably made from semi-crystalline or crystalline polymers. Suitable exemplary crystalline and semi-crystalline polyester polymers include polyethylene terephthalate (“PET”), copolymers of PET such as PET/I, polybutylene terephthalate (“PBT”), polyethylene naphthalate (“PEN”), poly-1,4-cyclohexylenedimethylene terephthalate, and copolymers and combinations thereof. The polyester material may be formed from ingredients including dimer fatty acids. Non-limiting examples of useful commercially available polyester materials may include polyesters commercially available under the tradename DYNAPOL such as, for example, DYNAPOL L912 (includes polycyclic groups derived from tricyclodecanedimethanol), DYNAPOL L952, DYNAPOL P1500, DYNAPOL P1500 HV (has a melting point temperature of about 170° C., a glass transition temperature of about 20° C., and a number average molecular weight of approximately 20,000), DYNAPOL P1510, and DYNAPOL P1550 (each available from Hiils AG and based on monomers including terephthalic acid and/or isophthalic acid); polyester materials commercially available under the TRITAN tradename (available from Eastman Chemical Company and based on monomers including 2,2,4,4-Tetramethyl-1,3-cyclobutanediol); and polyester materials commercially available under the tradename GRILTEX such as, for example, GRILTEX DD2267EG and GRILTEX D2310EG (each available from EMS-Chemie and based on monomers including terephthalic acid and/or isophthalic acid).

Exemplary polyester polymers that may be used in making suitable powder polymer particles are described, for example, in U.S. Pat. Pub. No. 2014/0319133 (Castelberg et al.), U.S. Pat. Pub. No. 2015/0344732 (Witt-Sanson et al.), U.S. Pat. Pub. No. 2016/0160075 (Seneker et al.), International Application No. PCT/US2018/051726 (Matthieu et al.), U.S. Pat. No. 5,464,884 (Nield et al.), U.S. Pat. No. 6,893,678 (Hirose et al.), U.S. Pat. No. 7,198,849 (Stapperfenne et al.), U.S. Pat. No. 7,803,415 (Kiefer-Liptak et al.), U.S. Pat. No. 7,981,515 (Ambrose et al.), U.S. Pat. No. 8,133,557 (Parekh et al.), U.S. Pat. No. 8,367,171 (Stenson et al.), U.S. Pat. No. 8,574,672 (Doreau et al.), U.S. Pat. No. 9,096,772 (Lespinasse et al.), U.S. Pat. No. 9,011,999 (Cavallin et al.), U.S. Pat. No. 9,115,241 (Gao et al.), U.S. Pat. No. 9,187,213 (Prouvost et al.), U.S. Pat. No. 9,321,935 (Seneker et al.), U.S. Pat. No. 9,650,176 (Cavallin et al.), U.S. Pat. No. 9,695,264 (Lock et al.), U.S. Pat. No. 9,708,504 (Singer et al.), U.S. Pat. No. 9,920,217 (Skillman et al.), U.S. Pat. No. 10,131,796 (Martinoni et al.), U.S. Pat. Pub. No. 2020/0207516 (Seneker et al.), and WO 2021/105970 (Riazzi et al.).

Polyester polymers having C4 rings may be used such as, for example, are present in certain structural segments derived from cyclobutanediol-type compounds such as, e.g., including 2,2,4,4-tetramethyl-1,3-cyclobutanediol). Exemplary such polyesters including such C4 rings are described, for example, in WO2014/078618 (Knotts et al.), U.S. Pat. No. 8,163,850 (Marsh et al.), U.S. Pat. No. 9,650,539 (Kuo et al.), U.S. Pat. No. 9,598,602 (Kuo et al.), U.S. Pat. No. 9,487,619 (Kuo et al.), U.S. Pat. No. 9,828,522 (Argyropoulos et al.), and U.S. Pat. Pub. No. 2020/0207516 (Seneker et al.).

Preferably, the powder polymer particles may include a polyether polymer. The polyether polymer may contain a plurality of aromatic segment, more typically aromatic ether segments. The polyether polymer may be formed using any suitable reactants and any suitable polymerization process. The polyether polymer may be formed, for example, from reactants including an extender compound (e.g., a diol, which is preferably a polyhydric phenol, more preferably a dihydric phenol; a diacid; or a compound having both a phenol hydroxyl group and a carboxylic group) and a polyepoxide. In preferred embodiments, the polyepoxide is a polyepoxide of a polyhydric phenol (more typically a diepoxide of, e.g., a diglycidyl ether of, a dihydric phenol). Preferably, (i) the polyhydric phenol compound is an ortho-substituted diphenol (e.g., tetramethyl bisphenol F), (ii) the diepoxide is a diepoxide of an ortho-substituted diphenol (e.g., tetramethyl bisphenol F), or (iii) both (i) and (ii).

A polyether polymer may be formed from reactants including a diepoxide of an ortho-substituted diphenol (e.g., the diglycidyl ether of tetramethyl bisphenol F) and a dihydric phenol having only one phenol ring (e.g., hydroquinone, resorcinol, catechol, or a substituted variant thereof).

A polyether polymer may be prepared from reactants including a diepoxide (typically a diglycidyl ether or diglycidyl ester) that is not derived from a polyhydric phenol, and which includes one or more backbone or pendant aryl or heteroaryl groups. Such aromatic diepoxides may be prepared, for example, from aromatic compounds having two or more reactive groups such as diols, diacids, diamines, and the like. Suitable such exemplary aromatic compounds for use in forming the aromatic diepoxides include 1-phenyl-1,2-propanediol; 2-phenyl-1,2-propanediol; 1-phenyl-1,3-propanediol; 2-phenyl-1,3-propanediol; 1-phenyl-1,2-ethanediol; vanillyl alcohol; 1,2-, 1,3- or 1,4-benzenedimethanol; furandimethanol (e.g., 2,5-furandimethanol); terephthalic acid; isophthalic acid; and the like.

A polyether polymer may be prepared from reactants including one or more aliphatic polyepoxides, which are typically aliphatic diepoxides, and more typically cycloaliphatic diepoxides. Exemplary aliphatic diepoxides include diepoxides of (which are typically diglycidyl ethers of): cyclobutane diol (e.g., 2,2,4,4-tetramethyl-1,3-cyclobutanediol), isosorbide, cyclohexanedimethanol, neopentyl glycol, 2-methyl 1,3-propanediol, tricyclodecanedimethanol, 3,9-bis(1,1-dimethyl-2-hydroxyethyl)-2,4,8,10-tetraoxaspiro[5.5]undecane (PSG), and mixtures thereof.

Exemplary reactants, polymerization processes, and polyether polymers that may be used in making suitable powder particles are described in U.S. Pat. No. 7,910,170 (Evans et al.), U.S. Pat. No. 9,409,219 (Niederst et al.), U.S. Pat. Pub. No. 2013/0280455 (Evans et al.), U.S. Pat. Pub. No. 2013/0316109 (Niederst et al.), U.S. Pat. Pub. No. 2013/0206756 (Niederst et al.), U.S. Pat. Pub. No. 2015/0021323 (Niederst et al.), International Pub. Nos. WO 2015/160788 (Valspar Sourcing), WO 2015/164703 (Valspar Sourcing), WO 2015/057932 (Valspar Sourcing), WO 2015/179064 (Valspar Sourcing), WO 2018/125895 (Valspar Sourcing), and WO 2021/105970 (SWIMC LLC).

The polyether polymers may alternatively be formed from ingredients that do not include any bisphenols or any epoxides of bisphenols, although non-intentional, trace amounts may potentially be present due to, e.g., environmental contamination. Examples of suitable reactants for forming such bisphenol-free polyether polymers include any of the diepoxides derived from materials other than bisphenols described in the patent documents referenced in the preceding paragraph and any of the extender compounds other than bisphenols disclosed in such patent documents. Hydroquinone, catechol, resorcinol, and substituted variants thereof, are non-limiting examples of suitable extender compounds for use in making such bisphenol-free polyether polymers.

Preferably, the powder polymer particles may include a polymer formed via free-radical polymerization of ethylenically unsaturated monomers, with acrylic polymers being preferred examples of such polymers. Such polymers are referred to herein as “acrylic polymers” for convenience given that such polymers typically include one or more monomers selected from (meth)acrylates or (meth)acrylic acid. Preferred acrylic polymers include organic-solution polymerized acrylic polymers and emulsion polymerized acrylic latex polymers. A suitable acrylic polymer includes a reaction product of components that include a (meth)acrylic acid ester, an optional ethylenically unsaturated mono- or multi-functional acid, and an optional vinyl compound. For example, the acrylate film-forming polymer could be a reaction product of components that include ethyl acrylate and/or butyl acrylate, acrylic acid and/or methacrylic acid, and styrene and/or cyclohexyl methacrylate (preferably in the presence of 2,2′-azobis(2-methyl-butyronitrile) and tert-butyl peroxybenzoate free radical initiators).

Examples of suitable (meth)acrylic acid esters (i.e., methacrylic acid esters and acrylic acid esters) include methyl (meth)acrylate, ethyl (meth)acrylate, propyl (meth)acrylate, isopropyl (meth)acrylate, butyl (meth)acrylate, isobutyl (meth)acrylate, pentyl (meth)acrylate, isoamyl (meth)acrylate, hexyl (meth)acrylate, 2-hydroxyethyl (meth)acrylate, 2-ethylhexyl (meth)acrylate, cyclohexyl (meth)acrylate, decyl (meth)acrylate, isodecyl (meth)acrylate, benzyl (meth)acrylate, 2-hydroxypropyl (meth)acrylate, lauryl (meth)acrylate, isobornyl (meth)acrylate, octyl (meth)acrylate, and nonyl (meth)acrylate. Any suitable isomer or combination of isomers of the above may be used. By way of example, disclosure of “butyl (meth)acrylate” is intended to disclose all isomers such as n-butyl (meth)acrylate, sec-butyl (meth)acrylate, tert-butyl (meth)acrylate, and the like. In general, as disclosed herein, unless specifically indicated to the contrary, disclosure of all isomers for a given monomer is intended.

Examples of suitable ethylenically unsaturated mono- or multi-functional acids include methacrylic acid, acrylic acid, crotonic acid, itaconic acid, maleic acid, mesaconic acid, citraconic acid, sorbic acid, and fumaric acid.

Examples of suitable vinyl compounds include styrene, halostyrene, isoprene, a conjugated butadiene, alpha-methylstyrene, vinyl toluene, vinyl naphthalene, vinyl chloride (which is not preferred), acrylonitrile, methacrylonitrile, vinyl acetate, vinyl propionate, vinyl cyclohexane, vinyl cyclooctane, vinyl cyclohexene, and vinyl stearate.

Examples of commercially available acrylic polymers include those available under the trade names VIACRYL SC 454/50BSNB, VIACRYL SC383w/50WA, and VANCRYL 2900 DEV (all from Cytec Industries Inc., West Patterson, NJ), as well as NEOCRYL A-639, NEOCRYL XK-64, URACON CR203 M3, and URACON CS113 SIG (all from DSM Neoresins BV, 5140 AC Waalwijk, Netherlands).

Exemplary acrylic polymers that may be used in making suitable powder particles are described in U.S. Pat. No. 8,168,276 (Cleaver et al.), U.S. Pat. No. 7,189,787 (O'Brien), U.S. Pat. No. 7,592,047 (O'Brien et al.), U.S. Pat. No. 9,181,448 (Li et al.), U.S. Pat. No. 9,394,456 (Rademacher et al.), U.S. Pat. Pub. No 2016/0009941 (Rademacher et al.), U.S. Pat. Pub. No. US2016/0376446 (Gibanel et al.), U.S. Pat. Pub. No. 2017/0002227 (Gibanel et al.), U.S. Pat. Pub. No. 2018/0265729 (Gibanel et al.), WO2016/196174 (Singer et al.), WO2016/196190 (Singer et al.), WO2017/112837 (Gibanel et al.), WO2017/180895 (O'Brien et al.), WO2018/085052 (Gibanel et al.), WO2018/075762 (Gibanel et al.), WO2019/078925 (Gibanel et al.), WO2019/046700 (O'Brien et al.), and WO2019/046750 (O'Brien et al.).

The powder polymer particles may include dried latex particles that include both polyether polymer and acrylic polymer. Examples of such latex particles are described, e.g., in WO2017/180895 (O'Brien et al.) and International App. No. WO2019046700 (O'Brien et al.).

Preferably, the powder polymer particles may include a polyolefin polymer. Examples of suitable polyolefin polymers include maleic-modified polyethylene, maleic-modified polypropylene, ethylene acrylic acid copolymers, ethylene methacrylic acid copolymers, propylene acrylic acid copolymers, propylene methacrylic acid copolymers, and ethylene vinyl alcohol copolymers.

Examples of commercially available polyolefin polymers include those available under the trade names DOW PRIMACOR 5980i, DUPONT NUCREL, POLYBOND 1103, NIPPON SOARNOL (EVOH), ARKEMA OREVAC 18751, and ARKEMA OREVAC 18360. Exemplary polyolefin polymers that may be used in making suitable powder particles are described in U.S. Pat. No. 9,000,074 (Choudhery), U.S. Pat. No. 8,791,204 (Choudhery), International Pub. No. WO 2014/140057 (Akzo Nobel), U.S. Pat. No. 8,722,787 (Romick et al.), U.S. Pat. No. 8,779,053 (Lundgard et al.), and U.S. Pat. No. 8,946,329 (Wilbur et al.).

Suitable polyolefin particles may be prepared from aqueous dispersions of polyolefin polymer. See, for example, U.S. Pat. No. 8,193,275 (Moncla et al.) for a description of suitable processes for producing such aqueous polyolefin dispersions. Examples of commercially available aqueous polyolefin dispersions include the CANVERA line of products available from Dow, including, for example, the CANVERA 1110 product, the CANVERA 3110-series, and the CANVERA 3140-series. Dry powder polymer particles of the specifications disclosed herein can be achieved using any suitable process, including any of the suitable processes disclosed herein such as, for example, spray drying. Preferably, a chemical process, such as spray drying or limited coalescence, is used to form dry powder polymer particles of the specifications disclosed herein.

The powder polymer particles may include an unsaturated polymer in combination with one or both of an ether component or a metal drier. The ether component may be present in the unsaturated polymer itself. While not intending to be bound by theory, it is believed that the presence of a suitable amount of unsaturation (e.g., aliphatic or cycloaliphatic carbon-carbon double bonds such as present in, e.g., norbornene groups and unsaturated structural units derived from maleic anhydride, itaconic acid, functionalized polybutadiene, and the like) in combination with a suitable amount of ether component or metal drier (e.g., aluminum, cobalt, copper, oxides thereof, salts thereof) can result in molecular weight build during thermal cure of the powder coating composition to form a hardened coating. See, for example, U.S. Pat. No. 9,206,332 (Cavallin et al.) for further discussion of such reaction mechanisms and suitable materials and concentrations. The polymer of the powder polymer particles may have an iodine value of at least 10, at least 20, at least 35, or at least 50. The upper range of suitable iodine values is not particularly limited, but in most such embodiments the iodine value typically will not exceed about 100 or about 120. The aforementioned iodine values are expressed in terms of the centigrams of iodine per gram of the material. Iodine values may be determined, for example, using ASTM D 5768-02 (Reapproved 2006) entitled “Standard Test Method for Determination of Iodine Values of Tall Oil Fatty Acids.”

### Optional Charge Control Agents

In certain preferred embodiments of the powder coating compositions of the present disclosure, one or more charge control agents are included in the coating composition. That is, in such preferred embodiments, the powder polymer particles are in contact with one or more charge control agents.

Preferably, one or more charge control agents are disposed on a surface of the powder polymer particles. The polymer particles are preferably at least substantially coated, or even completely coated, with one or more charge control agents. One or more charge control agents are more preferably adhered to a surface of the powder polymer particles.

Charge control agent(s) enables the powder coating particles to efficiently accept a charge (preferably, a triboelectric charge) to better facilitate electrostatic application to a substrate (e.g., via a conductive or semiconductive transporter such as any of those described herein, e.g., a metallic drum). The charge control agent(s) also allow the powder coating particles to better maintain a latent triboelectric charge for a longer period of time, avoiding a degradation of the electrostatic application properties over time. In addition to the benefits achieved by incorporating one or more charge control agents, the agent(s) should not negatively impact the system. For example, the charge control agent(s) should not interfere in any deleterious way with the function of the any component of the application equipment (such as the fuser) or the performance of the hardened coating (such as adhesion, color development, clarity, or product resistance).

Accordingly, such combination of particles and charge control agent(s) is referred to herein as “triboelectrically chargeable powder polymer particles” (or simply “chargeable polymer particles” or “chargeable particles”). The use and orientation of the charge control agent(s) with respect to the powder polymer particles is well-known to those in the toner printing industry.

During application to a substrate, the charge control agent preferably provides a charge to the powder polymer particles by friction thereby forming charged (i.e., triboelectrically charged) powder polymer particles.

The charge control agents may be for use with positive charged powder coating compositions. Alternatively, the charge control agents may be for use with negative charged powder coating compositions.

The charge control agent may include inorganic particles, organic particles, or both (e.g., inorganic modified organic particles or organometallic particles). Preferably, the charge control agent includes inorganic particles. Inorganic particles can also function as flow aids to enhance the flowability of the powder and reduce surface forces as well as acting as a process aid for spray drying; however, flow aids typically cannot function as charge control agents. Charge control agents can be either positively charged or negatively charged.

The charge control agent particles may be of any suitable size. Typically, the charge control agent particles have particle sizes in the sub-micron range (e.g., less than 1 micron, 100 nanometers or less, 50 nanometers or less, or 20 nanometers or less), although any suitable size may be employed. Preferably, the particle size of the charge control agent particles is of 0.001 micron to 0.10 micron. A useful method for determining particle sizes of the charge control agent particles is laser diffraction particle size analysis, as described herein for the powder polymer particles.

Examples of suitable charge control agents include hydrophilic fumed aluminum oxide particles, hydrophilic precipitated sodium aluminum silicate particles, metal carboxylate and sulfonate particles, quaternary ammonium salt particles (e.g., quaternary ammonium sulfate or sulfonate particles), polymers containing pendant quaternary ammonium salt particles, ferromagnetic pigments, transition metal particles, nitrosine or azine dye particles, copper phthalocyanine pigment particles, metal complexes of chromium, zinc, aluminum, zirconium, or calcium, in the form of particles or combinations thereof.

### Optional Carrier Particles

In certain preferred embodiments the powder coating composition includes one or more carriers (i.e., carrier particles) in addition to, or in place of, one or more charge control agents.

Carriers (i.e., carrier particles) are used to transport powder polymer particles and tribocharge the powder polymer particles to the polarity required for deposition. Carriers are typically granular and may be larger by approximately 1.5× to 100× or more than the powder polymer particles. Sand, glass, aluminum, iron, steel, nickel, magnetite, and ferrite have all can be used as carriers.

Suitable non-magnetic carrier particles include glass, non-magnetic metal, polymer, and ceramic material. These particles can be of various shapes, for example, irregular or regular shape, and sizes (e.g., similar to the particle sizes of the powder polymer particles), although spherical, substantially spherical, or potato shaped are preferred.

Magnetic carrier particles are preferred. Suitable magnetic carrier particles have a core of, for example, iron, steel, nickel, magnetite, γ-Fe₂O₃, or certain ferrites, such as for example, CuZn, NiZn, MnZn, and barium ferrites. Magnetic carriers may be solvent coated or powder coated with charge control agents such as polymethyl methacrylate (PMMA) or polyvinylidene fluoride (PVF), or uncoated, and spherical or irregular in shape. Magnetic carriers have the advantage of being easily transported by permanent magnets inside a roller. This is done to both tribocharge the polymer powder particles and move them into proximity with a photoconductor or other electrographic imaging member for deposition. Magnetic carriers include spherical iron powders, spherical ferrites, magnetite, and irregular iron powder.

More information is found about carriers in “Carrier Materials for Imaging” by L. Jones, in Handbook of Imaging Materials, eds. A. Diamond, D. Weiss, 2^{nd} edition (2002) pp. 209-238.

When mixed with powder polymer particles, sufficient carrier is used that the surface area of all the carrier particles is large enough for all the polymer powder particles to be in contact with at least one carrier particle. In other words, the polymer powder particles should coat all the carrier without large amounts of excess toner particles. The weight percentage of polymer powder particles required for adequate tribocharging actually depends on the surface area per unit weight of carrier particles and the density of the particles.

### Optional Additives

The powder coating composition of the present disclosure may include one or more other optional additives to provide desired effects. For example, such optional additives may be included in the coating composition to enhance composition aesthetics, to facilitate manufacturing, processing, handling, and application of the composition, and to further improve a particular functional property of the coating composition or a hardened coating resulting therefrom. One or more optional additives may form a part of the particles themselves, such as part of chemically produced (e.g., spray dried) particles.

Because hardened coatings of the present disclosure are preferably used on food-contact surfaces, it is desirable to avoid the use of additives that are unsuitable for such surfaces due to factors such as taste, toxicity, or other government regulatory requirements.

Examples of such optional additives, particularly those suitable for use in coatings used on food-contact surfaces, include lubricants, adhesion promoters, crosslinkers, catalysts, colorants (e.g., pigments or dyes), ferromagnetic pigments, degassing agents, levelling agents, matting agents, wetting agents, surfactants, flow control agents, heat stabilizers, anti-corrosion agents, adhesion promoters, inorganic fillers, metal driers, and combinations thereof. The powder coating composition may include one or more lubricants, pigments, crosslinkers, or a combination thereof.

In preferred embodiments, powder coating compositions of the present disclosure include one or more lubricants, e.g., for flexibility. In this context, a lubricant is a compound that reduces the friction at the surface of a coating to impart abrasion resistance to the finished coated metal substrate. It is distinct from a flow improver that aids in the flow of the coating composition and application of a coating to a metal substrate.

Examples of suitable lubricants include carnauba wax, synthetic wax (e.g., Fischer-Tropsch wax), polytetrafluoroethylene (PTFE) wax, polyolefin wax (e.g., polyethylene (PE) wax, polypropylene (PP) wax, and high-density polyethylene (HDPE) wax), amide wax (e.g., micronized ethylene-bis-stearamide (EBS) wax), combinations thereof, and modified version thereof (e.g., amide-modified PE wax, PTFE-modified PE wax, and the like). The lubricants may be micronized waxes, which may optionally be spherical. Lubricants facilitate manufacture of metal cans, particularly metal riveted can ends and pull tabs, by imparting lubricity, and thereby flexibility, to sheets of coated metal substrates.

One or more lubricants may be present in a powder coating composition of the present disclosure in an amount of at least 0.1 wt-%, at least 0.5 wt-%, or at least 1 wt-%, based on the total weight of the powder coating composition, or the total weight of the overall hardened coating. Further, one or more lubricants may be present in an amount of up to 4 wt-%, up to 3 wt-%, or up to 2 wt-%, based on the total weight of the powder coating composition, or the total weight of the overall hardened coating. The concentrations in the hardened coating are equivalent to the concentrations of the starting materials in the powder coating composition.

The lubricant may be present in the powder polymer particles, on the powder polymer particles, in another ingredient used to form the powder coating composition, or a combination thereof. The lubricant may also be applied in a second powder coating composition that is applied in a separate powder layer. For example, the lubricant may be applied in a “dust-on-dust” approach on a base powder layer including the powder polymer particles of the present disclosure, prior to cure of the base powder layer.

Examples of suitable commercially available lubricants include the CERETAN line of products from Munzing (e.g., the CERETAN MA 7020, MF 5010, MM 8015, MT 9120, and MXD 3920 products); the LUBA-PRINT line of products from Munzing (e.g., the LUBA-PRINT 255/B, 276/A (ND), 351/G, 501/S-100, 749/PM, and CA30 products); the SST-52, S-483, FLUOROSLIP 893-A, TEXTURE 5347 W, and SPP-10 products from Shamrock; the CERAFLOUR line of products from BYK (e.g., the CERAFLOUR 981, 988, 996, 258, and 970 products); and the CERACOL 607 product from BYK. In some embodiments, PTFE-free lubricants (i.e., those that do not contain polytetrafluoroethylene) are preferred. In some embodiments, the coating composition is free of any lubricants made using fluorine-containing ingredients.

Particle sizes of some of these lubricants, and methods used to determine such particle sizes as identified by the suppliers (although, herein, such lubricant particle sizes may be measured by laser diffraction particle size analysis), are presented in the following table.

| Supplier | Lubricant | Chemistry of Lubricant* | Particle Size* | Method* |
|---|---|---|---|---|
| Munzing | Ceretan MA | Micronized ethylene-bis- | D99 <20 μm/ | LV 5 ISO 13320 |
| | 7020 | stearamide wax | D50 <5 μm | |
| Munzing | Ceretan MF | Spherical, micronized PTFE | D99 <10 μm/ | LV 5 ISO 13320 |
| | 5010 | modified polyolefin wax | D50 <4 μm | |
| Munzing | Ceretan MM | Sperical, micronized montan | D99 <15 μm/ | LV 5 ISO 13320 |
| | 8015 | wax | D50 <6 μm | |
| Munzing | Ceretan MT | High melting, spherical, | D99 <20 μm/ | LV 5 ISO 13320 |
| | 9120 | micronized Fischer-Tropsch | D50 <7 μm | |
| | | wax | | |
| Munzing | Ceretan | Coated, micronized wax | D99 <20 μm/ | LV 5 ISO 13320 |
| | MXD 3920 | with diamond-like hardness | D50 <4 μm | |
| Munzing | LUBA-print | Carnauba wax dispersion | D50: 2-3 μm/ | Picture-Particle- |
| | 255/B | | D98: <6 μm | Analyzing |
| | | | | System |
| Munzing | LUBA-print | Polyethylene-wax/PTFE | D50: 2-3 μm/ | Picture-Particle- |
| | 276/A | dispersion | D98: <8 μm | Analyzing |
| | | | | System |
| Munzing | LUBA-print | Functional blend wax | D50: 2-3 μm/ | Picture-Particle- |
| | 351/G | dispersion | D98: <5 μm | Analyzing |
| | | | | System |
| Munzing | LUBA-print | Polyethylene-wax dispersion | D50: 2.5-4 μm/ | Picture-Particle- |
| | 501/S-100 | | D98: <8 μm | Analyzing |
| | | | | System |
| Munzing | LUBA-print | Amide-wax dispersion | D50: 2-3 μm/ | Picture-Particle- |
| | 749/PM | | D98: <5 μm | Analyzing |
| | | | | System |
| Munzing | LUBA-print | Carnauba wax dispersion | D98: 3.0 μm | Single pass test |
| | CA 30 | | | |
| BYK | Ceraflour | Micronized PTFE | D50: 3 μm/ | Laser diffraction- |
| | 981 | | D90: 6 μm | volume |
| | | | | distribution |
| BYK | Ceraflour | Micronized, amide-modified | D50: 6 μm/ | Laser diffraction- |
| | 988 | polyethylene wax | D90: 13 μm | volume |
| | | | | distribution |
| BYK | Ceraflour | Micronized, PTFE-modified | D50: 6 μm/ | Laser diffraction- |
| | 996 | polyethylene wax | D90: 11 μm | volume |
| | | | | distribution |
| BYK | Ceraflour | Micronized polypropylene | D50: 9 μm/ | Laser diffraction- |
| | 970 | wax | D90: 14 μm | volume |
| | | | | distribution |
| BYK | Ceramat 258 | Dispersion of an oxidized | 30 μm | Hegman |
| | | HDPE wax | | |
| BYK | Ceracol 607 | PTFE-modified | D50: 4 μm/ | Laser diffraction- |
| | | polyethylene wax dispersion | D90: 10 μm | volume |
| | | | | distribution |

*According to Manufacturer's Literature

In preferred embodiments, powder coating compositions of the present disclosure include one or more crosslinkers and/or catalysts. Additionally, or alternatively, the powder coating composition may include one or more self-crosslinkable polymers.

The term “crosslinker” refers to a molecule capable of forming a covalent linkage between polymers or between two different regions of the same polymer. Examples of suitable crosslinkers include carboxyl-reactive curing resins, with beta-hydroxyalkyl-amide crosslinkers being preferred such crosslinkers (e.g., available commercially under the trade name PRIMID from EMS-Griltech (e.g., the PRIMID XL-552 and PRIMID QM-1260 products)) and hydroxyl-curing resins such as, for example, phenolic crosslinkers, blocked isocyanate crosslinkers, and aminoplast crosslinkers. Other suitable curing agents may include benzoxazine curing agents such as, for example, benzoxazine-based phenolic resins or hydroxy alkyl ureas. Examples of benzoxazine-based curing agents are provided in U.S. Pat. Pub. No. 2016/0297994 (Kuo et al.). Examples of hydroxy alkyl ureas are provided in U.S. Pat. Pub. No. 2017/0204289 (Kurtz et al.).

Phenolic crosslinkers include the condensation products of aldehydes with phenols. Formaldehyde and acetaldehyde are preferred aldehydes. Various phenols can be employed such as phenol, cresol, p-phenylphenol, p-tert-butylphenol, p-tert-amylphenol, and cyclopentylphenol.

Aminoplast crosslinkers are typically the condensation products of aldehydes such as formaldehyde, acetaldehyde, crotonaldehyde, and benzaldehyde with amino or amido group-containing substances such as urea, melamine, and benzoguanamine. Examples of suitable aminoplast crosslinking resins include benzoguanamine-formaldehyde resins, melamine-formaldehyde resins, esterified melamine-formaldehyde, and urea-formaldehyde resins. One specific example of a suitable aminoplast crosslinker is the fully alkylated melamine-formaldehyde resin commercially available from Cytec Industries, Inc. under the trade name of CYMEL 303.

Examples of other suitable crosslinkers (e.g., phenolic crosslinker, amino crosslinker, or a combination thereof) and catalysts (e.g., a titanium-containing catalyst, a zirconium-containing catalyst, or a combination thereof) are described in U.S. Pat. No. 8,168,276 (Cleaver et al.).

Preferably, the powder coating composition does not include any added crosslinkers. In such embodiment, the polymer of the powder particles may, or may not, be a self-crosslinking polymer, depending on the chemistry of the selected polymer and the desired coating properties.

One or more crosslinkers may be present in a powder coating composition of the present disclosure in an amount of at least 0.1 wt-%, at least 1 wt-%, at least 2 wt-%, at least 5 wt-%, or at least 8 wt-% based on the total weight of the powder coating composition, or the total weight of the overall hardened coating. One or more crosslinkers may be present in an amount of up to 40 wt-%, up to 30 wt-%, up to 20 wt-%, or up to 10 wt-%, based on the total weight of the powder coating composition, or the total weight of the overall hardened coating. The concentrations in the hardened coating are equivalent to the concentrations of the starting materials in the powder coating composition.

One or more catalysts may be present in a powder coating composition of the present disclosure in an amount of at least 0.01 wt-%, based on the total weight of the powder coating composition, or the total weight of the overall hardened coating. One or more catalysts may be present in an amount of up to 5 wt-%, based on the total weight of the powder coating composition, or the total weight of the overall hardened coating. The concentrations in the hardened coating are equivalent to the concentrations of the starting materials in the powder coating composition.

In preferred embodiments, powder coating compositions of the present disclosure include one or more colorants, such as a pigment and/or dye. Examples of suitable colorants for use in the powder coating composition include titanium dioxide, barium sulfate, carbon black, and iron oxide, and may also include organic dyes and pigments.

One or more colorants may be present in a powder coating composition of the present disclosure in an amount of, for example, at least 1 wt-%, at least 2 wt-%, at least 5 wt-%, at least 10 wt-%, or at least 15 wt-%, based on the total weight of the powder coating composition, or the total weight of the overall hardened coating composition. One or more colorants may be present in an amount of up to 50 wt-%, up to 40 wt-%, up to 30 wt-%, or up to about 20%, based on the total weight of the powder coating composition, or the total weight of the overall hardened coating. The concentrations in the hardened coating are equivalent to the concentrations of the starting materials in the powder coating composition. The use of a higher colorant concentration may be advantageous to achieve good coverage with thinner coatings.

Powder coating compositions of the present disclosure may include one or more inorganic fillers. Exemplary inorganic fillers used in the powder coating composition of the present disclosure include, for example, clay, mica, aluminum silicate, fumed silica, magnesium oxide, zinc oxide, barium oxide, calcium sulfate, calcium oxide, aluminum oxide, magnesium aluminum oxide, zinc aluminum oxide, magnesium titanium oxide, iron titanium oxide, calcium titanium oxide, and mixtures thereof.

The inorganic fillers are preferably nonreactive, and may be incorporated into the powder coating composition in the form of a powder, preferably with a particle size distribution that is the same or smaller than that of the blend of one or more powder polymer particles.

One or more inorganic fillers may be present in a powder coating composition of the present disclosure in an amount of at least 0.1 wt-%, at least 1 wt-%, or at least 2 wt-%, based on the total weight of the powder coating composition, or the total weight of the overall hardened coating. One or more inorganic fillers may be present in an amount of up to 20 wt-%, up to 15 wt-%, or up to 10 wt-%, based on the total weight of the powder coating composition, or the total weight of the overall hardened coating. The concentrations in the hardened coating are equivalent to the concentrations of the starting materials in the powder coating composition.

In preferred embodiments, powder coating compositions of the present disclosure include one or more flow control agents. The flow control agent may assist in achieving a uniform thin film and may further assist in reducing lumping and dust issues that may otherwise occur with fine powder particles.

Examples of flow control agents are inorganic particles, such as silica particles (e.g., hydrophobic fumed silica particles, hydrophilic fumed silica particles, hydrophobic precipitated silica particles, hydrophilic precipitated silica particles), and organic resins, such as polyacrylics.

Examples of commercially available materials for use as flow control agents include the AEROSIL, AEROXIDE, and SIPERNAT lines of products from Evonik (e.g., the AEROSIL R972, R816, 200, and 380 products; the AEROXIDE Alu C product; and the SIPERNAT D 17, 820A, 22 S, 50 S, and 340 products); the BONTRON series of products from Orient Corporation of America (e.g., the BONTRON E-Series, S-Series, N-Series, and P-Series lines of products); and the HDK line of pyrogenic silica products from Wacker (e.g., the HDK H1303VP, H2000/4, H2000T, and H3004 products).

An exemplary flow control agent for use in the powder coating composition is a polyacrylate commercially available under the tradename PERENOL from Henkel Corporation, Rocky Hill, CT. Additionally, useful polyacrylate flow control agents are commercially available under the tradename ACRYLON MFP from Protex France, and those commercially available from BYK-Chemie GmbH, Germany. Numerous other compounds known to persons skilled in the art also may be used as a flow control agent.

One or more flow control agents may be present in a powder coating composition of the present disclosure in an amount of at least 0.1 wt-%, or at least 0.2 wt-%, based on the total weight of the powder coating composition, or the total weight of the overall hardened coating. One or more flow control agents may be present in an amount of up to 5 wt-%, or up to 1 wt-%, based on the total weight of the powder coating composition, or the total weight of the overall hardened coating. The concentrations in the hardened coating are equivalent to the concentrations of the starting materials in the powder coating composition.

In certain preferred embodiments, powder coating compositions of the present disclosure include one or more matting agents. The matting agents may assist in creating a matt or flat appearance (i.e., appearing to have little to no gloss), uniformly across the surface or selectively in a pattern, by creating a micro-roughness on the surface of the coating that scatters the light and reduces the reflectance (i.e., gloss). Examples of suitable matting agents include silicas, waxes, and fillers.

Examples of commercially available materials for use as matting agents include those available under the trade designations SUNSPHERE L-121, SUNSPHERE L-31, and SUNSPHERE L-51 from Asahi Glass; DEOCOAT 3100, DEOCOAT 3412, DEOCOAT 3500, and DEOCOAT 3607 from DOG Chemie; CRAYVALLAC WN-1110 and CRATVALLAC WN-1135 from Arkem; the CERAFLOUR 913, CERAFLOUR 928, and CERAFLOUR 968 from BYK; and URANOX P 7150 from DSM.

One or more matting agents may be present in a powder coating composition of the present disclosure in an amount of at least 1 wt-%, or at least 2 wt-%, based on the total weight of the powder coating composition, or the total weight of the overall hardened coating. One or more matting agents may be present in an amount of up to 15 wt-%, or up to 10 wt-%, based on the total weight of the powder coating composition, or the total weight of the overall hardened coating. The concentrations in the hardened coating are equivalent to the concentrations of the starting materials in the powder coating composition.

In certain preferred embodiments, powder coating compositions of the present disclosure are formulated to achieve a glossy (i.e., highly reflective) appearance by reducing the micro-roughness of the coating uniformly across the surface or selectively in a pattern. This glossy appearance may be achieved by reducing or eliminating the presence of any additives that increase micro-roughness, especially matting agents. Alternatively, different areas of the same coated article may have areas of high gloss and areas of high matt on the same coated article in a patterned fashion.

In preferred embodiments, powder coating compositions of the present disclosure include one or more surfactants. Examples of suitable surfactants for use in the powder coating composition include wetting agents, emulsifying agents, suspending agents, dispersing agents, and combinations thereof. One or more of the surfactants may be polymeric surfactant (e.g., an alkali-soluble resin). Examples of suitable surfactants for use in the coating composition include non-ionic and anionic surfactants.

One or more surfactants may be present in a powder coating composition of the present disclosure in an amount of at least 0.1 wt-%, or at least 0.2 wt-%, based on the total weight of the powder coating composition, or the total weight of the overall hardened coating. One or more surfactants may be present in an amount of up to 10 wt-%, or up to 5 wt-%, based on the total weight of the powder coating composition, or the total weight of the overall hardened coating. The concentrations in the hardened coating are equivalent to the concentrations of the starting materials in the powder coating composition.

For additives that are in particulate form (e.g., lubricants), the particles have particle sizes that are no larger than the powder polymer particles. Typically, they are in the sub-micron range (e.g., less than 1 micron, 100 nanometers or less, 50 nanometers or less, or 20 nanometers or less), although any suitable size may be employed. A useful method for determining particle sizes of the optional additives (e.g., lubricants) is laser diffraction particle size analysis.

### Methods of Making Powder Coating Compositions

A metal packaging (e.g., a food, beverage, aerosol, or general packaging container, portion thereof, or metal closure) powder coating composition can be made as follows. In an initial step, powder polymer particles as described herein are provided. These are then preferably combined with one or more charge control agents and/or magnetic carrier particles as described herein. These particles, preferably in contact with one or more charge control agents and/or magnetic carrier particles, are then used as is or with one or more optional additives as a powder coating composition that is suitable for use as a metal packaging (e.g., a food, beverage, aerosol, or general packaging container, portion thereof, or metal closure) powder coating composition as described herein.

The polymer particles may be any suitable polymer particles, including, for example, precipitated polymer particles, polymer particles formed by methods other than precipitation, or a combination of precipitated and non-precipitated polymer particles. Any suitable method may be used to form suitably sized precipitated particles of the present disclosure. The method preferably includes providing a carrier (e.g., a solvent) having polymer material dispersed therein, preferably dissolved therein, and reducing the solubility of the polymer material in the carrier (e.g., by cooling the temperature of the carrier, by changing the composition of the carrier, or by changing the concentration of the polymer in the carrier) to form precipitated particles. Preferably, the method includes: preparing a mixture of an organic solvent and a solid crystallizable polymer; heating the mixture to a temperature sufficient to disperse (and preferably dissolve), but not melt, the solid crystallizable polymer in the organic solvent; and cooling the mixture to form precipitated polymer particles.

The powder polymer particles may be prepared using an emulsion, suspension, solution, or dispersion polymerization method, which are well-known to those skilled in the art. For example, a polymer may be prepared in the form of an aqueous emulsion, suspension, solution, or dispersion using standard techniques and subsequently dried to form particles using any of a variety of techniques including, for example, spray drying, fluidized bed drying, vacuum drying, radiant drying, freeze drying, and flash drying, among others. Preferably, drying involves spray drying. Polymer particles produced using emulsion/suspension/dispersion/solution polymerization are not typically considered precipitated particles.

The powder polymer particles are preferably not prepared by grinding a polymer to form ground polymer particles (that is, the particles are not provided as ground particles).

Preferably, the powder polymer particles are provided as agglomerates of primary polymer particles, as described herein, which may be prepared using standard techniques well-known to those skilled in the art. For example, a polymer may be prepared in the form of an aqueous emulsion/dispersion/suspension/solution technique and subsequently dried using, for example, a spray drying technique. Spray drying may form agglomerates directly. Spray drying involves the atomization of a liquid feedstock into a spray of droplets and contacting the droplets with hot air in a drying chamber. The sprays are typically produced by either rotary (wheel) or nozzle atomizers. Evaporation of moisture from the droplets and formation of dry particles proceed under controlled temperature and airflow conditions. Powder particles are typically discharged substantially continuously from the drying chamber. Operating conditions and dryer design are selected according to the drying characteristics of the product specification.

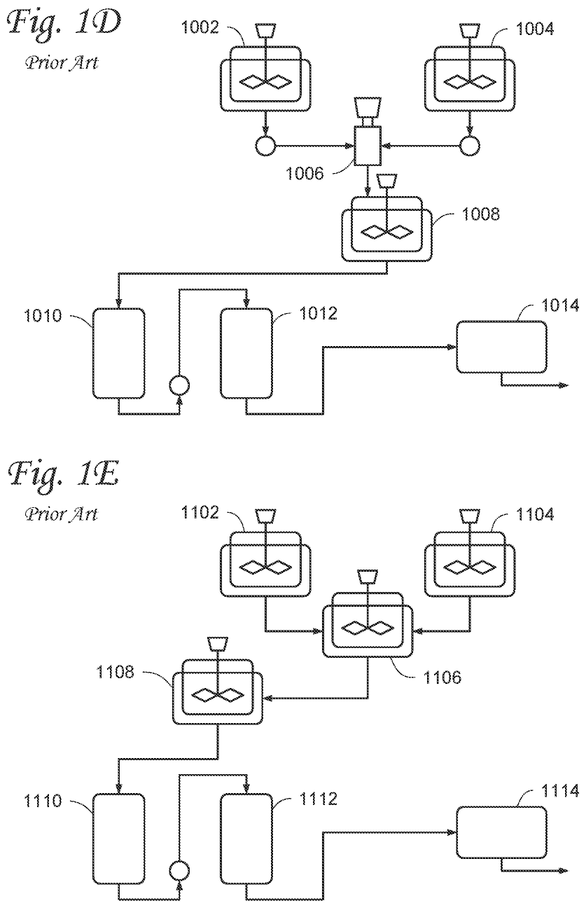

FIG. 2 shows a suitable spray drying apparatus (for example, the Büchi B290 lab-scale spray dryer) that uses a pressurized gas 1, such as compressed air or nitrogen, to generate an aerosolized spray of the liquid product via a stainless steel nozzle 2. This spray is coeluted with a drying gas, such as lab air or nitrogen 3, into a glass drying tower 4 where the droplets of liquid product are dewatered/desolvated by the heated air/gas, resulting in solid powder particles that are largely free of their original solvent or dispersant. A glass cyclone 6 then separates the powder from the heated solvent vapor. If a sample is to be collected to determine particle size and shape, it is typically collected at the collection jar 5 at the bottom of the tower 4 and cyclone 6. Finally, the water/solvent vapor passes through a particulate filter 7 to remove any fine particles before the vapor is exhausted or collected.

Typically, the agglomerated particles formed from a spray drying technique are spherical or substantially spherical (e.g., potato shaped). The particle size of the agglomerates will typically increase with higher solids content of the emulsion/dispersion/suspension/solution and/or with lower atomization pressure in the spray drying nozzles. Secondary drying (e.g., using a fluidized bed) can be done to remove bound water from the agglomerates if desired.

Alternatively, primary particles may be formed, e.g., by emulsion/dispersion/suspension/solution polymerization, or by precipitation, and subsequently aggregated and/or coalesced to form agglomerated particles using, for example, chemical aggregation or mechanical fusion (e.g., heating above the Tg of a polymer to fuse the primary particles into an agglomerated particle). Any suitable aggregation process may be used in forming the aggregated dispersion particles with or without additives (e.g., pigments, lubricants, surfactants).

An example of a particle aggregation process is described in U.S. Pat. No. 9,547,246 (Klier et al.), and includes forming an aqueous dispersion including a thermoplastic polymer, a stabilizing agent capable of promoting the formation of a stable dispersion or emulsion (e.g., a surfactant), optional additives, and an aggregating agent capable of causing complexation (e.g., alkali earth metal or transition metal salts) in a vessel. The mixture is then stirred until homogenized and heated to a temperature of, for example, about 50° ° C. The mixture may be held at such temperature for a period of time to permit aggregation of the particles to the desired size. Once the desired size of aggregated particles is achieved, the pH of the mixture may be adjusted in order to inhibit further aggregation. The particles may be further heated to a temperature of, for example, about 90° C. and the pH lowered in order to enable the particles to coalesce and spherodize. The heater is then turned off and the reactor mixture allowed to cool to room temperature, at which point the aggregated and coalesced particles are recovered and optionally washed and dried. The particle aggregation process may also be used starting from an aqueous dispersion including a thermoset polymer.

Also, the powder polymer particles of the present disclosure may be made using an emulsion aggregation process described in G. E. Kmiecik-Lawrynowicz, DPP2003: IS&T's International Conference on Digital Production Printing and Industrial Applications, pages 211-213, for making toner particles for high quality digital color printing.

The powder polymer particles are preferably combined with one or more charge control agents and/or magnetic carrier particles to form chargeable powder polymer particles, as described herein. Preferably, the method of making a powder coating composition of the present disclosure includes applying one or more charge control agents and/or magnetic carrier particles to the powder polymer particles and forming a powder coating composition. The charge control agents and/or magnetic carrier particles (as with any of the optional additives described herein) may be added to the powder polymer particles during their formation (e.g., as in a spray drying process) or subsequent thereto.

One or more charge control agents may be introduced during, prior to, or both during and prior to, the spray drying process such that polymer droplets or nascent forming particles contact charge control agent. While not intending to be bound by theory, the presence of charge control agent during the spray drying process may be advantageous for purposes of enhancing mobility of the powder polymer particles, avoiding or inhibiting clumping of the powder polymer particles, and/or avoiding or inhibiting sticking of the powder polymer particles on process equipment.

One or more charge control agents may be added to dried particles (e.g., after a spray drying process). For example, one or more charge control agents may be applied to a surface of the powder polymer particles. This may involve completely coating the polymer particles with the one or more charge control agents. It may additionally, or alternatively, involve adhering the one or more charge control agents to the surface of the powder polymer particles.

This combination of charge control agents and powder polymer particles form chargeable particles. For example, the charging of powder particles, e.g., by friction or induction, can be affected using processes commonly known in photocopying technology or laser printer technology (which processes are elucidated in, for example, L. B. Schein, Electrophotography and Development Physics, pages 32-244, Volume 14, Springer Series in Electrophysics (1988)).

Standard methods of mixing may be used if one or more optional additives are used with the chargeable particles, which are well-known to those skilled in the art. The one or more optional additives may be combined with the powder polymer particles, the charge control agent(s), or both. Such optional additives may be added during powder polymer particle preparation or subsequent thereto. Certain of such additives may be incorporated into the powder polymer particles, coated on the powder polymer particles, or blended with the powder polymer particles.

The present disclosure also provides methods that include causing the metal packaging powder coating composition to be used on a metal substrate of metal packaging. In some cases where multiple parties are involved, a first party (e.g., the party that manufactures and/or supplies the metal packaging powder coating composition) may provide instructions, recommendations, or other disclosures about the metal packaging powder coating composition end use to a second party (e.g., a metal coater (e.g., a coil coater for beverage can ends), can maker, or brand owner). Such disclosures may include, for example, instructions, recommendations, or other disclosures relating to coating a metal substrate for subsequent use in forming packaging containers or portions thereof, coating a metal substrate of pre-formed containers or portions thereof, preparing powder coating compositions for such uses, cure conditions or process-related conditions for such coatings, or suitable types of packaged products for use with resulting coatings. Such disclosures may occur, for example, in technical data sheets (TDSs), safety data sheets (SDSs), regulatory disclosures, warranties or warranty limitation statements, marketing literature or presentations, or on company websites. A first party making such disclosures to a second party shall be deemed to have caused the metal packaging powder coating compositions to be used on a metal substrate of metal packaging (e.g., a container or closure) even if it is the second party that actually applies the composition to a metal substrate in commerce, uses such coated substrate in commerce on a metal substrate of packaging containers, and/or fills such coated containers with product.

### Coated Metal Substrates and General Methods of Coating

The present disclosure also provides a coated metal substrate. The metal substrate is preferably of suitable thickness to form a metal food or beverage container (e.g., can), an aerosol container (e.g., can), a general packaging container (e.g., can), or a closure (e.g., for a glass jar). The metal substrate has an average thickness of up to 635 microns, preferably up to 375 microns. Preferably, the metal substrate has an average thickness of at least 125 microns. In embodiments in which a metal foil substrate is employed in forming, e.g., a packaging article, the thickness of the metal foil substrate may be even thinner than that described above.

Such metal substrate has a hardened adherent coating disposed on at least a portion of a surface thereof. The hardened adherent coating is formed from a metal packaging (e.g., a food, beverage, or aerosol can) powder coating composition as described herein with or without one or more optional additives.

Hardened (e.g., cured) coatings of the disclosure preferably adhere well to metal (e.g., steel, stainless steel, electrogalvanized steel, tin-free steel (TFS), tin-plated steel, electrolytic tin plate (ETP), aluminum, etc.), which may or may not be pre-treated. They also provide high levels of resistance to corrosion or degradation that may be caused by prolonged exposure to, for example, food, beverage, or aerosol products.

Thus, metal substrates useful herein include steel, stainless steel, electrogalvanized steel, tin-free steel (TFS), tin-plated steel, electrolytic tin plate (ETP), aluminum, etc. Metal substrates useful herein also includes tab stock and aluminum coil for making beverage can ends (with the hardened coating applied to an interior or exterior surface of the beverage can end, or both). Metal substrates herein may be provided in a coil or sheet form. Metal substrates herein may be provided as a preformed container (e.g., can or cup). If the metal substrate is a preformed can or cup, it can be coated, e.g., by placing it on a spinning mandrel and directing a powder coating composition to the can or cup while it is spinning. Examples of metal cups that may benefit from coating compositions of the present disclosure are those described in U.S. Pat. No. 10,875,076 (Scott) and U.S. Pub. No. 2019/0112100 (Scott). In the context of a hardened adherent coating being disposed “on” a surface or substrate, both coatings applied directly (e.g., virgin metal or pre-treated metal such as electroplated steel) or indirectly (e.g., on a primer layer) to the surface or substrate are included. Thus, for example, a coating applied to a pre-treatment layer (e.g., formed from a chrome or chrome-free pretreatment) or a primer layer overlying a substrate constitutes a coating applied on (or disposed on) the substrate.

If a steel sheet is used as the metal substrate, the surface treatment may comprise one, two, or more kinds of surface treatments such as zinc plating, tin plating, nickel plating, electrolytic chromate treatment, chromate treatment, and phosphate treatment. If an aluminum sheet is used as the metal substrate, the surface treatment may include an inorganic chemical conversion treatment such as chromic phosphate treatment, zirconium phosphate treatment, or phosphate treatment; an organic/inorganic composite chemical conversion treatment based on a combination of an inorganic chemical conversion treatment with an organic component as exemplified by a water-soluble resin such as an acrylic resin or a phenol resin, and tannic acid; or an application-type treatment based on a combination of a water-soluble resin such as an acrylic resin with a zirconium salt.

The metal substrate may be cryogenically cleaned. It may be provided as a cryogenically cleaned metal substrate, or the method coating may include cryogenically cleaning the metal substrate prior to directing a powder coating composition to at least a portion of the metal substrate. In an exemplary process, cryogenic cleaning may be achieved by directing a high-pressure stream of liquid nitrogen (between 5,000 and 50,000 psi and between −150° F. and −250° F.) at the metal surface. The temperature of the metal surface decreases rapidly, causing fracturing of any contaminants. The fractured contaminants are then directed away from the metal surface by the high-pressure stream, leaving behind a cleaned substrate.

In preferred embodiments, the hardened adherent coating is continuous. As such, it is free of pinholes and other coating defects that result in exposed substrate, which can lead to (i) unacceptable corrosion of the substrate, and can even potentially lead to a hole in the substrate and product leakage, and/or (ii) adulteration of the packaged product. Except in embodiments in which coating roughness or texture is desired (e.g., for certain exterior can coatings for aesthetic purposes), the hardened continuous coating is preferably smooth, especially for most interior can coatings.

In certain embodiments, the hardened, preferably continuous, adherent coating has an average total thickness of up to 100 microns (particularly if the coating has texture), or a maximum total thickness up to 100 microns. Typically, however, one or both of the maximum and average total thickness will be appreciably thinner than 100 microns. Preferably, the hardened, preferably continuous, adherent coating has an average total thickness of up to 50 microns, more preferably up to 25 microns, even more preferably up to 20 microns, still more preferably up to 15 microns, and most preferably up to 10 microns, or in certain situations, up to 5 microns. Interior can coatings are typically less than 10 microns (total) thick on average. Preferably, the hardened adherent coating has an average total thickness, or a minimum coating thickness, of at least 1 micron, at least 2 microns, at least 3 microns, or at least 4 microns.

The hardened coatings may be used as coatings on any suitable surface, including inside surfaces of metal packaging containers (e.g., food, beverage, or aerosol can bodies, such as three-piece aerosol cans or aluminum monobloc aerosol cans, as well as two-piece and three-piece food or beverage cans), outside surfaces of such container bodies, riveted can ends, pull tabs, and combinations thereof. The hardened coatings may also be used on interior or exterior surfaces of other packaging containers, or portions thereof, metal closures (e.g., for glass containers) including bottle crowns, recyclable aluminum beverage cups such as those commercially available from the Ball Corporation, or metered dose inhaler (MDI) cans. Such specific cans, cups, and other containers, with interior food-contact surfaces, riveted can ends, and pull tabs have specific flexibility requirements, as well as taste, toxicity, and other government regulatory requirements.

The powder coating compositions of the present disclosure may also be used on substrates other than rigid metal substrate, including substrates for use in packaging food or beverage products or other products. For example, the powder coating compositions may be used to coat the interior or exterior surfaces of metal or plastic pouches or other flexible packaging. The powder coating compositions may also be used to coat fiberboard or paperboard (e.g., as employed for Tetra Pack containers and the like); various plastic containers (e.g., polyolefins), wraps, or films; metal foils; or glass (e.g., exteriors of glass bottles to prevent scratching or provide desired color or other aesthetic effects).

The hardened coating preferably includes less than 50 ppm, less than 25 ppm, less than 10 ppm, or less than 1 ppm, extractables, if any, when tested pursuant to the Global Extraction Test described in the Test Methods. Significantly, such coatings are suitable for use on food-contact surfaces. Thus, a metal packaging container (e.g., a food, beverage, or aerosol can) is provided that includes such coated metal substrate, particularly wherein the coated surface of the metal substrate forms an interior surface of the container body (which contacts a food, beverage or aerosol product). Alternatively, the coated surface is a surface of a riveted can end and/or a pull tab.

In certain embodiments, the metal substrate is in the form of a planar coil or sheet, although for side-seam stripes or other applications in which the can has already been formed the metal substrate may not be planar (e.g., it may be in cylindrical form).

Sheet coating involves applying a coating composition to separate pieces of a substrate that has been pre-cut into square or rectangular “sheets.” Coil coating is a special application method in which coiled metal strips (e.g., aluminum) are unwound and then passed through pretreating, coating, and drying equipment before finally being rewound. It is believed the use of preferred powder coating compositions of the present disclosure can eliminate the need for the pretreatment step employed when using conventional liquid coatings, thereby simplifying the application process and removing cost. Coil coating allows for very efficient coating of large surface areas in a short time at high throughput.

For example, the moving surface of a coil substrate in a continuous process is preferably traveling at a line speed of at least 50 meters per minute, at least 100 meters per minute, at least 200 meters per minute, or at least 300 meters per minute. Typically, the line speed will be less than 400 meters per minute. The curing time of the coil coating applied coating compositions is preferably at least 0.5 second, at least 3 seconds, at least 6 seconds, at least 10 seconds, or at least 12 seconds, and up to 20 seconds, up to about 25 seconds, or up to about 30 seconds. In the context of thermal bakes to cure the coil coating, such curing times refer to the residence time in the oven(s). In such embodiments, the curing process is typically conducted to achieve peak metal temperatures of 200° ° C. to 260° C.

Thus, the process of applying a powder coating composition to a substrate according to the present disclosure is preferably used in a coil-coating process or in a sheet-coating process.

The hardened coating may be formed from a metal packaging powder coating composition as described herein with or without one or more optional additives, particularly one with the powder polymer particles described herein and a lubricant. The lubricant may be present in the hardened coating in the powder polymer particles, on the powder polymer particles, in another ingredient used to form the powder coating composition (or the hardened coating formed therefrom), or a combination thereof. Alternatively or additionally, a lubricant as described herein (e.g., carnauba wax, synthetic wax, polytetrafluoroethylene wax, polyethylene wax, polypropylene wax, or a combination thereof) may be applied to the hardened coating or otherwise disposed on a surface of the hardened coating (e.g., via application of another powder composition). Similarly, the lubricant may be applied in a separate powder layer applied to a first powder layer including the polymer particles of the present disclosure prior to coating cure (i.e., in a so called “dust-on-dust” application technique). However, when it is incorporated into or on the hardened coating, a lubricant is preferably present in an amount of at least 0.1 wt-% (or at least 0.5 wt-%, or at least 1 wt-%), and a lubricant is preferably present in an amount of up to 4 wt-% (or up to 3 wt-%, or up to 2 wt-%), based on the total weight of the powder coating composition (or hardened coating formed therefrom).

Preferably, a hardened coating that includes an amorphous polymer (and/or semicrystalline polymer with amorphous portions) has a glass transition temperature (Tg) of at least 40° C., at least 50° C., at least 60° C., or at least 70° C., and a Tg of up to 150° C., up to 130° C., up to 110° C., or up to 100° C. For many packaging technologies, especially for interior can coatings for more aggressive products, higher Tg coatings are preferred for corrosion resistance.

The hardened coating may not have any detectable Tg.

Preferably, a hardened coating produced from preferred embodiments of the powder coating composition is capable of passing a 4T T-Bend test when disposed on conventional aluminum beverage can end stock at a conventional average dry film coating weight for an interior beverage can coating (e.g., about 2.3 grams per square meter for an interior soda beverage can coating). A useful T-bend testing procedure is described in ASTM D4145-10 (2010, Reapproved 2018).

Flexibility is especially important for a hardened coating on a metal substrate that is fabricated into a metal packaging container (e.g., a food, beverage, or aerosol can) or part of the container (e.g., can), such as a riveted can end or pull tab. Flexibility is important so that the coating can deflect with the metal substrate during post-cure fabrication steps (e.g., necking and dome reformation, or rivet formation), or if the can is dropped from a reasonable height during transport or use.

Flexibility can be determined using the Flexibility Test described in the Test Methods, which measures the ability of a coated substrate to retain its integrity as it undergoes the formation process necessary to produce a riveted beverage can end. It is a measure of the presence or absence of cracks or fractures in the formed end. Preferably, a hardened coating formed from a coating composition described herein passes this Flexibility Test. More preferably, a coating composition, when applied to a cleaned and pretreated aluminum panel and subjected to a curative bake for an appropriate duration to achieve a 242° C. peak metal temperature (PMT) and a dried film thickness of approximately 7.5 milligram per square inch and formed into a fully converted 202 standard opening beverage can end, passes less than 5 milliamps of current while being exposed for 4 seconds to an electrolyte solution containing 1% by weight of NaCl dissolved in deionized water.

### General Methods of Coating a Metal Substrate

A general method of coating a metal substrate suitable for use in forming metal packaging (e.g., a metal packaging container such as a food, beverage, aerosol, or general packaging container (e.g., can), or a portion thereof, or a metal closure) is also provided. Such method includes: providing a metal packaging powder coating composition that includes particles (preferably includes triboelectrically charged particles) as described herein; directing the powder coating composition (preferably triboelectrically charged powder coating composition) to at least a portion of the metal substrate (e.g., coil or sheet), preferably by means of an electric field, an electromagnetic field, or any other suitable type of applied field; and providing conditions effective for the powder coating composition to form a hardened, preferably continuous, coating on at least a portion of the metal substrate.

Directing the powder coating composition to at least a portion of the metal substrate preferably includes: feeding the powder coating composition to a conductive or semiconductive transporter; and directing the powder coating composition (preferably triboelectrically charged powder coating composition) from the transporter to at least a portion of the metal substrate by means of an electric or electromagnetic field, or any other suitable type of applied field. Directing the powder coating composition more preferably includes directing the powder coating composition from the conductive or semiconductive transporter directly to at least a portion of the metal substrate by means of an electric field between the transporter and the metal substrate.

Directing the powder coating composition preferably includes: directing the powder coating composition (preferably, triboelectrically charged powder coating composition) from the conductive or semiconductive transporter to a transfer member by means of an electric field, electromagnetic field, or any other suitable type of applied field, between the conductive or semiconductive transporter and the transfer member; and transferring the powder coating composition from the transfer member to at least a portion of the metal substrate. The transfer may be carried out by applying, for example, thermal energy (using thermal processing techniques), or other forces, such as electrical, electrostatic, or mechanical forces, to effect transfer.

This process is similar to conventional electrographic printing processes, but can be required to continuously produce a fully coated substrate (e.g., more than 90%), as opposed to a printing process, wherein the coverage is typically much less (e.g., only 10%) of the substrate. For example, the charging of the powder particles by friction or induction (known as triboelectric charging), and the transporting or conveying and the application to substrates can be effected using processes commonly known in electrophotography, photocopying technology, or laser printer technology. In particular, an electric field can be applied using conventional methods, such as a voltage supply or a corona discharge, to produce a moving or fixed counter electrode. Such processes are elucidated in, for example, U.S. Pat. No. 6,342,273 (Handels et al.) and L. B. Schein, Electrophotography and Development Physics, pages 32-244, Volume 14, Springer Series in Electrophysics (1988).

A transfer member may be used, including, for example, semiconductive or insulative drums or belts. Transfer belts and drums are usually compliant or have a compliant backing roller, and are made of polyurethane or polyimide containing conductive additives. For example, U.S. Pat. No. 8,119,719 (Park et al.) discloses that a transfer belt may have volume resistivity of 10⁸ to 1013 ohm-cm, a contact angle of 105-113°, and an elastic modulus of 0.8-4.5 GPa. The conductive or semiconductive belt may have a non-conductive coating, such as a fluoropolymer release surface. Transfer belts and drums function similarly and have similar compositions. Transfer can be carried out in one or more steps using multiple transfer members.

The powder coating composition preferably includes magnetic carrier particles, although non-magnetic particles may also be used as described herein.

Preferably, the transporter includes a magnetic roller and the powder coating composition containing magnetic carrier particles is conveyed by means of a magnetic roller as described in, for example, U.S. Pat. No. 4,460,266 (Kopp et al.). Magnetic rollers can have a fixed magnetic core or a rotating magnetic core. Although magnetic carrier particles are preferably used in the powder coating composition, substantially all of the magnetic carrier particles stay with the transporter. Some magnetic carrier particles may be deposited on the substrate, but it is not intended to form part of the final coating on the metal substrate. Usually, such magnetic carrier particles are transitive and removed by a strong magnet. In addition to a magnetic roller or brush apparatus, also useful in the present process are, for example, non-magnetic cascade development processes. In addition, transport by air, for example, powder cloud development, may be used, as described, for example, in U.S. Pat. No. 2,725,304 (Landrigan et al.).

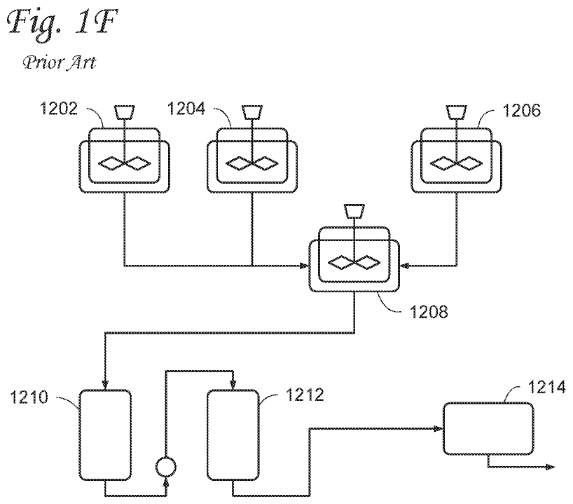

FIG. 3A provides a line drawing of an application device 10 capable of delivering a powder coating composition 13 to a substrate 11 without the aid of magnetic carrier particles. FIG. 3B provides a line drawing of an application device 10′ capable of delivering a powder coating composition 13′ to a substrate 11′ with the aid of a magnetic carrier. Although FIGS. 3A and 3B employ a transporter 15/15′ in the form of a conductive or semiconductive drum, other transporter structures (e.g., belts, etc.) may be used in place of a drum. During an exemplary process, a uniform voltage (either positive or negative, but assumed negative in this example) is induced on the surface 34/34′ of a photo-conductive drum 15/15′ (i.e., a drum having a photo-conductive coating thereon) by a corona charger or roller charger 16/16′ that applies a uniform negative charge to the surface of the photo-conductive drum 15/15′. A scanning light source 17/17′ (for example, either a laser and mirror assembly or a light emitting diode (LED) array) converts a computer-generated image into a corresponding pattern on the drum 15/15′. The surface of the drum 15/15′ will lose negative charge anywhere the light source 17/17′ impinges on the surface of the drum 15/15′, for example, at location 36/36′. Concurrently, a powder coating composition is triboelectrically charged by movement through a series of augers and/or by a biased charging member and applied to a transporter, usually in the form of a developer roll 19/19′, that carries the powder coating composition to the drum 15/15′ from a hopper/reservoir 18/18′. The electrostatic charge on the polymeric powder and the voltage on the transporter 38/38′ is such that negatively charged powder (once brought into close contact with the drum 15/15′) is electrostatically adhered to the areas of the drum that were exposed, and positively charged powder is electrostatically adhered to the areas of the drum that were not exposed. Adherence of powder to areas that were discharged is called Discharge Area Development (DAD). Adherence of powder to areas that were never discharged and retain a high charge is called Charged Area Development (CAD).

In some cases, as demonstrated by FIG. 3A, the powder coating formulation is developed such that no magnetic carrier particles are required. This is typically done by careful selection of charge control and flow control agents discussed elsewhere herein and by tribocharging, induction, or corona charging, with charging member 20, which can also be a powder coating gun, charged fluidized bed, or the like. In some cases, as demonstrated by FIG. 3B, magnetic carrier particles (which are generally not transferred to the drum or substrate) are employed to electrostatically charge powder coating particles and move them into juxtaposition with drum 15′.

One or more electrical grounds 12/12′, as shown in FIGS. 3A and 3B, keep the metal substrate 11/11′ at electrical ground of 0 volts (0V) to transfer the powder coating particles from the drum 15/15′ to the substrate 11/11′, in the pattern that the scanning light source 17/17′ created on the drum 15/15′. The resulting pattern of powder coating particles on the metal substrate 11/11′ are then passed through a thermal, radiation, or induction fuser 14/14′ that causes the particles to fuse into one another and form a continuous coating. The surface 40/40′ of metal substrate 11/11′ can be uncoated metal, have a conductive or semicondutive coating, or have a nonconductive insulative coating.

Biasing the substrate 11/11′ to ground potential (0 V) assists with transfer of the powder to the substrate by eliminating or reducing any electrical charges on the substrate 11/11′ that may adversely affect transfer of the powder to the substrate 11/11′. For each deposition or transfer step, a potential difference of magnitude at least 50 V is needed, preferably at least 200V, and more preferably, at least 400 V or more. One of the upper limits to the potential difference is the breakdown voltage of air, approximately 3V/micron. Particle charges are generally of magnitude 10 to 50 microcoulombs/gram (μC/g).

For negatively charged particles and DAD, assuming that substrate 11/11′ is at ground potential of 0 V, photoconductor conductive layer 30/30′ should be at least −200V and preferably at least −400 V or more, charger 16/16′ should charge the surface of drum 15/15′ at location 34/34′ preferably to a potential of at least −1200 V (resulting in exposed areas 36/36′ on the drum being at least approximately −450 V or more negative in voltage) and developer roller 19/19′ should be at least −1100 VDC in magnitude, or more negative in DCV.

For positively charged particles and CAD, assuming that substrate 11/11′ is at ground potential of 0 V, photoconductor conductive layer 30/30′ should be at least 200 V and preferably at least 400 V or more, charger 16/16′ should charge the surface of drum 15/15′ at location 34/34′ preferably to a potential of at least −400 V (resulting in exposed areas 36/36′ on the drum being approximately 350 V or more positive in voltage) and developer roller 19/19′ should be at least 250 VDC in magnitude or more positive in DCV. If non-contact development is performed, an AC voltage is added to the developer roller DC voltage.

The key point in the discussion of bias voltages is that the photoconductor conductive layer is preferably biased to a non-zero voltage (and is not held at ground per the prior art) to enable deposition of charged powder coating particles to a grounded substrate. The voltages are given as examples. Ranges will depend on the exact geometry, separation distances, and composition of imaging members, as is well known in the art. Biasing the photoconductor conductive layer allows use of a transfer roller with a single bias. If the photoconductor conductive layer is at ground potential, a transfer belt must be used with backing rollers of opposite polarity to transfer the powder coating particles from the photoconductor to the transfer belt and subsequently to transfer the powder coating particles from the transfer belt to the substrate, which is preferably also at ground potential of 0 volts.

The systems in FIGS. 3A and 3B are used as electrophotographic office laser printers with additional subsystems known to the art, including toner supplies and cleaning systems. For electrophotographic office laser printers, the substrate is usually paper. For powder coating metal, the substrate is metal, which can scratch or wear the photoconductor surface. It is good design practice to avoid two moving hard surfaces in contact with each other. A polymeric roller 19 or magnetic brush 19′ can both be used with an adjacent hard surface. FIG. 3C shows direct deposition from a polymeric roller 19 or a magnetic brush 19′ to a substrate 11. An appropriate bias voltage is applied between 19/19′ and 11 to apply a powder coating composition to substrate 11. FIG. 3D shows direct deposition through a movable stencil 42 from a polymeric roller 19 or a magnetic brush 19′ similar to U.S. Pat. No. 5,450,789 (Hasegawa).

A polymeric transfer roller or belt can also be used in contact with a hard surface. FIG. 3E shows deposition onto a substrate 11 from an electrophotographic drum 50, from an electrophotographic master drum 52, or from an electrographic master drum 54 using a polymeric transfer member 60. Electrophotographic drum 50 is photoconductive and can be charged and exposed anywhere on its surface. Electrophotographic master drum 52 has areas that are either always at ground potential or insulated and other areas that are photoconductive and can be charged and exposed. A charged particle pattern is produced on electrophotographic master drum 50 using DAD or CAD. Electrographic master drum 54 has areas that are at high potential and other areas that are at lower potential. Means of producing this pattern of electrical potential include using a conductive drum with an insulative pattern on it, corona charging the insulative pattern, and biasing or grounding the drum. Another means of producing a pattern of electrical potential on electrographic master drum 54 is to make a drum that has conductive areas biased to a high potential and complementary conductive areas biased to a low potential, where the high potential conductive areas are electrically isolated from the low potential conductive areas. A charged particle pattern is produced on electrographic master drum 54 using DAD or CAD. Electrographic master drum 56 is made of a semiconductive polymer with debossed areas that are coated with charged particles that are electrostatically deposited on substrate 11. If imaging members 50/52/54/56 can be made compliant, then transfer member 60 is not needed, and coating particles can be directly applied to substrate 11 from imaging member 50/52/54/56. The conditions effective for the powder coating composition to form a hardened coating on at least a portion of the metal substrate preferably includes applying thermal energy (e.g., using a convection oven or induction coil), UV radiation, IR radiation, or electron beam radiation to the powder coating composition. Such processes can be carried out in one or more discrete or combined steps. The conditions may include applying thermal energy. Applying thermal energy may include using oven temperatures of at least 100° C. or at least 177° ° C. Applying thermal energy may further include using oven temperatures of up to 300° C. or up to 250° ° C. Applying thermal energy may include heating the coated metal substrate over a suitable time period to a peak metal temperature (PMT) of at least 177° C. Preferably, applying thermal energy includes heating the coated metal substrate over a suitable time period to a peak metal temperature (PMT) of at least 218° C. The time period may be as short as 0.5 second, or less than 1 second, or less than 3 seconds, or less than 5 seconds, or as long as 15 minutes, and preferably less than 12 minutes, less than 10 minutes, less than 8 minutes, less than 5 minutes, less than 4 minutes, less than 3 minutes, less than 2 minutes, or less than 1 minute, for forming a coil coating. Preferably, this occurs in a continuous process.

Coated metal substrates of the present disclosure may be drawn and redrawn. Significantly, the coating on the resultant thinned metal substrate remains continuous and adherent.

Application systems containing multiple application devices can be used to deliver multiple powder coating layers and patterns to a substrate. For example, the application devices in FIGS. 3A through 3E can be used in series to coat a conductive metal substrate with sequential charged particle patterns. Also, one or more application devices can be used to sequentially deposit charged particle patterns on a transfer apparatus and accumulate multiple charged particle patterns for transfer to a conductive metal substrate. The transfer apparatus typically consists of a semiconductive or insulative belt.

Charged particle patterns using positively charged particles, and separate charged particle patterns using negatively charged particles, can be deposited on the same conductive metal substrate, if a corona charger is used between application devices or application systems to change the polarity of the particles applied to the substrate in a first pattern to the same polarity as the particles to be applied in a second pattern. For example, a positively charged base layer can be applied to a conductive metal substrate, and corona charged negative to change polarity of the coating particles to negative, so that negatively charged layers of electrophotographic color toners can be subsequently applied.

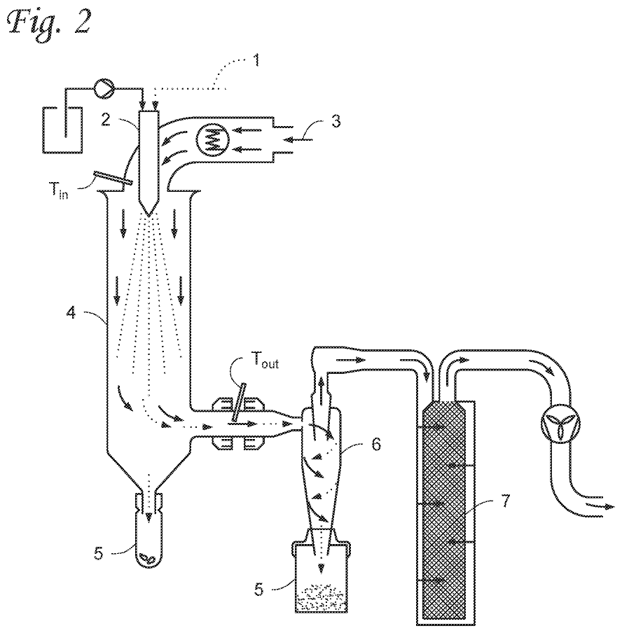

FIG. 4A is a schematic diagram of an application system 100 that includes a pair of application devices 110, each of which is configured to deliver a powder coating composition to a substrate 111 using a transfer apparatus 120 (e.g., a semiconductive or insulative belt, etc.). Although the depicted embodiment includes a transfer apparatus 120, in one or more alternative embodiments, two or more application devices 110 can be arranged to deliver powder coating compositions to the same substrate 111. Regardless of the presence or absence of a transfer apparatus 120, the powder coating compositions delivered using the different application devices 110 may be the same or different.

Another feature depicted in FIG. 4A in connection with the application system 100 are cartridges 130, with each cartridge 130 connected to one of the application devices 110. The cartridges 130 contain a volume of the powder coating compositions described herein and are configured to dispense the powder coating compositions to the application device 110 to which the cartridges 130 are connected.

Although the cartridges used in the cartridge-based delivery systems and methods described herein are depicted separately in, for example, FIG. 4A, in one or more embodiments, two or more of the cartridges may be connected (e.g., ganged, etc.) to form a multi-reservoir cartridge, wherein the different enclosed volumes of the connected cartridges contain the same or different powder coating compositions as described herein.

FIG. 4B shows an application system 100 used sequentially after an application device 110′, with a corona charger 140 used after application device 110′ to recharge the powder pattern applied by application device 110′. For example, this application system can be used to deposit a positively charged base layer onto a metal substrate, change the polarity of the base layer with a corona charger, and deposit at least one negatively charged conventional color imaging toner onto the base layer. This color imaging toner does not need to have the high durability and high molecular weight of the base layer. In a simple extension of the process shown in FIG. 4B, the negatively charged layers on the substrate can be corona charged positive and coated with another positive protective coating.

FIGS. 3A through 3E and 4A-4B show only components necessary to describe each of the application devices to a skilled practitioner. Power supplies, electrical grounds, voltages, chargers, cleaners, digital computers, and other components necessary for operation are used per the prior art.

In certain embodiments of coating a metal substrate described herein, the method comprises electrically grounding the metal substrate while directing at least one powder coating composition of the multiple powder coating compositions to the at least a portion of the substrate. Preferably, the method comprises electrostatically adhering at least one powder coating of the multiple powder coating compositions to a transporter surface, imaging member, and/or intermediate transfer member, before directing each of the multiple powder coating compositions to at least a portion of the metal substrate; wherein electrostatically adhering the at least one powder coating composition comprises electrically biasing the transporter surface, imaging member, and/or intermediate transfer member to a non-zero voltage before electrostatically adhering the at least one powder coating composition to the transporter surface, imaging member, and/or intermediate transfer member. In certain preferred methods, additionally, a first deposited powder coating composition is at a first polarity, and the method further includes changing the first polarity of the first deposited powder coating composition to a second polarity, and applying a second coating composition at a second polarity to the first deposited powder coating composition.

### Cartridge-Based Delivery Systems and Methods

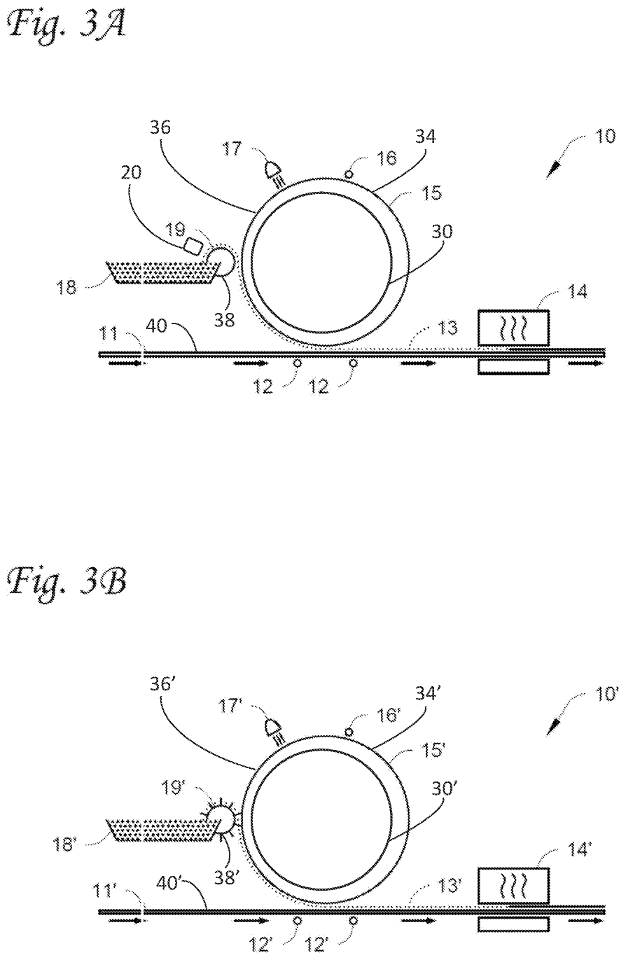

The cartridges are part of a system of transporting, storing, and dispensing the powder coating compositions described herein. The cartridges of the system are fully enclosed to limit and/or prevent the unwanted dispensing of the powder coating compositions described herein outside of when the powder coating compositions are needed to form a coating as described herein. The cartridges are preferably configured to be returned to the powder coating composition supplier for refilling when needed. That refilling process may, as described herein, include collapsing the cartridges to reduce their size for shipping when empty and cleaned as needed before refilling to make the delivery process cyclical-thereby reducing waste associated with the cartridges. That process is schematically depicted in FIG. 5 where use of each of the cartridges includes filling a cartridge with a powder coating composition at a filling location 1302, followed by delivery and/or storage 1304 of the filled cartridge from the filling location to a dispensing location 1306 where the powder coating composition in the cartridge is dispensed as needed to provide a coating as described herein.

After the powder coating composition in the cartridge is emptied (either completely or partially (e.g., by a majority of the powder coating composition in the cartridge at the time of delivery to a dispensing location), the process includes returning the “spent” cartridge 1308 to a filling location (either the same filling location at which the cartridge was previously filled or a different filling location) where the cartridge is received for refilling with the same powder coating composition or a different powder coating composition.

The depicted process includes an optional cleaning process 1310, in which the interior volumes of the cartridges received for refilling at the filling location 1302 may be cleaned before they are filled/refilled. Cleaning may be performed if the cartridges are to be filled with the same or a different powder coating composition from that previously contained in the cartridge.

Although not depicted in FIG. 5, the process may involve collapsing the cartridges after dispensing the powder coating composition so that the collapsed cartridges have a collapsed interior volume and occupy less overall volume during transport to the filling/refilling location. In those instances, the collapsed cartridges will typically be expanded from their collapsed interior volume to their filled interior volume before refilling with a powder coating composition. It may be preferred that any such expansion be performed before the interiors of the cartridges are cleaned to ensure proper cleaning of the cartridges. In some embodiments, however, the collapsed cartridges may expand during the filling/refilling process.

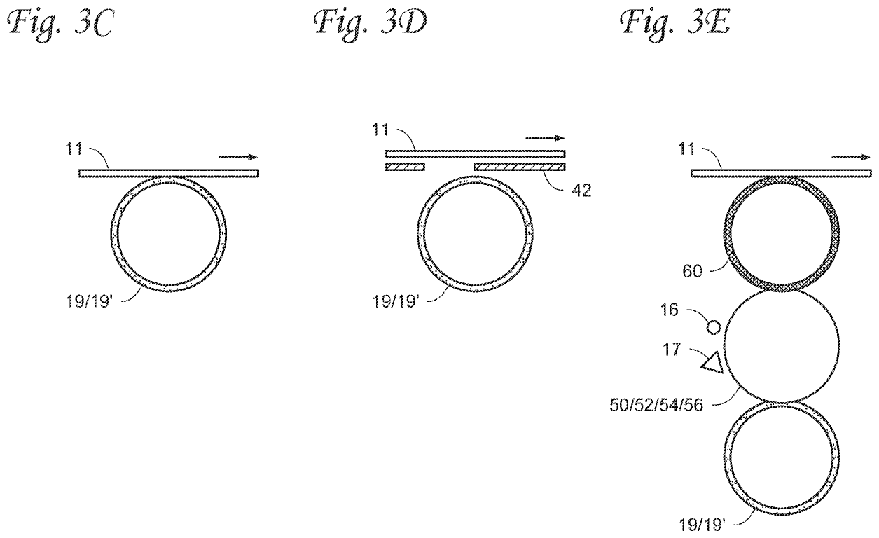

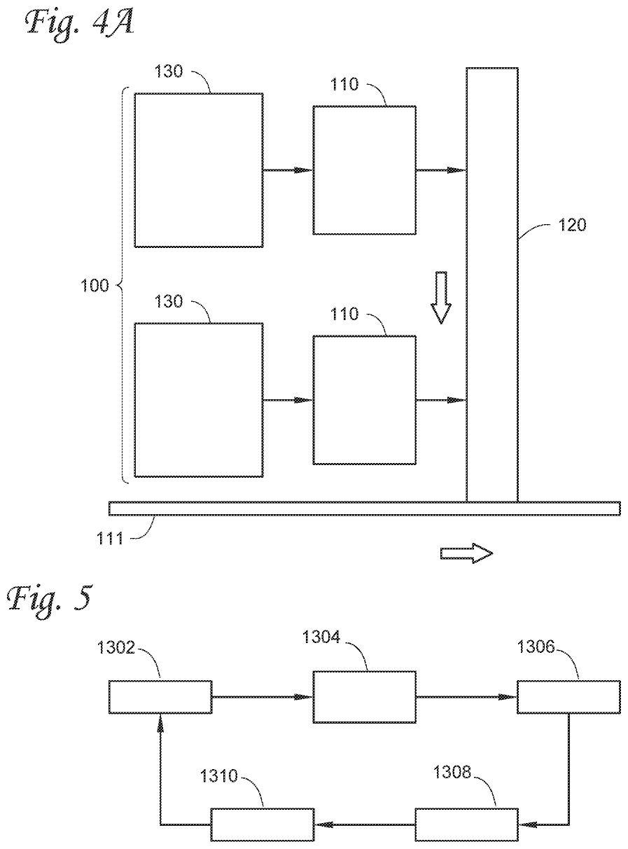

FIGS. 6-7 depict one illustrative embodiment of a cartridge that may be used in a cartridge-based delivery system as described herein. The depicted cartridge 230 includes a body 232 that defines an enclosed volume 234. The enclosed volume 234 is filled with a powder coating composition 235 as described herein. In one or more embodiments, the cartridge 230 may be sized such that the enclosed volume can hold any suitable volume of the powder coating compositions described herein.

The cartridge 230 also includes a dispensing port 236 that is configured to provide a path out of the enclosed volume 234 of the cartridge 230 during dispensing of the powder coating composition contained in the cartridge 230. The dispensing port 236 is preferably sealed, closed, etc. during transport and storage of the filled cartridge 230 to avoid unwanted dispensing of the powder coating composition. The cartridge 230 also includes an inlet port 238 configured to allow makeup air to enter the enclosed volume 234 of the cartridge 230 as the powder coating composition 235 is dispensed from the dispensing port 236. The cap 239 may be removed from the inlet port 238 when the cartridge 230 is being filled with a powder coating composition 235 as depicted in FIG. 7.

Although the depicted illustrative embodiment of cartridge 230 includes a separate inlet port 238 and dispensing port 236, alternative embodiments of cartridges could include a single port configured to perform the functions of both an inlet port and a dispensing port.

The cartridge 230 also includes desiccant material exposed within the interior volume of the cartridge 230 such that makeup air entering the enclosed volume 234 during dispensing of the powder coating composition passes through the desiccant material to control the amount of water vapor allowed into the enclosed volume 234 of the cartridge 230. In one or more embodiments, any headspace (i.e., a portion of the enclosed volume that is not occupied by the powder coating composition) may be filled with one or more of dry air, one or more inert gases (e.g., nitrogen, etc.). In the depicted embodiment, the desiccant material may be located in the cap 239 provided over the inlet port 238. Any suitable desiccant material may be used, e.g., silica gel (or silicon dioxide), indicating silica gel, bauxite, calcium oxide, calcium chloride, calcium sulfate, lithium chloride, lithium bromide, magnesium sulfate, montmorillonite clay, activated alumina (aluminum oxide), aluminosilicate molecular sieves, etc. It may be preferred that the desiccant material be capable of regeneration and reuse by, e.g., heating, etc. to limit the waste associated with the cartridge-based delivery systems and methods described herein.

Another feature of one or more embodiments of the cartridges described herein are stacking features 233 on the cartridges 230 that are configured to allow for stacking of the cartridges 230 on each other as depicted in, e.g., FIG. 6. The stacking features 233 may take a variety of different forms. Although the depicted stacking features 233 are located at the bottom of the cartridges 230, the stacking features may alternatively include complementary structures of the top of the cartridge to facilitate stacking of the cartridges 230. Regardless of their specific form, the stacking features may be configured to prevent lateral (i.e., horizontal) movement of the stacked cartridges 230 relative to each other where the stacked cartridges are stacked in the vertical direction.

In the depicted embodiment of cartridges 230, the inlet port 238 and cap 239 are offset in a lateral/horizontal direction from a center of the cartridge 230. That offset position, when coupled with corresponding clearance on the bottoms of the cartridges 230 can facilitate stacking of the cartridges 230 without interference from the inlet port 238 and cap 239. In the depicted embodiment, clearance between the stacked cartridges 230 may also be facilitated by shaping the bottom surfaces of the cartridges such that the bottom surfaces slope towards a dispensing port 236 to also facilitate dispensing of the powder coating composition 235 in the cartridges 230, with the dispensing port 236 being, in the depicted embodiment, located at the bottommost location on the sloped bottom floor 237 of the cartridge 230.

With reference to FIG. 7, one illustrative embodiment of an apparatus used to deliver powder coating composition 235 into the enclosed volume 234 of the cartridge 230 is depicted. In the depicted embodiment, the inlet port 238 is configured to receive the powder coating composition 235 during delivery of the powder coating composition 235 into the enclosed volume 234 of the cartridge 230.

The depicted apparatus used to deliver the powder coating composition 235 into the cartridge 230 is in the form of a delivery pipe 250 connected to the inlet port 238 (after removal of the cap 239). The delivery pipe 250 may optionally be configured to remove air from the enclosed volume 234 of the cartridge 230 as the powder coating composition 235 is delivered into the enclosed volume 234 of the cartridge 230.

The depicted delivery pipe 250 includes a delivery lumen 252 and a return lumen 254. The delivery lumen 252 is configured to deliver the powder coating composition 235 into the enclosed volume 234 and the return lumen 254 is configured to remove air from the enclosed volume 234. In the depicted embodiment, the delivery lumen 252 and the return lumen 254 are arranged coaxially along the delivery pipe 250. In particular, the delivery lumen 252 is located within or surrounded by the return lumen 254. The return lumen includes a vent 256 to remove the makeup air. Although not depicted, the vent 256 may be provided with a filter assembly or other structure/apparatus configured to capture any powder coating composition 235 removed from the interior volume 234 with the makeup air.

Additional optional features of the illustrative embodiment of the cartridge-based delivery system described herein that are depicted in FIG. 7 include a base 240 configured to support the cartridge 230 during the filling process and an oscillating mechanism 260 used to vibrate or oscillate portions or all of the body 232 of the cartridge in a settling mode during the filling process to promote proper filling of the enclosed volume 234 by the powder coating composition 235 (by, e.g., promoting settling of the powder coating composition 235) In the depicted embodiment, the oscillating mechanism 260 is attached to (e.g., located in) the base 240, but in alterative embodiments, one or more oscillating mechanisms may be provided on the cartridge 230 itself. Additionally, although the figure indicates a lateral oscillating movement, the preferred oscillating mechanism 260 may generate motion along any spatial axis or along more than one spatial axis, e.g., a vertical thumping or a circular motion. The preferred oscillating mechanism may also vary in its frequency and/or periodic nature. The base 240 of the depicted embodiment includes a seat 242 configured to retain the cartridge 230 in a selected position on the base 240 to, e.g., limit unwanted movement of the cartridge 230 on the base due to the vibrational energy delivered to the cartridge 230 by the oscillating mechanism 260.

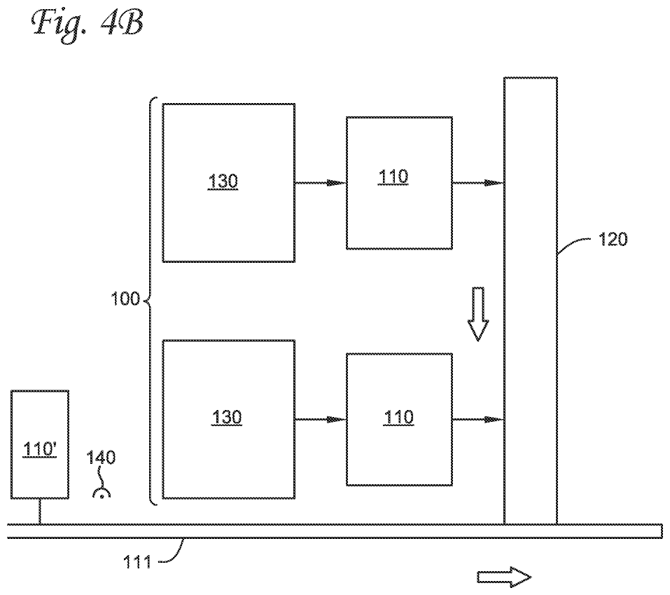

One alternative embodiment of a cartridge 330 that can be used in a cartridge-based delivery system as described herein is depicted in FIG. 8. The cartridge 330 includes a body 332 that defines an enclosed volume 334. Cartridge 330 also includes a dispensing port 336 and an inlet port 338, the inlet port 338 being closed in the depicted embodiment by a cap 339. Other features depicted in connection with cartridge 330 include a base 340 that includes a seat 342 configured to receive the bottom of the cartridge 330 (including the stacking features 333 on the cartridge 330). An oscillating mechanism 360 is also attached to the base 340. During the dispensing process, the oscillating mechanism 360 is run in an agitating mode to disrupt the settled powder coating composition to prevent bridges and rat holes from forming and interfering with dispensing of powder. In the depicted embodiment, the oscillating mechanism 360 is attached to (e.g., located in) the base 340, but in alterative embodiments, one or more oscillating mechanisms may be provided on the cartridge 330 itself, particularly to collapse, expand, or rock the cartridge body 332 to prevent bridging and ratholing. Again, although the figure indicates a lateral oscillating movement, the preferred oscillating mechanism 360 may generate motion along any spatial axis or along more than one spatial axis, e.g., a vertical thumping or a circular motion. The preferred oscillating mechanism may also vary in its frequency and/or periodic nature, and oscillating mechanism 360 may vary in movement, nature, and/or location from oscillating mechanism 260.

FIG. 8 also depicts a discharge tube 370 attached to the dispensing port 336 on the cartridge, the discharge tube 370 used to dispense powder coating composition from the interior volume 334 of the cartridge 330 to, e.g., an application device such as, e.g., application devices 10, 10′, 110 and 110′ described herein. The depicted embodiment also includes a valve 380 that can be used to control dispensing of the powder coating composition in the cartridge 330. The valve 380 may take any suitable form that is compatible with dispensing of the powder coating composition, e.g., a shutter valve, blade valve, ball valve, screw conveyor, etc. The valve 380 may preferably be controlled from a location that is available to a user such as the side of the cartridge 330 as seen in FIG. 8.

The sloped bottom floor 337 of the cartridge 330 may be shaped to promote the flow of the powder coating composition out of the cartridge 330 through the dispensing port 336. As depicted in FIG. 8, the dispensing port 336 is located at the bottommost location on the sloped bottom floor 337 to facilitate emptying of the powder coating composition in the cartridge 330.

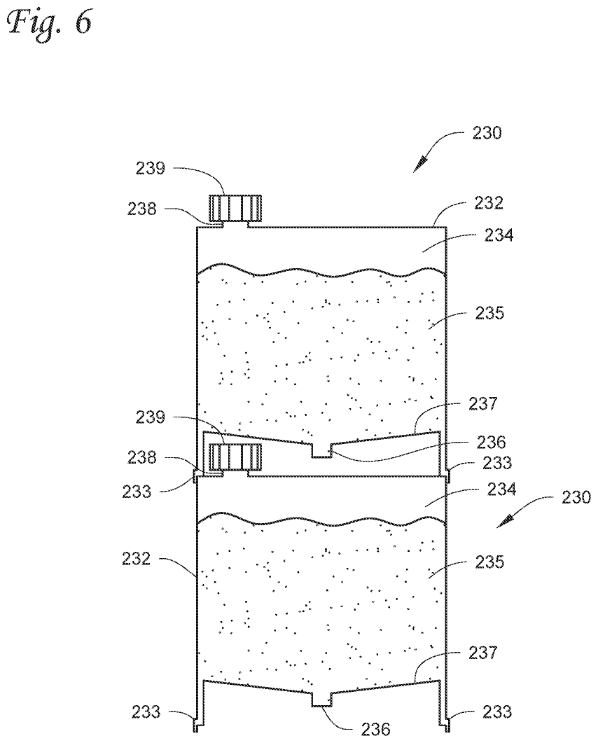

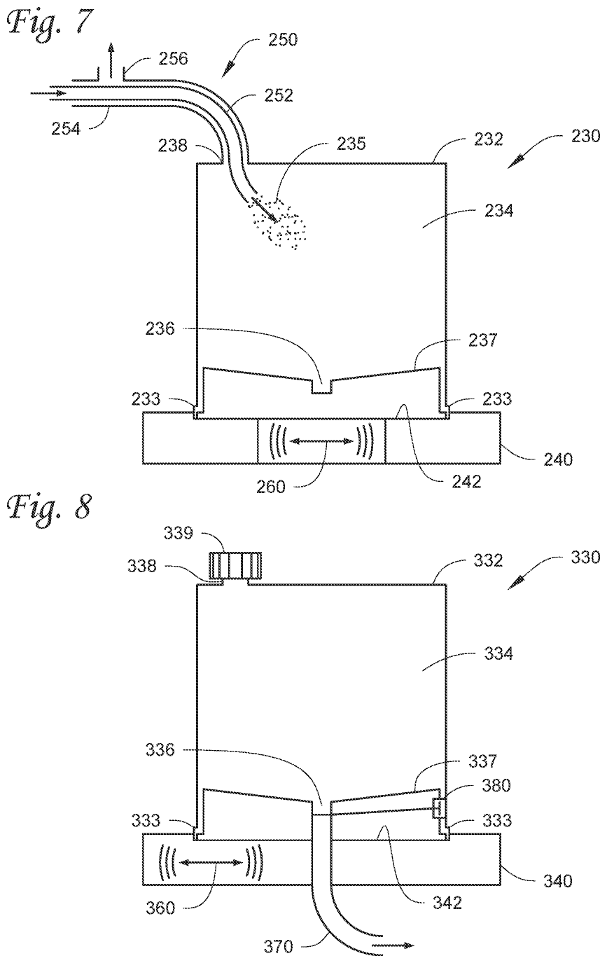

The cartridges 430 depicted in FIG. 9 include more optional features that may be provided in the cartridges used in one or more embodiments of the cartridge-based delivery systems and methods described herein. The optional feature depicted in the cartridges 430 of FIGS. 9-10 is that the cartridges 430 are convertible between a collapsed configuration (seen in FIG. 9) and an expanded configuration (seen in FIG. 10).

In the depicted embodiment of cartridge 430, an expansion joint 490 extends between a bottom panel 492 and a top panel 494 of the cartridge 430. The expansion joint 490 is configured to connect and seal the bottom panel 492 to the top panel 494 so that the bottom panel 492 and the top panel 494 can be moved relative to each other between an expanded distance (associated with the expanded configuration) and a collapsed distance (associated with the collapsed configuration). The bottom panel 492 and the top panel 494 may be constructed of relatively rigid materials capable of supporting the dispensing port 436 and inlet port 438 as needed. The inlet port 438 may be closed by a cap 439. When the bottom panel 492 and top panel 494 are separated from each other by the collapsed distance, the cartridge 430 is in the collapsed configuration and when the bottom panel 492 and top panel 494 are separated from each other by the expanded distance, the cartridge 430 is in the expanded configuration.

In one or more embodiments, the collapsed distance between the bottom panel 492 and top panel 494 is less than the expanded distance, such that the bottom panel 492 is located closer to the top panel 494 when the bottom panel 492 and the top panel 494 are separated from each other by the collapsed distance than when the bottom panel 492 and the top panel 494 are separated from each other by the expanded distance. In one or more embodiments, the ratio of the collapsed distance to the expanded distance is 0.5:1 or less, 0.4:1 or less, or 0.3:1 or less.

In terms of volume, the collapsible cartridges described herein may have, when in the collapsed configuration, a collapsed enclosed volume that is 60% or less, 50% or less, 40% or less, 30% or less, or 20% or less of the expanded enclosed volume. In terms of absolute volume, the collapsible cartridges described herein may have, when in the collapsed configuration, a collapsed enclosed volume (at an upper end) of 0.5 cubic meter or less, 0.4. cubic meter or less, or 0.3 cubic meter or less, 0.2 cubic meter or less, 0.1 cubic meter or less, 0.05 cubic meter or less, 0.01 cubic meter or less, 0.005 cubic meter or less, 0.001 or cubic meter or less. The collapsible cartridges may have, when in the expanded configuration, an expanded enclosed volume (at a lower end) of 0.001 cubic meter or more, 0.005 cubic meter or more, 0.01 cubic meter or more, 0.05 cubic meter or more, 0.1 cubic meter or more, 0.2 cubic meter or more, 0.3 cubic meter or more, 0.4 cubic meter or more, 0.5 cubic meter or more, 0.75 cubic meter or more or 1 cubic meter or more. Preferably, the cartridges described herein are not so large as to prevent a typical fork-lift truck from transporting the cartridge when filled. In one or more embodiments, the cartridges and/or the bases on which the cartridges may be located may be configured to receive the tines of a fork-lift truck to facilitate transport by a fork-lift truck.

These collapsed/expanded distances and collapsed/expanded enclosed volumes may, in one or more embodiments, provide advantages in both shipping/storage and dispensing because they may provide a beneficial combination of sufficient volume in the expanded configuration to be economically useful in the coating processes described herein balanced with a collapsed volume that facilitates shipping and storage of cartridges when in the collapsed configuration, and flexible side walls to aid with agitation of the powder during dispensing.

The stacked set of cartridges 430 depicted in FIG. 9 are all in the collapsed configuration in which the bottom panels 492 and top panels 494 of the cartridges 430 are separated from each other the collapsed distance. The cartridge 430 depicted in FIG. 10 is in the expanded configuration such that the bottom panel 492 and top panel 494 of the cartridge 430 are separated from each other by an expanded distance. Putting the cartridges 430 into the collapsed configuration is useful to reduce the size of the cartridges 430 when they are, for example, being returned for refilling or merely being stored between use.

The structure of the expansion joint 490 may take any suitable form. In one or more embodiments, the expansion joint 490 may include one or both of a flexible polymeric ring and a flexible accordion-shaped bellows. The expansion joint 490 may be constructed of one or more flexible materials such as rubber, LDPE, polyurethane, neoprene, etc. The expansion joint 490 and/or cartridge 430 may include struts or other structures that retain the cartridge 430 in the expanded configuration, with the unsupported state of the cartridge 430 being the collapsed configuration. In one or more embodiments, the cartridge may include a collapsible bag or bladder used to contain the powder coating composition within the cartridge.

With reference to FIG. 10 in which the cartridge 430 is in the expanded configuration and set up on a base 440, another feature of the cartridge-based delivery systems described herein may include a cleaning apparatus 482 that can be introduced into the enclosed volume of the cartridge 430 to clean the cartridge 430 before it is refilled. Although not required, cleaning may preferably be performed, in the case of collapsible cartridges, after the cartridges have been expanded to their expanded configuration. Cleaning apparatus may be in the form of a spray head configured to wash/rinse the interior surfaces of the cartridge 430 with one or more liquids during the cleaning process. Although the cleaning apparatus is, in the depicted embodiment, introduced through the inlet port 438, alternative embodiments of cartridges may allow for introduction of a cleaning apparatus through the dispensing port 436 or through any other suitable access point (e.g., a dedicated cleaning port, etc.). The cartridge 430 may include a discharge tube 370 attached to the dispensing port 336.

### Metal Packaging and General Methods of Making

The present disclosure also provides metal packaging (e.g., a metal packaging container such as a food, beverage, aerosol, or general packaging container (e.g., can), a portion thereof, or a metal closure) that includes a coated metal substrate as described herein. The coated surface of the metal substrate preferably forms an interior surface of the container (e.g., can or cup) or closure (although it can form an exterior surface). The coated surface of the metal substrate is preferably a surface of a riveted can end, a pull tab, and/or a can/cup body. The metal packaging container (e.g., food, beverage, or aerosol can) may be filled with a food, beverage, or aerosol product.

A general method of making metal packaging (e.g., a metal packaging container such as a food, beverage, aerosol, or general packaging container (e.g., can or cup), a portion thereof, or a metal closure for a container such as a metal can or glass jar or pull tab for an easy open end) is provided. The method includes: providing a metal substrate (e.g., coil or sheet) having a hardened, preferably continuous, adherent coating disposed on at least a portion of a surface thereof, wherein: the metal substrate has an average thickness of up to 635 microns; the hardened, preferably continuous, adherent coating is formed from a metal packaging powder coating composition; wherein the powder coating composition comprises powder polymer particles comprising a polymer having a number average molecular weight of at least 2000 Daltons, wherein the powder polymer particles have a particle size distribution having a D50 of less than 25 microns; and forming the substrate (e.g., by stamping) into at least a portion of a metal packaging container (e.g., food, beverage, aerosol, or general packaging can) or a portion thereof, or a metal closure for a container (e.g., metal can or glass jar).

For example, two-piece or three-piece cans or portions thereof such as stamped riveted beverage can ends (e.g., soda or beer cans) with a hardened coating formed from the powder coating composition described herein disposed thereon can be formed using such a method. Standard fabrication techniques, e.g., stamping, may be used.

The coated surface of the metal substrate preferably forms an interior surface of a can or cup. The coated surface of the metal substrate is preferably a surface of a riveted can end, a pull tab, and/or a can/cup body. The can may be filled with a food, beverage, or aerosol product.

In some embodiments, the application of the coating to metal can take place at various stages in the production of the final package. In the case of side-seam stripes, powder can be moved via auger or other mechanism, through a boom to the application mechanism. A side seam stripe is typically one that covers the weld on a three-piece can side wall, interior or exterior. Various forms of electrography (such as electrophotography, electrostatic master printing, electrostatic screen printing, electrostatic stencil printing, etc.) can be utilized to deposit a suitable coating to specific areas of a formed can. This approach would be advantageous over current powder stripes as it would allow a thinner film and reduction of overspray.

### Powder-on-Powder Coating Methods, Systems, and Resultant Products

The present disclosure also provides a method of coating a metal substrate suitable for use in forming metal packaging (e.g., a food, beverage, aerosol, or general packaging container (e.g., can or cup), portion thereof, metal closure, or pull tab for an easy open end) that involves powder-on-powder coating, generally forming layers of the powder coating compositions disclosed herein. In this context, a powder-on-powder coating involves applying a powder coating composition onto a powder coating composition as well as a powder coating composition onto a hardened powder coating. This method uses any of the variety of powder coating compositions, including polymer particles and additives, and any of the general and cartridge-based systems and methods described herein. The general descriptions of the coatings also apply to the coatings that result from this method.

Layers containing the disclosed powder coating compositions may be combined in a variety of ratios and in any desired order to form the resultant hardened, preferably continuous, adherent coating. For example, first and second dissimilar powder coating compositions may be used to form a hardened coating containing from 99 wt-% to 1 wt-% of a first powder coating composition and from 1 wt-% to 99 wt-% of a second powder coating composition, from 95 wt-% to 5 wt-% of a first powder coating composition and from 5 wt-% to 95 wt-% of a second powder coating composition, from 90 wt-% to 10 wt-% of a first powder coating composition and from 10 wt-% to 90 wt-% of a second powder coating composition, or from 80 wt-% to 20 wt-% of a first powder coating composition and from 20 wt-% to 80 wt-% of a second powder coating composition, etc.

More than two (for example, three or more, four or more, or five or more) dissimilar powder coating compositions may be applied to make a hardened multi-layer coating. The dissimilar powder coating compositions typically will differ with respect to at least one physical or chemical properties. Representative such properties may include polymer particle properties such as molecular weight, density, glass transition temperature (Tg), melting temperature (Tm), intrinsic viscosity (IV), melt viscosity (MV), melt index (MI), crystallinity, arrangement of blocks or segments, availability of reactive sites, reactivity, acid number, as well as coating composition properties such as surface energy, hydrophobicity, oleophobicity, moisture or oxygen permeability, transparency, heat resistance, resistance to sunlight or ultraviolet energy, adhesion to metals, color or other visual effects, and recyclability. For properties measured on an absolute scale, the dissimilar properties (i.e., a particular property of at least two different powder coating compositions) may, for example, differ by at least ±5%, at least ±10%, at least ±15%, at least ±25%, at least ±50%, at least +100%, or more.

Thus, in one embodiment, the present disclosure provides a method of coating a metal substrate suitable for use in forming metal packaging that includes: providing a metal substrate; providing multiple metal packaging powder coating compositions, wherein each powder coating composition comprises powder polymer particles (preferably, chemically produced powder polymer particles, such as those produced by spray drying or limited coalescence), and at least two of the multiple metal packaging powder coating compositions are different; directing each of the multiple powder coating compositions (e.g., using a conductive or semiconductive transporter) to at least a portion of the metal substrate such that at least one powder coating composition is deposited on another different powder coating composition (either prior to or after hardening of the underlying powder coating composition to form a coating); and providing conditions effective for the multiple powder coating compositions to form a hardened, preferably continuous, adherent coating on at least a portion of the metal substrate.

Although the method can involve providing conditions effective for each of the powder coating compositions to form a hardened, preferably continuous, adherent coating between depositing layers of different powder coating compositions, preferably the method involves providing conditions effective for each of the powder coating compositions to form a hardened, preferably continuous, adherent coating after depositing all the layers of different powder coating compositions. Significant advantage of this electrographic powder coating process in the rigid metal packaging industry is that multiple layers can be applied in a powder-on-powder format, all before the coating undergoes a curative or fusing step. In a liquid coating process currently used in the industry, a subsequent coating layer can typically only be applied once the first layer has received at least a partial curing bake. This intermediate curing step is required to remove the solvent (organic or aqueous) still present in the first applied coating and form a hardened film that will be resistant to any impact of the solvent present in the subsequently applied layer. This additional, intermediate curing step adds time to the coating process and requires a significant increase in the footprint of the coating/curing equipment.

Similar to the operation of a laser printer that applies successive layers of colored toner powders (followed by a single thermal fusing step), EPC can be used to apply multiple layers of powder coatings while avoiding any deleterious effects caused by the intimate contact between successive layers prior to any cure. Although each individual coating layer can be cured/fused if desired, preferably, once all coating layers are applied, a single curative/fusing step can be used to form a hardened, preferably continuous, adherent coating.

A particular advantage of applying multiple different metal packaging powder coating compositions is that each composition can be chemically different and/or physically different, and provide a specific function that would otherwise be difficult to achieve with a single material. For example, hardness and flexibility can be quite difficult to achieve in a single coating composition, because they are achieved by incorporating dissimilar functionalities and architectures into the polymer backbone of the coating. Moreover, relative to conventional multi-layer packaging coating approaches (e.g., using conventional liquid applied coating approaches for each layer such as roll coating, spray coating, and the like), performance enhancements and/or cost savings can be realized by selectively applying one or more powder layers in a multi-layer powder coating system only where that particular layer is desired (e.g., as opposed to “all-over coating” for the given layer).

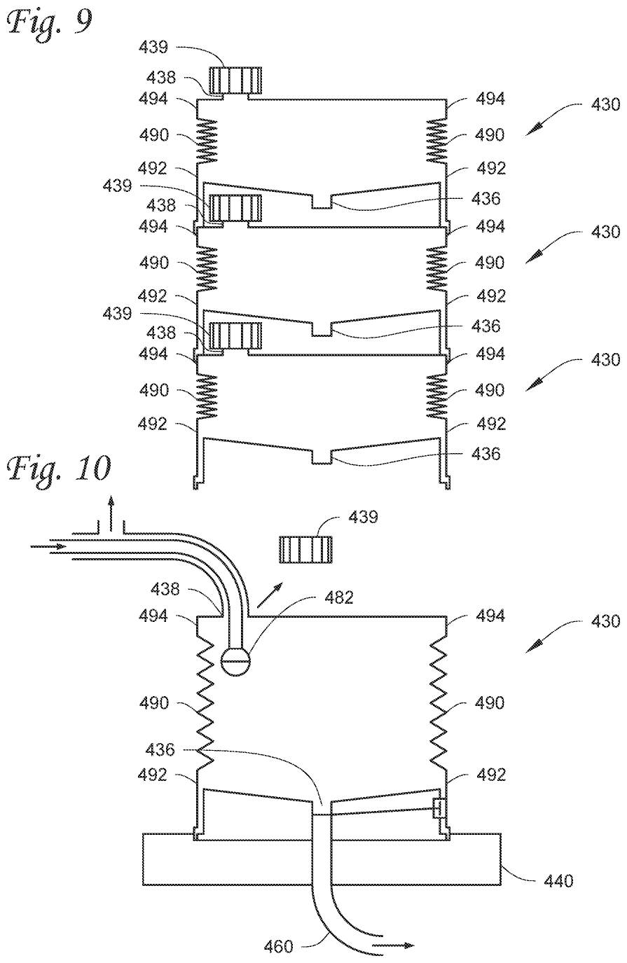

FIG. 11 provides schematics of representative examples of assemblies that include multilayer coatings in the rigid metal packaging industry. As shown on the left side of the substrate 511 in FIG. 11, using this method, a lubricant 513 may be applied in a second powder coating composition on a base powder layer 512 on substrate 511, prior to cure of the base powder layer, only where needed, thereby eliminating the need for applying lubricant globally across the coating surface or as an additive component of the 512 powder coating composition. In most cases, this lubricant layer will be selectively applied in a patterned format such that it only covers 50% or less of the base powder layer and/or is typically not thicker than the particle size of the lubricant applied.

In certain embodiments that include multiple powder coating compositions, each of the compositions do not include lubricant.

As shown in the middle portion of the substrate 511 in FIG. 11, two chemically different powder coating compositions may be applied—a first powder coating composition 514 may be applied to form a color coating, and then a second (different) powder coating composition 515 may be applied to form an outermost (i.e., top) clear coating over the colored coating 514. This can eliminate tool wear issues with pigmented end/tab coatings.

As shown on the right side of the substrate 511 in FIG. 11, a first powder coating composition 516 can be applied to provide a relatively soft coating layer, and a second powder coating composition 517 can be applied (i.e., deposited) to provide a relatively hard top (i.e., outermost) coating layer. In this context, soft and hard are used as terms to describe the relative hardness or softness (Tg) of the resultant first and second coatings (as opposed to a “hardened” coating). The softer coating 516 provides flexibility and a primer layer which enhances adhesion of the hard top coating layer 517, whereas the harder coating 517 provides an abrasion-resistant top coating.

Another example of powder-on-powder architectures includes the use of multiple differently colored powder coating compositions that can be used in color-on-color printing to generate a new color. Thus, the multiple powder coating compositions can include a base set of colors that can be mixed to form other colors. Similar to the way a desktop printer works, a multi-color-plus-black scheme (preferably a three-color-plus-black scheme) could be used to print an infinite array of colors from only four powder (or toner) sources, typically magenta, cyan, yellow, and black. For color development layers where a preceding or subsequent layer is providing a continuous protective layer over the metal substrate and/or over the color development layers, a pixel approach to achieve an infinite array of colors may be used. In this way, individual pixels or points (sufficiently small so as not to be detected by the human eye), can be printed onto the substrate such that the array of pixels or points on the substrate appear to the human eye to be a result of blending of those colors. For example, a 1:1 blend of cyan and yellow pixels would appear green to the unaided eye.

Mechanically, this array of colors could be achieved by arranging a bank of 4 transporters, laser assemblies, and toner cartridges (one for each color) in a row, so that each one deposits a proscribed amount of powder onto the substrate, with each one depositing powder on top of the previous layer.

Additionally, a transfer belt could be used to collect the powder from each of the four application units, and then the belt could transfer that collection of colors all onto the substrate at one time.

Yet another example of powder-on-powder architectures that could be of utility in the rigid metal packaging industry includes the use of a pretreatment base layer. Traditional non-chrome aluminum pretreatments consist of molybdenum and/or zirconium compounds (often in a polyacrylic acid matrix) that are coated in a very thin (sub-micron) layer prior to the protective coating. In some applications, the polyacrylic acid sealer layer provides a significant percentage of the pretreatment performance advantage. This pretreatment process is often complicated and messy. It would be beneficial to use a powder coating composition in a very thin layer of a pretreatment metal compound sealer, or potentially just sealer by itself.

A powder-on-powder architecture may include multiple powder coating compositions deposited in a manner to form a textured surface (e.g., detectible by unaided human senses visually and/or by touch). The texture results from the coating being applied to a smooth/flat metal substrate. Alternatively, a powder-on-powder architecture may include multiple powder coating compositions deposited in a manner to form a smooth/flat surface. The smooth/flat surface results from the coating being applied to a smooth/flat metal substrate or a textured substrate. The textured or smooth surface may be detectable to human eye and/or human touch, or alternatively, the texture can be measured and reported as an Arithmetical Mean Roughness (Ra). Arithmetical mean roughness indicates the average of the absolute value along the sampling length and can be measured with, for example, a 3D surface profiler such as the Keyence VK-X3000.

A powder-on-powder architecture may result in a hardened, preferably continuous, adherent coating that forms markings, as described for the patterned coating method.

A powder-on-powder architecture may result in a hardened, preferably continuous, adherent coating having different thicknesses across a coated surface as a result of the powder coating composition being deposited in different amounts. For example, the hardened adherent coating may have an average total thickness of up to 100 microns, or a maximum total thickness up to 100 microns. Typically, however, one or both of the maximum and average total thickness will be appreciably thinner than 100 microns. The coating may have multiple layers of powder coating compositions, thereby providing different thicknesses throughout the coating. The highest peak of a cross-section of a coating may be measured using microscopy (e.g., optical microscopy).

In methods of the present disclosure wherein multiple powder coating compositions are used, directing each of the multiple powder coating compositions comprises directing each of the multiple powder coating compositions (preferably, triboelectrically charged powder coating composition) to at least a portion of the metal substrate by means of an electric or electromagnetic field, or any other suitable type of applied field. As described with the general methods, this can involve feeding each of the multiple powder coating compositions to one or more transporters (e.g., one or more developer rollers); and directing each of the multiple powder coating compositions from the one or more transporters to at least a portion of the metal substrate by means of an electric or electromagnetic field between the one or more transporters and the metal substrate. In such methods, the transporter can be the same or different for each of the powder coating compositions. In such methods, two or more transporters may be employed in series to apply one or more powder coating compositions to at least a portion of the metal substrate.

In certain methods that involve the use of a transporter, directing each of the multiple powder coating compositions from the one or more transporters comprises: directing each of the multiple powder coating compositions from the one or more transporters to one or more transfer members by means of an electric field between the one or more transporters and the one or more transfer members; and transferring each of the multiple powder coating compositions from the one or more transfer members to at least a portion of the metal substrate. In such methods, the transfer member can be the same or different for each of the powder coating compositions. For example, a drum transporter can apply powder by means of an electric field to a transfer member (e.g., a belt), which in turn applies the powder coating composition to at least a portion the metal substrate.

The present disclosure also provides coated metal substrates, and metal packaging that includes such coated metal substrates, having a surface at least partially coated with a coating prepared by methods of the present disclosure wherein multiple powder coating compositions are used. Such metal packaging is analogous to that described herein made by the general methods that are described above. Such packaging may be filled with a food, beverage, or aerosol product.

The present disclosure also provides a packaging coating system, comprising: multiple metal packaging powder coating compositions, wherein at least two of the multiple metal packaging powder coating compositions are different; wherein each powder coating composition comprises powder polymer particles comprising a polymer having a number average molecular weight of at least 2000 Daltons, wherein the powder polymer particles have a particle size distribution having a D50 of less than 25 microns, and wherein the powder polymer particles are preferably formed, e.g., via spray drying or limited coalescence, to have a suitable regular particle shape and morphology—unlike ground particles. Such systems preferably further include instructions comprising: directing each of the multiple powder coating compositions to at least a portion of a metal substrate such that at least one powder coating composition is deposited on another different powder coating composition (prior to or after hardening of the prior applied powder coating composition); and providing conditions effective for the multiple powder coating compositions to form a hardened, preferably continuous, adherent coating on at least a portion of the metal substrate.

Preferably, in such systems, at least two of the metal packaging powder coating compositions differ in one or more chemical or physical properties. Such properties include polymer particle properties (such as molecular weight, density, glass transition temperature (Tg), melting temperature (Tm), intrinsic viscosity (IV), melt viscosity (MV), melt index (MI), crystallinity, arrangement of blocks or segments, monomer composition, availability of reactive sites, reactivity, and acid number), and coating composition properties (such as surface energy, hydrophobicity, oleophobicity, moisture or oxygen permeability, transparency, heat resistance, resistance to sunlight or ultraviolet energy, adhesion to metals, color or other visual effects, and recyclability). Preferably, a particular property of at least two different powder coating compositions differ by at least ±5%, at least ±10%, at least ±15%, at least ±25%, at least ±50%, at least #100%, or more.

In such systems, the multiple powder coating compositions are typically contained in a plurality of cartridges, wherein each cartridge of the plurality of cartridges contains a powder coating composition, and wherein at least two cartridges of the plurality of cartridges contain different powder coating compositions (e.g., a differently colored powder coating composition). Preferably, such cartridges are refillable and reusable.

### Patterned Coating Methods, Systems, and Resultant Products

The present disclosure also provides a method of coating a metal substrate suitable for use in forming metal packaging (e.g., a food, beverage, aerosol, or general packaging container (e.g., can or cup), portion thereof, metal closure, or pull tab for an easy open end), that involves forming a patterned coating. This method uses any of the variety of powder coating compositions, including polymer particles and additives, and any of the general and cartridge-based systems and methods described herein. The general descriptions of the coatings also apply to the coatings that result from this method.

In particular, this method includes: providing a metal substrate; providing a metal packaging powder coating composition, wherein the powder coating composition comprises powder polymer particles (preferably, chemically produced powder polymer particles, such as those produced by spray drying or limited coalescence); selectively applying the powder coating composition on at least a portion of the metal substrate (e.g., with the assistance of a conductive or semiconductive transporter) to form a patterned coating; and providing conditions effective for the powder coating composition to form a hardened adherent patterned coating on at least a portion of the metal substrate. This is a method of selectively applying or printing the powder coating composition.

A “patterned” coating (i.e., a multi-portion coating) refers to a hardened coating printed in two or more regions on a substrate surface, which may or may not have blank regions between and/or surrounding the printed regions having no coating thereon.

Felectromagnetic druA patterned coating may include a regular or irregular pattern of coated regions, which may be in a variety of shapes (e.g., stripes, diamonds, squares, circles, ovals, rings). Such coated regions could be very discrete with clearly delineated transitions. Alternatively, such coated regions could provide gradient effects (e.g., in terms of color or matte/gloss) without clearly delineated transitions.

The terms “pattern” and “patterned” do not require any repetition in design elements, although such repetition may be present. The hardened coated regions of the patterned coating are preferably continuous in that they are free of pinholes and other coating defects that result in exposed substrate if an underlying coating is not present.

A patterned coating may be applied on another powder coating, whether it is an all-over coating or another patterned coating. A patterned coating may be applied to a conventional liquid-applied base coat.

Using a patterned coating method as described herein has a number of advantages. It provides the ability to do things in a selective and/or differential manner in a given coating, which is different from conventional methods. For example, the patterned coating could provide information in the form of markings. In this context, “markings” includes graphics, text, indicia, numbers, letters, code, communication means (e.g., as to when and where coated), and other visual images (e.g., faces such as those of celebrities, animals, characters, objects, artistic representations, and the like) including high resolution images. The markings could be present as portions within an overall layer, or could be applied as a second layer (i.e., with the edge boundaries of the layer substantially defined by the markings or each individual marking). The markings could be applied, e.g., by a customer, to a conventional continuous liquid-applied base coat already present.

Using a patterned coating method as described herein could result in a potential savings in the amount of powder coating composition consumed. There may also be a reduction in the amount of metal substrate scrapped. For example, savings can occur using a patterned coating architecture in the fabrication of paint cans. A ring-shaped coating can be applied to a metal substrate (e.g., steel) only in the area where the ring is to be formed, leaving the remaining metal substrate free of any coating material (i.e., referred to as “bare tinplate”). Once the coated ring is formed the remaining bare tinplate can then be used to create gallon lids. This operation saves on the consumption of the metal substrate by allowing what would have been scrapped to be usable material.

Using a patterned coating method as described herein could result in a potential reduction in down time due to the need to clean fabrication machinery. For example, applying a powder coating composition as a patterned (e.g., spot) coating to a product contact area for a food or beverage can end, or similar packaging parts, could prevent the downstream effect of developing coating hairs in the fabrication machinery. In a conventional method, shearing an organic coating on tinplated steel generates a thin hair of coating which is pulled from the cut edge. This coating hair builds up in the machinery, creating a cleanliness issue and down time. Applying a spot coating in the food-contact area only allows for the cut edge to remain free of coating material. This prevents formation of coating hairs and eliminates the down time needed for cleaning and translates into a significant cost savings.

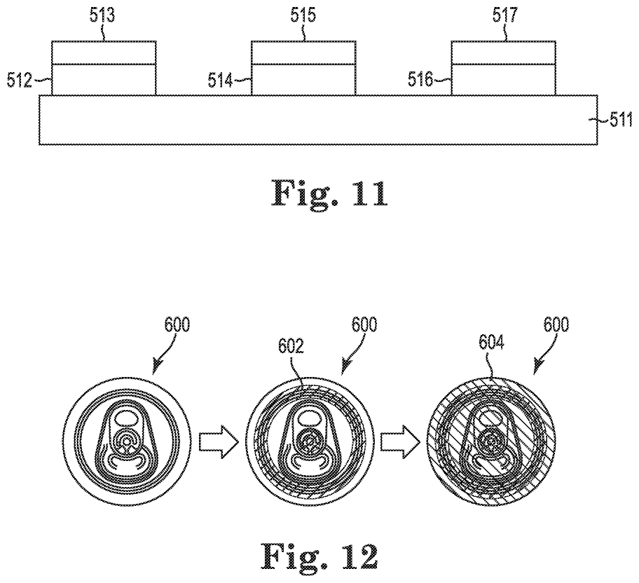

The fabrication of food and beverage can ends is one of the most demanding areas of rigid metal packaging fabrication, due largely to the significant number of fabrication steps that occur after a coating is applied to a metal substrate in a coil format (and sometimes to metal sheets). This is especially true for so called “easy open” food and beverage can ends, which include a “rivet” having extreme contours for purposes of attaching a pull-tab to the can end. With a conventional liquid-based roll coat application, the coating composition needs to be highly engineered to pass the post-coating fabrications steps. Because a significant amount of the can end is subjected to few, if any, of these post-coating fabrication steps, the coating composition is actually over-engineered for these areas. As shown in FIG. 12, an electrographic patterned coating can be provided on only selected regions 602 of the can end 600 as described herein, however, allows these regions 602 of the metal substrate that are subject to the significant number of fabrication steps to be coated with a highly engineered powder coating composition with superior flexibility and adhesion, such as one that includes polyester or epoxy polymer particles. Then, a more general-performance powder coating composition 604 that includes acrylic polymer particles, for example, can be applied over the entire surface of the can end 600.

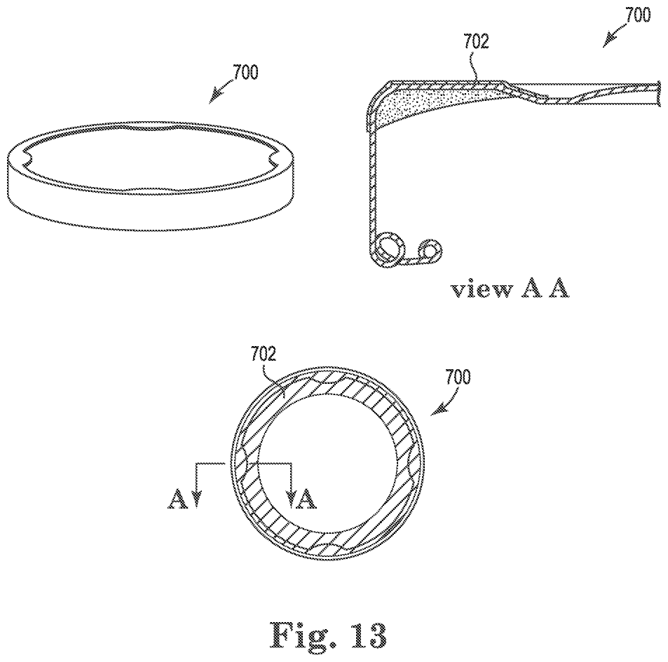

The fabrication of metal closures for glass jars (e.g., lugged or threaded caps) will also benefit from an electrographic patterned coating method as described herein. Such metal closures 700 are typically double coated, with the top coat being formulated to have good adhesion to a polyvinyl chloride (PVC) gasket that aids in sealing the lid (i.e., metal closure such as lug cap) to the glass jar. The top coat must also prevent leaching of the PVC plasticizer (found in the gasket) into the base coat and encourage corrosion. Using the electrographic patterned coating method as described herein, a high-performance, gasket-compatible, powder coating composition for the top coat could be localized to a ring shape 702 in the area directly under the gasket, versus being coated over the entire closure 700. FIG. 13 is a schematic of an electrographic patterned coating on one example of a lug cap 700 seen in a perspective view on the left side of FIG. 13, with the upper right cross-sectional view A-A of FIG. 13 being taken along line A-A in the lowermost view of FIG. 13.

Multiple powder coating compositions, where at least two of the multiple metal packaging powder coating compositions are different, may be used in the patterned coating method, as described for the powder-on-powder coating method. For example, a method could involve directing a powder coating composition to at least a portion of a metal substrate to form a continuous coating, which may be a patterned coating or an all-over coating, before or after forming a patterned coating with a different powder coating composition. For exterior images/printing, currently a patterned coating layer (i.e., a pattern layer) is used that is separate from a protective layer. The patterned coating method would allow for the pattern layer and performance layer to be accomplished in a single pass through the coating apparatus followed by a single hardening step.

In another example that involves a patterned coating method that uses multiple powder coating compositions, each of the multiple powder coating compositions may be directed to at least a portion of the metal substrate such that at least one powder coating composition is optionally deposited on another different powder coating composition to form a coating. This could include powder-on-powder coating. Alternatively, the multiple coating compositions could be directed to different, non-overlying areas (e.g., abutting areas that such a continuous coating is preferably formed), which is distinct from the powder-on-powder method.

As with the powder-on-powder method, providing conditions effective for each of the multiple powder coating compositions to form a hardened coating involves providing conditions effective for each of the powder coating compositions to form a hardened coating between depositing layers of different powder coating compositions. Preferably, however, the method involves providing conditions effective for each of the powder coating compositions to form a hardened coating after depositing all the layers of different powder coating compositions, whether powder-on-powder or not.

A patterned coating may have different thicknesses across a coated surface as a result of the powder coating composition being deposited in different amounts, as described for the powder-on-powder coating method. This is advantageous in the rigid metal packaging industry when there is a need for a varied coating thickness across a substrate surface (i.e., an indexed variable thickness coating) for example, for coating performance and/or aesthetic purposes. Preferably, such coating thickness can be selectively varied on demand during application. Such selectivity cannot be achieved using a conventional roll-applied liquid coating process. To achieve selective variable thicknesses using such conventional process, expensive and permanent milling/etching of the application roll would be required. Furthermore, such conventional process could not provide the high degree of resolution that can be accomplished using a method of the present disclosure.

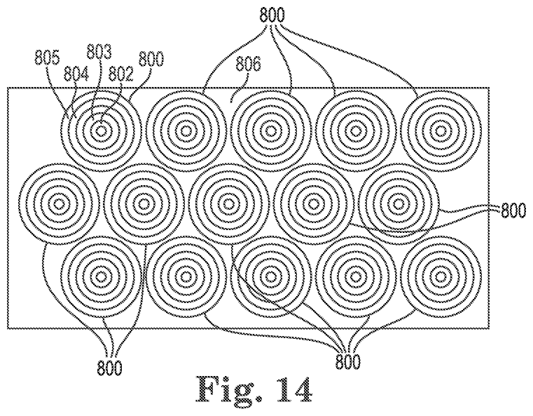

FIG. 14 demonstrates an example of the utility of an indexed variable thickness (IVT) coating. This illustrates an IVT coating as it could be used in the rigid metal packaging industry to produce a coated metal sheet. From this sheet, can/cup blanks could be punched and subsequently formed through a traditional drawing and ironing process. In the margins 806 between the blanks, which are typically collected and recycled, no coating is applied. In the circular areas 800 separated by the margin 806 that will eventually be punched out for can/cup blanks, more coating can be applied in a radial pattern to the areas 800 that will eventually become the upper sidewall of the can/cup. The depicted circular areas 800 may include indexed coating weights forming concentric circles 802, 803, 804, and 805, with the coating weights increasing when moving from the central portion 802 outward. The thickest coating weights may be found in one or more of the outermost rings (e.g., rings 804 and/or 805) where needed at, e.g., upper sidewalls of a can or cup. This is useful because the upper sidewall of the can/cup is typically more susceptible to corrosion than other areas such as the dome or bottom area.

A patterned coating may also have different finishes. For example, at least a portion of the patterned coating may have a glossy finish. Alternatively, at least a portion of the patterned coating may have a matte finish. The patterned coating may have one or more gradient (e.g., gradual) transitions from a glossy finish area (i.e., region) to a matte finish area and/or one or more immediate transitions from a glossy finish area to a matte finish area. Such matte/glossy finishes can be determined using a gloss meter, such as a BYK-Gardner AG-4440 digital gloss meter.

The present disclosure also provides pattern-coated metal substrates, and metal packaging that includes such pattern-coated metal substrates. More specifically, a pattern-coated metal substrate is provided that is suitable for use in forming metal packaging (e.g., a food, beverage, aerosol, or general packaging container (e.g., can or cup), portion thereof, metal closure, or pull tab for an easy open end), wherein at least a portion of the metal substrate has a surface coated with a hardened adherent patterned coating comprising fused powder polymer particles (preferably, chemically produced, e.g., spray dried, powder polymer particles). Such metal packaging is analogous to that described herein made by the general methods that describe the use of a single powder coating composition. Such packaging may be filled with a food, beverage, or aerosol product.

The present disclosure also provides a packaging coating system for patterned coating, comprising: one or more metal packaging powder coating compositions; wherein each powder coating composition comprises powder polymer particles comprising a polymer having a number average molecular weight of at least 2000 Daltons, wherein the powder polymer particles have a particle size distribution having a D50 of less than 25 microns (wherein the powder polymer particles are preferably formed, e.g., via spray drying or limited coalescence, to have a suitable regular particle shape and morphology—unlike ground particles); and instructions comprising: selectively applying the one or more powder coating compositions on at least a portion of the metal substrate to form a patterned coating; and providing conditions effective for the one or more powder coating compositions to form a hardened adherent patterned coating (which may or may not be continuous) on at least a portion of the metal substrate.

Preferably, in such systems that include at least two different metal packaging powder coating compositions, such compositions differ in one or more chemical or physical properties. Such properties include polymer particle properties (such as molecular weight, density, glass transition temperature (Tg), melting temperature (Tm), intrinsic viscosity (IV), melt viscosity (MV), melt index (MI), crystallinity, arrangement of blocks or segments, monomer composition, availability of reactive sites, reactivity, and acid number), and coating composition properties (such as surface energy, hydrophobicity, oleophobicity, moisture or oxygen permeability, transparency, heat resistance, resistance to sunlight or ultraviolet energy, adhesion to metals, color or other visual effects, and recyclability). Preferably, a particular property of at least two different powder coating compositions differ by at least +5%, at least ±10%, at least #15%, at least ±25%, at least ±50%, at least ±100%, or more.

In such systems, the multiple powder coating compositions are typically contained in a plurality of cartridges, wherein each cartridge of the plurality of cartridges contains a powder coating composition, and wherein at least two cartridges of the plurality of cartridges contain different powder coating compositions (e.g., a differently colored powder coating composition). Preferably, such cartridges are refillable and reusable.

### Methods of Making Metal Packaging—All-In-One Location

The present disclosure also includes a method that involves placement of an electrographic powder coating (EPC) unit in-line with a fabrication press used to produce rigid metal packaging components for food and beverage containers. In such a method, uncoated metal is supplied to the fabricator, typically in the form of a coil or spool, and after unspooling, the metal would then pass through an EPC unit, followed by a fusing until to create a continuous film. This coated metal could then be fed immediately into a fabrication press (e.g., for fabricating an easy open end, pull-tab, can body, etc.) to create the finished part. A similar process could also be utilized for metal sheets that is not part of a continuous coil.

In the current method of making food and beverage container components, the starting metal (e.g., aluminum or steel in the form of large coils or individual sheets) is often pre-coated by the metal producer or a toll coater and then supplied to, e.g., a can maker or other container fabricator, for fabrication. This means that the coating must be predetermined and applied to the entire coil, and then inventoried by the fabricator once supplied. Different types of container parts require different coatings so that inventory can be quite complex. The coating lines, or finishing lines, are typically large, stand-alone facilities, and the time spent coating the metal delays the time it takes to get it from the rolling mills to the fabrication presses. This has driven the finishing lines to accelerate to significant line speeds (above 1,000 feet, or 300 meters, per minute). Such high speeds limit the types of coating chemistries, and application methods that can be used to coat the metal.

More specifically, the present disclosure provides a method of making metal packaging (e.g., a metal packaging container such as a food, beverage, aerosol, or general packaging container (e.g., can or cup), a portion thereof, or a metal closure such as for a metal packaging container or a glass jar) in one location and/or in one continuous manufacturing line or process, the method comprising: providing a metal substrate; providing a metal packaging powder coating composition, wherein the powder coating composition comprises powder polymer particles (preferably, chemically produced, e.g., spray dried, powder polymer particles); directing the powder coating composition (preferably using an application process including a conductive or semiconductive transporter) to at least a portion of the metal substrate; providing conditions effective for the powder coating composition to form a hardened, preferably continuous, adherent coating on at least a portion of the metal substrate; and forming the at least partially coated metal substrate into at least a portion of a metal packaging container (e.g., a food, beverage, aerosol, or general packaging container (e.g., can or cup)), a portion thereof, or a metal closure (e.g., for a metal packaging container or a glass jar).

This method is referred to herein as the “all in one location method.” In this context, “all-in-one location” as well as “in one location and/or in one continuous manufacturing line or process” means that the method is carried out in one building or on one property with a conveyor system (optionally involving multiple adjacent buildings on adjacent properties with a conveyor system between).

This all-in-one location method uses any of the variety of powder coating compositions, including polymer particles and additives, and any of the general and cartridge-based systems and methods described herein. The general descriptions of the coatings also apply to the coatings that result from this method.

For example, the all-in-one location method can involve forming a patterned coating as described herein. Also, the all-in-one location method can involve the use of multiple coating compositions in a powder-on-powder coating method as described herein. Alternatively, the all-in-one location method can involve the use of multiple coating compositions in a coating method that does not require powder-on-powder application.

This method has several advantages. Due to the simplicity of the coating apparatus and the significant reduction in heat input required to cure the coating, EPC should require a small enough footprint that it could be completed in-line with the fabrication press. In this arrangement, the fabricator could significantly reduce their inventory of coated base metal, requiring them only to stock uncoated metal. This in-line set up allows the fabricator to move to a just-in-time manufacturing scenario. In addition, the metal is typically only fed into the press at 50-100 feet, or 15-30 meters, per minute. As such, the coating process can be slowed down significantly while effectively adding zero time to the production of rigid metal packaging components. Thus, for example, providing a metal substrate comprises feeding the metal substrate (e.g., into a coating apparatus wherein the powder coating composition is directed to at least a portion of the metal substrate) at a rate of 50-100 feet, or 15-30 meters, per minute.

The in-line process could also include a quality control step. For example, this could include (before or after forming the at least partially coated metal substrate into at least a portion of a metal packaging container, a portion thereof (e.g., an easy open end), or a metal closure) a quality inspection step (e.g., visual inspection) to ensure proper formation of the hardened, preferably continuous, adherent coating.

In addition, the method allows the can-maker much greater flexibility in making changes for the applied powder coating compositions between runs without having to change substrate, or inventory different pre-coated substrates, which may assist, for example, with differential marketing campaigns (e.g., by changing the external appearance of a tab, easy open end, or can body via a patterned coating).

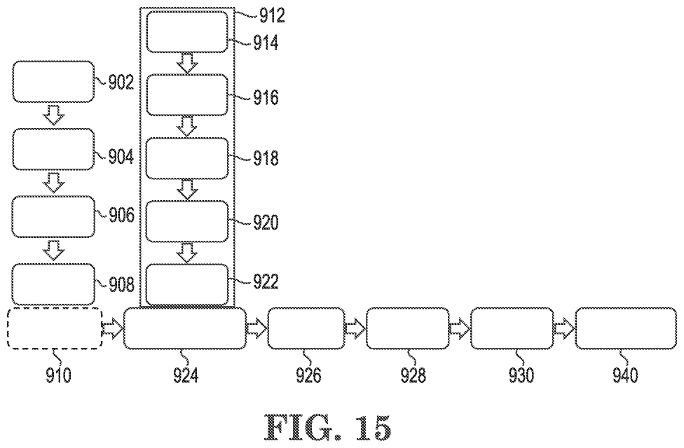

A representation of this method is shown in FIG. 15. In order to prepare for in-line coating and fabrication of a metal substrate at a can-maker's facility, uncoated metal coil or sheets would need to be formed by a metal producer and delivered to the can-maker's site. This process would typically involve metal ingot formation 902, hot rolling 904, and cold rolling 906, prior to delivery 908 of the uncoated metal substrate. In order to prepare for in-line coating and fabrication of a metal substrate at a can-maker's facility, the powder coating would also need to be produced and delivered by the coating manufacturer 912. This process would involve the steps described in this disclosure to be completed by the coating manufacturer prior to delivery of the powder coating to the can-maker's site, i.e., production of the polymer dispersion 914, chemically preparing the polymer powder particles 916 (e.g., spray drying), formulation of the final powder coating composition 918, packaging of the powder coating composition, 920, and delivery of the powder coating composition 922. Once the uncoated metal and powder coating are on-site at the can-maker's facility, the metal can be cleaned 910, coated 924, fabricated 926, and packaged for delivery 928 to the filler 930 who will fill and seal the food or beverage containers prior to delivery 940 to the distribution warehouses and eventually to the vendors who will sell the packaged food and beverages to the consumers.

In one example of an in-line process, a coating application device 924 would be in-line following an un-spooler (not shown, that unwinds a coil), and prior to the fabrication press. For beverage end fabrication, there are typically two presses, a shell press that forms the radially symmetrical features (the countersink and shoulder), and a conversion press that forms the non-radially-symmetrical features (the thumbwell, score, rivet placement, etc.). Compounders that apply the gasket material to can ends will come after the press, followed by the material handlers that package the can parts. The presses may complete various types of can part fabrication, such as punching blanks, pressing features into the flat metal, rotary curling, rolling beads into the can walls, necking to reduce the diameter of a portion of the cylindrical can, coining to fix a tab to a rivet, or forming lugs or thread to keep a closure on a glass, metal or plastic container.

### EXEMPLARY EMBODIMENTS

### Embodiments A: Cartridge-Based Delivery Systems and Delivery Methods

Embodiment A-1 is a cartridge-based delivery system comprising: a plurality of cartridges, wherein each cartridge of the plurality of cartridges comprises a body defining an enclosed volume containing a metal packaging (e.g., a food, beverage, aerosol, or general packaging container (e.g., can or cup), portion thereof, or metal closure) powder coating composition, wherein, optionally, 0.001 cubic meter or more of the powder coating composition is contained within the enclosed volume; a dispensing port configured to provide a path for the powder coating composition during dispensing of the powder coating composition from the cartridge; an optional inlet port configured to configured to allow makeup air to enter the enclosed volume as the powder coating composition is dispensed from the dispensing port; and optionally, desiccant material exposed within the enclosed volume such that the makeup air passes through the desiccant material when entering the enclosed volume; wherein the metal packaging powder coating composition comprises: powder polymer particles (preferably, chemically produced, e.g., spray dried, powder polymer particles) comprising a polymer having a number average molecular weight of at least 2000 Daltons, wherein the powder polymer particles have a particle size distribution having a D50 of less than 25 microns; and preferably one or more charge control agents in contact with the powder polymer particles, and/or magnetic carrier particles, which may or may not be in contact with the powder polymer particles.

Embodiment A-2 is the system of Embodiment A-1, wherein the inlet port is configured to receive the powder coating composition during delivery of the powder coating composition into the enclosed volume.

Embodiment A-3 is the system of Embodiment A-1 or A-2, wherein the system comprises a delivery pipe configured to deliver the powder coating composition into the enclosed volume through the inlet port and, optionally, to remove air from the enclosed volume through the inlet port while delivering the powder coating composition into the enclosed volume.

Embodiment A-4 is the system of Embodiment A-3, wherein the delivery pipe comprises a delivery lumen and a return lumen, wherein the delivery lumen is configured to deliver the powder coating composition into the enclosed volume and the return lumen is configured to remove air from the enclosed volume, and, optionally, wherein the delivery lumen and the return lumen are arranged coaxially along the delivery pipe.

Embodiment A-5 is the system of any of the preceding Embodiments A, wherein the plurality of cartridges are configured to stack such that each cartridge of the plurality of cartridges is configured to be supported on a top surface of another cartridge of the plurality of cartridges.

Embodiment A-6 is the system of Embodiment A-5, wherein the dispensing port and the inlet port on each cartridge of the plurality of cartridges are offset in a horizontal direction in any stacked set of cartridges.

Embodiment A-7 is the system of any of the preceding Embodiments A, wherein each cartridge of the plurality of cartridges comprises a sloped bottom floor and wherein the dispensing port is positioned at a bottommost location on the sloped bottom floor.

Embodiment A-8 is the system of any of the preceding Embodiments A, wherein the system comprises an oscillating mechanism configured to vibrate or oscillate the powder coating composition in the enclosed volume to facilitate flow of the powder coating composition through the dispensing port.

Embodiment A-9 is the system of Embodiment A-8, wherein the oscillating mechanism is attached to a base configure to support each cartridge of the plurality of cartridges.

Embodiment A-10 is the system of any of the preceding Embodiments A, wherein each cartridge of the plurality of cartridges is convertible between a collapsed configuration and an expanded configuration, wherein cartridge comprises a collapsed enclosed volume in the collapsed configuration and an expanded enclosed volume in the expanded configuration, wherein the collapsed enclosed volume is less than the expanded enclosed volume.

Embodiment A-11 is the system of Embodiment A-10, wherein the body of each cartridge of the plurality of cartridges comprises an expansion joint located between a bottom panel and a top panel of the cartridge, wherein the expansion joint is configured to connect and seal the bottom panel to the top panel when the bottom panel and the top panel are separated from each other by an expanded distance when the cartridge is in the expanded configuration, and wherein the expansion joint is configured to connect and seal the bottom panel to the top panel when the bottom panel and the top panel are separated from each other by a collapsed distance when the cartridge is in the collapsed configuration, wherein the collapsed distance is less than the expanded distance.

Embodiment A-12 is the system of Embodiment A-11, wherein a ratio of the collapsed distance to the expanded distance is 0.5:1 or less, 0.4:1 or less, or 0.3:1 or less

Embodiment A-13 is the system of any of Embodiment A-10 to A-12, wherein the body defines a collapsible enclosed volume that is 60% or less, 50% or less, 40% or less, 30% or less, or 20% or less of the expanded enclosed volume.

Embodiment A-14 is the system of any of Embodiment A-10 to A-13, wherein the body defines a collapsed enclosed volume of 0.5 cubic meter or less, 0.4. cubic meter or less, or 0.3 cubic meter or less, 0.2 cubic meter or less, 0.1 cubic meter or less, 0.05 cubic meter or less, 0.01 cubic meter or less, 0.005 cubic meter or less, 0.001 or cubic meter or less when the cartridge is in the collapsed configuration.

Embodiment A-15 is the system of any of Embodiments A-10 to A-14, wherein the body defines an expanded enclosed volume of 0.001 cubic meter or more, 0.005 cubic meter or more, 0.01 cubic meter or more, 0.05 cubic meter or more, 0.1 cubic meter or more, 0.2 cubic meter or more, 0.3 cubic meter or more, 0.4 cubic meter or more, 0.5 cubic meter or more, 0.75 cubic meter or more, or 1 cubic meter or more when the cartridge is in the expanded configuration.

Embodiment A-16 is the system of any of Embodiments A-10 to A-15, wherein the expansion joint comprises one or both of a flexible polymeric ring and a flexible accordion-shaped bellows.

Embodiment A-17 is the system of any of Embodiments A-10 to A-16, wherein the expansion joint is configured to selectively retain the top panel and the bottom panel separated from each other by the expanded distance.

Embodiment A-18 is the system of any of the preceding Embodiments A, wherein each cartridge of the plurality of cartridges comprises an inlet cap closing the inlet port, wherein, optionally, the desiccant material is contained within the inlet cap.

Embodiment A-19 is a method of delivering and dispensing a powder coating composition, the method comprising: filling a plurality of cartridges according to any of Embodiments A-1 to A-18 with a metal packaging (e.g., a food, beverage, aerosol, or general packaging container (e.g., can or cup), portion thereof, or metal closure) powder coating composition at a filling location; delivering the plurality of cartridges filled with the powder coating composition to a dispensing location; receiving the plurality of cartridges at the filling location or a different filling location from the dispensing location after dispensing a majority of the powder coating composition in the plurality of cartridges; and refilling the plurality of cartridges at the filling location or the different filling location with the powder coating composition used to fill the plurality of cartridges at the filling location or a different a metal packaging powder coating composition; wherein the metal packaging powder coating composition comprises: powder polymer particles (preferably, chemically produced, e.g., spray dried, powder polymer particles) comprising a polymer having a number average molecular weight of at least 2000 Daltons, wherein the powder polymer particles have a particle size distribution having a D50 of less than 25 microns; and preferably one or more charge control agents in contact with the powder polymer particles, and/or magnetic carrier particles, which may or may not be in contact with the powder polymer particles.

Embodiment A-20 is the method of Embodiment A-19, wherein the method comprises cleaning the interior volumes of the plurality of cartridges after receiving the plurality of cartridges and before refilling the plurality of cartridges.

Embodiment A-21 is the method of Embodiment A-19 or A-20, wherein the method comprises expanding each cartridge of the plurality of cartridges from a collapsed interior volume to an expanded interior volume after receiving the plurality of cartridges at the filling location.

Embodiment A-22 is the system or method of any of the preceding Embodiments A, wherein the powder polymer particles comprise powder polymer particles prepared by spray drying or limited coalescence.

Embodiment A-23 is the system or method of any of the preceding Embodiments A, wherein the powder polymer particles have a particle size distribution having a D50 of less than 20 microns, less than 15 microns, or less than 10 microns.

Embodiment A-24 is the system or method of any of the preceding Embodiments A, wherein the powder polymer particles have a particle size distribution having a D90 of less than 25 microns, less than 20 microns, less than 15 microns, or less than 10 microns.

Embodiment A-25 is the system or method of any of the preceding Embodiments A, wherein the powder polymer particles have a particle size distribution having a D95 of less than 25 microns, less than 20 microns, less than 15 microns, or less than 10 microns.

Embodiment A-26 is the system or method of any of the preceding Embodiments A, wherein the powder polymer particles have a particle size distribution having a D99 of less than 25 microns, less than 20 microns, less than 15 microns, or less than 10 microns.

Embodiment A-27 is the system or method of any of the preceding Embodiments A, wherein the powder polymer particles have a particle size distribution having a D50 (preferably, a D90, D95, or a D99) of greater than 1 micron, greater than 2 microns, greater than 3 microns, or greater than 4 microns.

Embodiment A-28 is the system or method of any of the preceding Embodiments A, wherein the powder coating composition as a whole has a particle size distribution having a D50 (preferably, a D90, D95, or a D99) of less than 25 microns, less than 20 microns, less than 15 microns, or less than 10 microns, and optionally also a D90 of less than 25 microns, less than 20 microns, less than 15 microns, or less than 10 microns.

Embodiment A-29 is the system or method of any of the preceding Embodiments A, wherein the powder coating composition comprises at least 40 wt-%, at least 50 wt-%, at least 60 wt-%, at least 70 wt-%, at least 80 wt-%, or at least 90 wt-% of the powder polymer particles, based on the total weight of the powder coating composition.

Embodiment A-30 is the system or method of any of the preceding Embodiments A, wherein the powder coating composition comprises up to 100 wt-%, up to 99.99 wt-%, up to 95 wt-%, or up to 90 wt-%, of the powder polymer particles, based on the total weight of the powder coating composition.

Embodiment A-31 is the system or method of any of the preceding Embodiments A, wherein the one or more charge control agents are present, and preferably present in an amount of at least 0.01 wt-%, at least 0.1 wt-%, or at least 1 wt-%, based on the total weight of the powder coating composition (e.g., the charge control agent(s) and powder polymer particles). In some embodiments, the charge control agents are preferably present in an amount of up to 10 wt-%, up to 9 wt-%, up to 8 wt-%, up to 7 wt-%, up to 6 wt-%, up to 5 wt-%, up to 4 wt-%, or up to 3 wt-%, based on the total weight of the powder coating composition (e.g., the charge control agent(s) and powder polymer particles)

Embodiment A-32 is the system or method of any of the preceding Embodiments A, wherein the magnetic carrier particles are present.

Embodiment A-33 is the system or method of any of the preceding Embodiments A, wherein the powder polymer particles are chemically produced (as opposed to mechanically produced (e.g., ground) polymer particles).

Embodiment A-34 is the system or method of any of the preceding Embodiments A, wherein the powder polymer particles have a shape factor of 100-140 (spherical and potato shaped), and preferably 120-140 (e.g., potato shaped).

Embodiment A-35 is the system or method of any of the preceding Embodiments A, wherein the powder coating composition as a whole (i.e., the overall composition) has a shape factor of 100-140 (spherical and potato shaped), and preferably 120-140 (e.g., potato shaped).

Embodiment A-36 is the system or method of any of the preceding Embodiments A, wherein the powder polymer particles have a compressibility index of 1 to 50 (or 1 to 10, 11 to 15, 16 to 20, 21 to 35, or 35 to 50).

Embodiment A-37 is the system or method of any of the preceding Embodiments A, wherein the powder coating composition as a whole has a compressibility index of 1 to 20 (or 1 to 10, 11 to 15, or 16 to 20).

Embodiment A-38 is the system or method of any of the preceding Embodiments A, wherein the powder polymer particles have a Haussner Ratio of 1.00 to 2.00 (or 1.00 to 1.11, 1.12 to 1.18, 1.19 to 1.25, 1.26 to 1.50, or 1.51 to 2.00).

Embodiment A-39 is the system or method of any of the preceding Embodiments A, wherein the powder coating composition as a whole has a Haussner Ratio of 1.00 to 2.00 (or 1.00 to 1.11, 1.12 to 1.18, or 1.19 to 1.25).

Embodiment A-40 is the system or method of any of the preceding Embodiments A, wherein the powder polymer particles comprise a thermoplastic polymer.

Embodiment A41 is the system or method of any of the preceding Embodiments A, wherein the powder polymer particles comprise a polymer having a melt flow index greater than 15 grams/10 minutes, greater than 50 grams/10 minutes, or greater than 100 grams/10 minutes.

Embodiment A-42 is the system or method of any of the preceding Embodiments A, wherein the powder polymer particles comprise a polymer having a melt flow index of up to 200 grams/10 minutes, or up to 150 grams/10 minutes.

Embodiment A-43 is the system or method of any of the preceding Embodiments A, wherein the powder coating composition as a whole exhibits a melt flow index greater than 15 grams/10 minutes, greater than 50 grams/10 minutes, or greater than 100 grams/10 minutes.

Embodiment A-44 is the system or method of any of the preceding Embodiments A, wherein the powder coating composition as a whole exhibits a melt flow index of up to 200 grams/10 minutes, or up to 150 grams/10 minutes.

Embodiment A-45 is the system or method of any of the preceding Embodiments A, wherein the powder polymer particles comprise a thermoset polymer.

Embodiment A-46 is the system or method of any of the preceding Embodiments A, wherein the powder polymer particles comprise a polymer having a glass transition temperature (Tg) of at least 40° C., at least 50° ° C., at least 60° ° C., or at least 70° C.

Embodiment A-47 is the system or method of any of the preceding Embodiments A, wherein the powder polymer particles comprise a polymer having a Tg of up to 150° ° C., up to 125° C., up to 110° C., up to 100° C., or up to 80° C.

Embodiment A-48 is the system or method of any of the preceding Embodiments A, wherein the powder polymer particles comprise a crystalline or semi-crystalline polymer having a melting point of at least 40° C.

Embodiment A-49 is the system or method of any of the preceding Embodiments A, wherein the powder polymer particles comprise a crystalline or semi-crystalline polymer having a melting point of up to 300° C.

Embodiment A-50 is the system or method of any of the preceding Embodiments A, wherein the powder polymer particles comprise a polymer selected from a polyacrylic (e.g., a solution-polymerized acrylic polymer, an emulsion polymerized acrylic polymer, or combination thereof), polyether, polyolefin, polyester, polyurethane, polycarbonate, polystyrene, or a combination thereof (i.e., copolymer or mixture thereof such as polyether-acrylate copolymer). Preferably, the polymer is selected from a polyacrylic, polyether, polyolefin, polyester, or a combination thereof.

Embodiment A-51 is the system or method of any of the preceding Embodiments A, wherein the polymer Mn is at least 5,000 Daltons, at least 10,000 Daltons, or at least 15,000 Daltons.

Embodiment A-52 is the system or method of any of the preceding Embodiments A, wherein the polymer Mn is up to 10,000,000 Daltons, up to 1,000,000 Daltons, up to 100,000 Daltons, or up to 20,00 Daltons.

Embodiment A-53 is the system or method of any of the preceding Embodiments A, wherein the polymer has a polydispersity index (Mw/Mn) of less than 4, less than 3, less than 2, or less than 1.5.

Embodiment A-54 is the system or method of any of the preceding Embodiments A, wherein the one or more charge control agents are present, and preferably disposed on a surface of the powder polymer particles (more preferably, the polymer particles are at least substantially coated, or even completely coated, with charge control agent).

Embodiment A-55 is the system or method of any of the preceding Embodiments A, wherein the one or more charge control agents, when present, enable the powder polymer particles to efficiently accept a charge to facilitate application to a substrate.

Embodiment A-56 is the system or method of Embodiment A-55, wherein the one or more charge control agents, when present, provide a charge to the powder polymer particles by friction, during application to a substrate, thereby forming triboelectrically charged powder polymer particles.

Embodiment A-57 is the system or method of any of the preceding Embodiments A, wherein the one or more charge control agents comprise particles having particle sizes in the sub-micron range (e.g., less than 1 micron, 100 nanometers or less, 50 nanometers or less, or 20 nanometers or less).

Embodiment A-58 is the system or method of any of the preceding Embodiments A, wherein the one or more charge control agents comprise inorganic particles.

Embodiment A-59 is the system or method of any of the preceding Embodiments A, wherein the one or more charge control agents comprise hydrophilic fumed aluminum oxide particles, hydrophilic precipitated sodium aluminum silicate particles, metal carboxylate and sulfonate particles, quaternary ammonium salts (e.g., quaternary ammonium sulfate or sulfonate particles), polymers containing pendant quaternary ammonium salts, ferromagnetic pigments, transition metal particles, nitrosine or azine dyes, copper phthalocyanine pigments, metal complexes of chromium, zinc, aluminum, zirconium, calcium, or combinations thereof.

Embodiment A-60 is the system or method of any of the preceding Embodiments A further comprising one or more optional additives selected from lubricants, adhesion promoters, crosslinkers, catalysts, colorants (e.g., pigments or dyes), ferromagnetic pigments, degassing agents, levelling agents, matting agents, wetting agents, surfactants, flow control agents, heat stabilizers, anti-corrosion agents, adhesion promoters, inorganic fillers, and combinations thereof.

Embodiment A-61 is the system or method of Embodiment A-59 further comprising one or more lubricants.

Embodiment A-62 is the system or method of Embodiment A-61, wherein the one or more lubricants are present in the powder coating composition in an amount of at least 0.1 wt-%, at least 0.5 wt-%, or at least 1 wt-%, based on the total weight of the powder coating composition.

Embodiment A-63 is the system or method of Embodiment A-61 or A-62, wherein the one or more lubricants are present in the powder coating composition in an amount of up to 4 wt-%, up to 3 wt-%, or up to 2 wt-%, based on the total weight of the powder coating composition.

Embodiment A-64 is the system or method of any of Embodiments A-40 through A-43 further comprising one or more crosslinkers and/or catalysts.

Embodiment A-65 is the system or method of any of the preceding Embodiments A, wherein the powder polymer particles comprise agglomerates (i.e., clusters) of primary polymer particles.

Embodiment A-66 is the system or method of Embodiment A-65, wherein the agglomerates have a particle size of 1 micron to 25 microns.

Embodiment A-67 is the system or method of Embodiment A-65 or A-66, wherein and the primary polymer particles have a primary particle size of 0.05 micron to 8 microns.

Embodiment A-68 is the system or method of any of the preceding Embodiments A, wherein the powder polymer particles comprise powder polymer particles prepared by spray drying or limited coalescence.

Embodiment A-69 is the system or method of any of the preceding Embodiments A, wherein the powder coating composition is substantially free of each of bisphenol A, bisphenol F, and bisphenol S.

Embodiment A-70 is the system or method of any of the preceding Embodiments A, wherein the powder coating composition is substantially free of all bisphenol compounds, except for TMBPF.

Embodiment A-71 is the system or method of any of the preceding Embodiments A, wherein the powder coating composition forms a coating that includes less than 50 ppm, less than 25 ppm, less than 10 ppm, or less than 1 ppm, extractables, if any, when tested pursuant to the Global Extraction Test.

Embodiment A-72 is the system or method of any of the preceding Embodiments A, wherein the powder coating composition forms a coating that adheres to a substrate, such as a metal substrate, according to the Adhesion Test with an adhesion rating of 9 or 10, preferably 10.

Embodiment A-73 is the system or method of any of the preceding Embodiments A, wherein the powder coating composition forms a continuous hardened coating that is free of pinholes and other coating defects that result in exposed substrate. Such film imperfections/failures can be indicated by a current flow measured in milliamps (mA) using the Flat Panel Continuity Test described in the Test Methods.

Embodiment A-74 is the system or method of any of the preceding Embodiments A, wherein the powder coating composition, when applied to a cleaned and pretreated aluminum panel and subjected to a curative bake for an appropriate duration to achieve a 242° C. peak metal temperature (PMT) and a dried film thickness of approximately 7.5 milligram per square inch and formed into a fully converted 202 standard opening beverage can end, passes less than 5 milliamps of current while being exposed for 4 seconds to an electrolyte solution containing 1% by weight of NaCl dissolved in deionized water.

### Embodiments B: Powder-On-Powder Coating Methods, Systems, and Resultant Products

Embodiment B-1 is a method of coating a metal substrate suitable for use in forming metal packaging (e.g., a food, beverage, aerosol, or general packaging container (e.g., can or cup), portion thereof, or metal closure, or pull tab for an easy open end), the method comprising: providing a metal substrate; providing multiple metal packaging powder coating compositions, wherein each powder coating composition comprises powder polymer particles (preferably, chemically produced powder polymer particles, e.g., such as those produced by spray drying or limited coalescence), and at least two of the multiple metal packaging powder coating compositions are different; directing each of the multiple powder coating compositions to at least a portion of the metal substrate such that at least one powder coating composition is deposited on another different powder coating composition (prior to or after hardening the one or more different underlying powder coating composition); and providing conditions effective for the multiple powder coating compositions to form a hardened, preferably continuous, adherent coating on at least a portion of the metal substrate; wherein each metal packaging powder coating composition comprises: powder polymer particles (preferably, chemically produced powder polymer particles, e.g., such as those produced by spray drying or limited coalescence) comprising a polymer having a number average molecular weight of at least 2000 Daltons, wherein the powder polymer particles have a particle size distribution having a D50 of less than 25 microns; and preferably one or more charge control agents in contact with the powder polymer particles, and/or magnetic carrier particles, which may or may not be in contact with the powder polymer particles.

Embodiment B-2 is the method of Embodiment B-1, wherein providing conditions effective comprises providing conditions effective for each of the powder coating compositions to form a hardened, preferably continuous, adherent coating between depositing layers of different powder coating compositions.

Embodiment B-3 is the method of Embodiment B-1, wherein providing conditions effective comprises providing conditions effective for each of the powder coating compositions to form a hardened, preferably continuous, adherent coating after depositing all the layers of different powder coating compositions.

Embodiment B-4 is the method of any of the preceding Embodiments B, wherein the different powder coating compositions are chemically different.

Embodiment B-5 is the method of Embodiment B-4, wherein the different powder coating compositions are in different colors, and the method results in color-on-color printing.

Embodiment B-6 is the method of Embodiment B-5, wherein the powder coating composition deposited as the outermost (i.e., top) coating forms a clear coating.

Embodiment B-7 is the method of any of the preceding Embodiments B, wherein the different powder coating compositions provide different functions.

Embodiment B-8 is the method of Embodiment B-7, wherein a first powder coating composition is deposited to provide a relatively soft, flexible primer layer, and a second powder coating composition is deposited on the first powder coating composition to provide a relatively hard, abrasion-resistant top coating.

Embodiment B-9 is the method of any of the preceding Embodiments B, wherein the different powder coating compositions are deposited in different amounts to form coating layers having different thicknesses.

Embodiment B-10 is the method of any of the preceding Embodiments B, wherein the multiple powder coating compositions are deposited in a manner to form a textured surface.

Embodiment B-11 is the method of any of Embodiments B-1 through B-9, wherein the multiple powder coating compositions are deposited in a manner to form a smooth surface.

Embodiment B-12 is the method of any of the preceding Embodiments B, wherein the hardened, preferably continuous, adherent coating forms markings.

Embodiment B-13 is the method of any of the preceding Embodiments B, wherein the metal substrate is a cryogenically cleaned metal substrate.

Embodiment B-14 is the method of any of the preceding Embodiments B, further comprising cryogenically cleaning the metal substrate prior to directing each of the multiple powder coating compositions to at least a portion of the metal substrate.

Embodiment B-15 is the method of any of the preceding Embodiments B, wherein the metal substrate has an average thickness of up to 635 microns (or up to 375 microns).

Embodiment B-16 is the method of any of the preceding Embodiments B, wherein the metal substrate has an average thickness of at least 125 microns.

Embodiment B-17 is the method of any of the preceding Embodiments B, wherein the hardened adherent coating has an average total thickness of up to 100 microns, or a maximum thickness up to 100 microns.

Embodiment B-18 is the method of Embodiment B-17, wherein the hardened adherent coating has an average total thickness of up to 50 microns, preferably up to 25 microns (e.g., up to 20 microns, up to 15 microns, up to 10 microns, or up to 5 microns).

Embodiment B-19 is the method of any of the preceding Embodiments B, wherein the hardened adherent coating has an average total thickness, or a minimum thickness, of at least 1 micron (or at least 2 microns, at least 3 microns, or at least 4 microns).

Embodiment B-20 is the method of any of the preceding Embodiments B, wherein one or more of the multiple powder coating compositions comprise powder polymer particles (preferably, chemically produced powder polymer particles, such as those produced by spray drying or limited coalescence) comprising a polymer having a number average molecular weight of at least 2000 Daltons (or at least 5,000 Daltons, at least 10,000 Daltons, or at least 15,000 Daltons).

Embodiment B-21 is the method of any of the preceding Embodiments B, wherein one or more of the multiple powder coating compositions comprise powder polymer particles comprising a polymer having a number average molecular weight of up to 10,000,000 Daltons (or up to 1,000,000 Daltons, up to 100,000 Daltons, or up to 20,00 Daltons).

Embodiment B-22 is the method of any of the preceding Embodiments B, wherein one or more of the multiple powder coating compositions comprise powder polymer particles comprising a polymer having a polydispersity index (Mw/Mn) of less than 4 (or less than 3, less than 2, or less than 1.5).

Embodiment B-23 is the method of any of Embodiments B-20 through B-22, wherein the powder polymer particles comprise the polymer in an amount of at least 40 wt-%, at least 50 wt-%, at least 60 wt-%, at least 70 wt-%, at least 80 wt-%, at least 90 wt-%, or at least 95 wt-%.

Embodiment B-24 is the method of any of the preceding Embodiments B, wherein one or more of the multiple powder coating compositions comprise powder polymer particles having a particle size distribution having a D50 of less than 25 microns (or less than 20 microns, less than 15 microns, or less than 10 microns).

Embodiment B-25 is the method of any of the preceding Embodiments B, wherein one or more of the multiple powder coating compositions comprise powder polymer particles having a particle size distribution having a D90 of less than 25 microns (or less than 20 microns, less than 15 microns, or less than 10 microns).

Embodiment B-26 is the method of any of the preceding Embodiments B, wherein one or more of the multiple powder coating compositions comprise the powder polymer particles in an amount of at least 40 wt-%, at least 50 wt-%, at least 60 wt-%, at least 70 wt-%, at least 80 wt-%, or at least 90 wt-%.

Embodiment B-27 is the method of any of the preceding Embodiments B, wherein one or more of the multiple powder coating compositions comprise the powder polymer particles in an amount of up to 100 wt-%, up to 99.99 wt-%, up to 95 wt-%, or up to 90 wt-%.

Embodiment B-28 is the method of any of the preceding Embodiments B, wherein one or more of the multiple powder coating compositions comprise one or more charge control agents in contact with the powder polymer particles, and/or magnetic carrier particles, which may or may not be in contact with the powder polymer particles.

Embodiment B-29 is the method of Embodiment B-28, wherein one or more of the multiple powder coating compositions comprise one or more charge control agents in an amount of at least 0.01 wt-%, at least 0.1 wt-%, or at least 1 wt-%.

Embodiment B-30 is the method of Embodiment B-28 or B-29, wherein one or more of the multiple powder coating compositions comprise one or more charge control agents in an amount of up to 10 wt-%, up to 9 wt-%, up to 8 wt-%, up to 7 wt-%, up to 6 wt-%, up to 5 wt-%, up to 4 wt-%, or up to 3 wt-%.

Embodiment B-31 is the method of any of Embodiments B-28 through B-30, wherein the one or more charge control agents enable the powder polymer particles to efficiently accept a triboelectric charge to facilitate application to a substrate (e.g., via a conductive or semiconductive transporter such as any of those described herein).

Embodiment B-32 is the method of any of Embodiments B-28 through B-31, wherein the one or more charge control agents comprise particles having particle sizes in the sub-micron range (e.g., less than 1 micron, 100 nanometers or less, 50 nanometers or less, or 20 nanometers or less).

Embodiment B-33 is the method of any of Embodiments B-28 through B-32, wherein the one or more charge control agents comprise hydrophilic fumed aluminum oxide particles, hydrophilic precipitated sodium aluminum silicate particles, metal carboxylate and sulfonate particles, quaternary ammonium salts (e.g., quaternary ammonium sulfate or sulfonate particles), polymers containing pendant quaternary ammonium salts, ferromagnetic pigments, transition metal particles, nitrosine or azine dyes, copper phthalocyanine pigments, metal complexes of chromium, zinc, aluminum, zirconium, calcium, or combinations thereof.

Embodiment B-34 is the method of any of Embodiments B-28 through B-33, wherein the one or more charge control agents comprise inorganic particles.

Embodiment B-35 is the method of any of the preceding Embodiments B, wherein directing each of the multiple powder coating compositions comprises directing each of the multiple powder coating compositions (preferably, triboelectrically charged powder coating composition) to at least a portion of the metal substrate by means of an electric or electromagnetic field, or any other suitable type of applied field.

Embodiment B-36 is the method of Embodiment B-35, wherein directing each of the multiple powder coating compositions comprises directing each of the multiple powder coating compositions to at least a portion of the metal substrate by means of an electric field.

Embodiment B-37 is the method of any of the preceding Embodiments B, wherein directing each of the multiple powder coating compositions to at least a portion of the metal substrate comprises: feeding each of the multiple powder coating compositions to one or more transporters; and directing each of the multiple powder coating compositions from the one or more transporters to at least a portion of the metal substrate by means of an electromagnetic field. The one or more transporter may comprise a transporter surface, imaging member, and/or intermediate transfer member.

Embodiment B-38 is the method of Embodiment B-37, wherein directing each of the multiple powder coating compositions from the one or more transporters comprises directing each of the multiple powder coating compositions from the one or more transporters to at least a portion of the metal substrate by means of an electric field between the one or more transporters and the metal substrate.

Embodiment B-39 is the method of Embodiment B-37 or B-38, wherein directing each of the multiple powder coating compositions from the one or more transporters comprises: directing each of the multiple powder coating compositions from the one or more transporters to one or more transfer members by means of an electric field between the one or more transporters and the one or more transfer members; and transferring each of the multiple powder coating compositions from the one or more transfer members to at least a portion of the metal substrate.

Embodiment B-40 is the method of Embodiment B-39, wherein the one or more transfer members comprise a semiconductive or insulative polymeric drum or belt.

Embodiment B-41 is the method of Embodiment B-39 or B-40, wherein transferring each of the multiple powder coating compositions from the one or more transfer members to at least a portion of the metal substrate comprises applying thermal energy, or electrical, electrostatic, or mechanical forces to effect the transfer.

Embodiment B-42 is the method of any of Embodiments B-37 through B-41, wherein the one or more transporters comprises a magnetic roller, polymeric conductive roller, polymeric semiconductive roller, metallic belt, polymeric conductive belt, or polymeric semiconductive belt; and one or more of the multiple powder coating compositions comprise magnetic carrier particles.

Embodiment B-43 is the method of any of the preceding Embodiments B, wherein providing conditions effective for the multiple powder coating compositions to form a hardened coating on at least a portion of the metal substrate comprises applying thermal energy (e.g., using a convection oven or induction coil), UV radiation, IR radiation, or electron beam radiation to the multiple powder coating compositions.

Embodiment B-44 is the method of Embodiment B-43, wherein providing conditions comprises applying thermal energy.

Embodiment B-45 is the method of Embodiment B-44, wherein applying thermal energy comprises applying thermal energy at a temperature of at least 100° C. or at least 177° C.

Embodiment B-46 is the method of Embodiment B-44 or B-45, wherein applying thermal energy comprises applying thermal energy at a temperature of up to 300° C. or up to 250° C.

Embodiment B-47 is the method of any of the preceding Embodiments B, wherein the metal substrate comprises steel, stainless steel, electrogalvanized steel, tin-free steel (TFS), tin-plated steel, electrolytic tin plate (ETP), or aluminum.

Embodiment B-48 is the method of any of the preceding Embodiments B, wherein one or more of the multiple powder coating compositions comprise chemically produced powder polymer particles (as opposed to mechanically produced (e.g., ground) polymer particles).

Embodiment B-49 is the method of any of the preceding Embodiments B, wherein one or more of the multiple powder coating compositions comprise powder polymer particles having a shape factor of 100-140 (spherical and potato shaped) (or 120-140 (e.g., potato shaped)).

Embodiment B-50 is the method of any of the preceding Embodiments B, wherein one or more of the multiple powder coating compositions comprise powder polymer particles having a compressibility index of 1 to 50 (or 1 to 10, 11 to 15, 16 to 20, 21 to 35, or 36 to 50), and a Haussner Ratio of 1.00 to 2.00 (or 1.00 to 1.11, 1.12 to 1.18, 1.19 to 1.25, 1.26 to 1.50, or 1.51 to 2.00).

Embodiment B-51 is the method of any of the preceding Embodiments B, wherein one or more of the multiple powder coating compositions comprise powder polymer particles comprising a thermoplastic polymer.

Embodiment B-52 is the method of any of the preceding Embodiments B, wherein one or more of the multiple powder coating compositions comprise powder polymer particles comprising a polymer having a melt flow index greater than 15 grams/10 minutes, greater than 50 grams/10 minutes, or greater than 100 grams/10 minutes, and preferably, a melt flow index of up to 200 grams/10 minutes, or up to 150 grams/10 minutes.

Embodiment B-53 is the method of any of the preceding Embodiments B, wherein one or more of the multiple powder coating compositions comprise powder polymer particles comprising a polymer having a glass transition temperature (Tg) of at least 40° C., at least 50° C., at least 60° ° C., or at least 70° C.

Embodiment B-54 is the method of any of the preceding Embodiments B, wherein one or more of the multiple powder coating compositions comprise powder polymer particles comprising a polymer having a Tg of up to 150° C., up to 125° C., up to 110° C., up to 100° C., or up to 80° C.

Embodiment B-55 is the method of any of the preceding Embodiments B, wherein the hardened coating does not have any detectable Tg.

Embodiment B-56 is the method of any of the preceding Embodiments B, wherein one or more of the multiple powder coating compositions comprise powder polymer particles comprising a crystalline or semi-crystalline polymer having a melting point of at least 40° C. and up to 300° C.

Embodiment B-57 is the method of any of the preceding Embodiments B, wherein one or more of the multiple powder coating compositions comprise powder polymer particles comprising a polymer selected from a polyacrylic (e.g., a solution-polymerized acrylic polymer, an emulsion polymerized acrylic polymer, or combination thereof), polyether, polyolefin, polyester, polyurethane, polycarbonate, polystyrene, or a combination thereof (i.e., copolymer or mixture thereof such as polyether-acrylate copolymer).

Embodiment B-58 is the method of Embodiment B-57, wherein one or more of the multiple powder coating compositions comprise powder polymer particles comprising a polymer selected from a polyacrylic, polyether, polyolefin, polyester, or a combination thereof.

Embodiment B-59 is the method of any of the preceding Embodiments B, wherein one or more of the multiple powder coating compositions comprise one or more optional additives selected from lubricants, adhesion promoters, crosslinkers, catalysts, colorants (e.g., pigments or dyes), ferromagnetic pigments, degassing agents, levelling agents, wetting agents, matting agents, surfactants, flow control agents, heat stabilizers, anti-corrosion agents, adhesion promoters, inorganic fillers, metal driers, and combinations thereof.

Embodiment B-60 is the method of Embodiment B-59, wherein one or more of the multiple powder coating compositions further comprise one or more lubricants, which is incorporated into the hardened coating,

Embodiment B-61 is the method of Embodiment B-60, wherein the one or more lubricants are present in or on the hardened coating in an amount of at least 0.1 wt-%, at least 0.5 wt-%, or at least 1 wt-%, based on the total weight of the overall hardened coating.

Embodiment B-62 is the method of Embodiment B-60 or B-61, wherein the one or more lubricants are present in or on the hardened coating in an amount of up to 4 wt-%, up to 3 wt-%, or up to 2 wt-%, based on the total weight of the overall hardened coating.

Embodiment B-63 is the method of any of Embodiments B-60 through B-62, wherein the lubricant comprises carnauba wax, synthetic wax (e.g., Fischer-Tropsch wax), polytetrafluoroethylene (PTFE) wax, polyolefin wax (e.g., polyethylene (PE) wax, polypropylene (PP) wax, and high-density polyethylene (HDPE) wax), amide wax (e.g., micronized ethylene-bis-stearamide (EBS) wax), combinations thereof, and modified version thereof (e.g., amide-modified PE wax, PTFE-modified PE wax, and the like)

Embodiment B-64 is the method of any of Embodiments B-1 through B-59, wherein the powder coating compositions do not include lubricant or a lubricant is selectively applied in a patterned format such that it only covers 50% or less of a base powder layer and/or is typically not thicker than the particle size of the lubricant applied.

Embodiment B-65 is the method of any of the preceding Embodiments B, wherein one or more of the multiple powder coating compositions comprise powder polymer particles comprising agglomerates (i.e., clusters) of primary polymer particles.

Embodiment B-66 is the method of any of the preceding Embodiments B, wherein one or more of the multiple powder coating compositions are substantially free of each of bisphenol A, bisphenol F, and bisphenol S, structural units derived therefrom, or both.

Embodiment B-67 is the method of any of the preceding Embodiments B, wherein one or more of the multiple powder coating compositions are substantially free of all bisphenol compounds, structural units derived therefrom, or both, except for TMBPF.

Embodiment B-68 is the method of any of the preceding Embodiments B, wherein one or more of the multiple powder coating compositions are substantially free of each of formaldehyde and formaldehyde-containing ingredients (e.g., phenol-formaldehyde resins).

Embodiment B-69 is the method of any of the preceding Embodiments B, wherein the hardened, preferably continuous, adherent coating includes less than 50 ppm, less than 25 ppm, less than 10 ppm, or less than 1 ppm, extractables, if any, when tested pursuant to the Global Extraction Test.

Embodiment B-70 is the method of any of the preceding Embodiments B, wherein the hardened, preferably continuous, adherent coating adheres to a substrate, such as a metal substrate, according to the Adhesion Test with an adhesion rating of 9 or 10, preferably 10.

Embodiment B-71 is the method of any of the preceding Embodiments B, wherein the hardened continuous adherent coating is free of pinholes and other coating defects that result in exposed substrate.

Embodiment B-72 is the method of any of the preceding Embodiments B, wherein one or more of the multiple powder coating compositions, when applied to a cleaned and pretreated aluminum panel and subjected to a curative bake for an appropriate duration to achieve a 242° C. peak metal temperature (PMT) and a dried film thickness of approximately 7.5 milligram per square inch and formed into a fully converted 202 standard opening beverage can end, pass less than 5 milliamps of current while being exposed for 4 seconds to an electrolyte solution containing 1% by weight of NaCl dissolved in deionized water.

Embodiment B-73 is the method of any of the preceding Embodiments B, wherein the metal substrate is provided as a coil and the method is a coil-coating process.

Embodiment B-74 is the method of any of Embodiments B-1 through B-72, wherein the metal substrate is provided as a sheet and the method is a sheet-coating process.

Embodiment B-75 is the method of any of Embodiments B-1 through B-72, wherein the metal substrate is provided as a preformed container (e.g., can or cup).

Embodiment B-76 is a coated metal substrate having a surface at least partially coated with a coating prepared by the method of any of the preceding Embodiments B.

Embodiment B-77 is the coated metal substrate of Embodiment B-76, wherein the substrate is a drawn and redrawn substrate.

Embodiment B-78 is the coated metal substrate of Embodiment B-76, wherein the metal substrate is tab stock.

Embodiment B-79 is the coated metal substrate of Embodiment B-76, wherein the metal substrate is aluminum coil for making beverage can ends (with the hardened coating applied to an interior or exterior surface of the beverage can end, or both).

Embodiment B-80 is metal packaging (e.g., a food, beverage, aerosol, or general packaging container (e.g., can or cup), portion thereof, metal closure, or pull tab for an easy open end) comprising a metal substrate having a surface at least partially coated with a coating prepared by the method of any of Embodiments B-1 through B-75.

Embodiment B-81 is the metal packaging of Embodiment B-80, wherein the surface is an interior surface, an exterior surface, or both, of a container (e.g., can or cup) body.

Embodiment B-82 is the metal packaging of Embodiment B-80 or B-81, wherein the surface is a surface of a riveted can end and/or a pull tab.

Embodiment B-83 is the metal packaging of any of Embodiments B-80 through B-82, which is filled with a food, beverage, or aerosol product.

Embodiment B-84 is a packaging coating system, comprising: multiple metal packaging powder coating compositions, wherein at least two of the multiple metal packaging powder coating compositions are different; wherein each powder coating composition comprises powder polymer particles comprising a polymer having a number average molecular weight of at least 2000 Daltons, wherein the powder polymer particles have a particle size distribution having a D50 of less than 25 microns.

Embodiment B-85 is the system of Embodiment B-84, further comprising instructions comprising: directing each of the multiple powder coating compositions to at least a portion of a metal substrate such that at least one powder coating composition is deposited on another different powder coating composition; and providing conditions effective for the multiple powder coating compositions to form a hardened, preferably continuous, adherent coating on at least a portion of the metal substrate.

Embodiment B-86 is the system of Embodiment B-84 and B-85, wherein at least two of the metal packaging powder coating compositions differ in one or more chemical or physical properties.

Embodiment B-87 is the system of Embodiment B-86, wherein the properties include polymer particle properties (such as molecular weight, density, glass transition temperature (Tg), melting temperature (Tm), intrinsic viscosity (IV), melt viscosity (MV), melt index (MI), crystallinity, arrangement of blocks or segments, availability of reactive sites, reactivity, acid number), and coating composition properties (such as surface energy, hydrophobicity, oleophobicity, moisture or oxygen permeability, transparency, heat resistance, resistance to sunlight or ultraviolet energy, adhesion to metals, color or other visual effects, and recyclability).

Embodiment B-88 is the system of Embodiment B-86 or B-87, wherein a particular property of at least two different powder coating compositions differ by at least ±5%, at least +10%, at least ±15%, at least ±25%, at least ±50%, at least ±100%, or more.

Embodiment B-89 is the system of any of Embodiment B-84 to B-88, wherein the system comprises a plurality of cartridges, wherein each cartridge of the plurality of cartridges contains a powder coating composition, and wherein at least two cartridges of the plurality of cartridges contain different powder coating compositions.

Embodiment B-90 is the system of Embodiment B-89, wherein the different powder coating compositions comprise differently colored powder coating composition.

Embodiment B-91 is the system of any of Embodiment B-89 to B-90, wherein the cartridges are refillable and reusable.

Embodiment B-92 is the method of any one of Embodiments B-1 to B-75, wherein the method comprises electrically grounding the metal substrate while directing at least one powder coating composition of the multiple powder coating compositions to the at least a portion of the substrate.

Embodiment B-93 is the method of Embodiment B-92, wherein the method comprises electrostatically adhering at least one powder coating of the multiple powder coating compositions to a transporter surface, imaging member, and/or intermediate transfer member, before directing each of the multiple powder coating compositions to at least a portion of the metal substrate; wherein electrostatically adhering the at least one powder coating composition comprises electrically biasing the transporter surface, imaging member, and/or intermediate transfer member to a non-zero voltage before electrostatically adhering the at least one powder coating composition to the transporter surface, imaging member, and/or intermediate transfer member.

Embodiment B-94 is the method of Embodiment B-93, wherein a first deposited powder coating composition is at a first polarity, and the method further includes changing the first polarity of the first deposited powder coating composition to a second polarity, and applying a second coating composition at a second polarity to the first deposited powder coating composition.

### Embodiments C: Patterned Coating Methods, Systems, and Resultant Products

Embodiment C-1 is a method of coating a metal substrate suitable for use in forming metal packaging (e.g., a food, beverage, aerosol, or general packaging container (e.g., can or cup), portion thereof, metal closure, or pull tab for an easy open end), the method comprising: providing a metal substrate; providing a metal packaging powder coating composition, wherein the powder coating composition comprises powder polymer particles (preferably, chemically produced powder polymer particles, such as those produced by spray drying or limited coalescence); selectively applying the powder coating composition on at least a portion of the metal substrate to form a patterned coating; and providing conditions effective for the powder coating composition to form a hardened adherent patterned coating (which may or may not be continuous) on at least a portion of the metal substrate.

Embodiment C-2 is the method of embodiment 1, wherein the hardened adherent patterned coating forms markings.

Embodiment C-3 is the method of embodiment 1, wherein the hardened adherent patterned coating is in the form of a ring-shaped coating on a metal substrate.

Embodiment C-4 is the method of embodiment 3, wherein the ring-shaped coating is a top coat localized in a metal closure to contact a PVC gasket.

Embodiment C-5 is the method of embodiment 1, wherein the hardened adherent patterned coating is in the form of a spot coating on a food or beverage can end.

Embodiment C-6 is the method of embodiment 5, wherein the hardened adherent patterned coating is in the form of a spot coating on a product-contact area of a food or beverage can end.

Embodiment C-7 is the method of any of the preceding Embodiments C, wherein the powder coating composition is intentionally and selectively deposited in different amounts to form a coating having different thicknesses across the coated surface.

Embodiment C-8 is the method of the preceding Embodiments C, further comprising directing a different powder coating composition to at least a portion of the metal substrate to form a hardened, preferably continuous, adherent coating, which may be a patterned coating or an all-over coating, before or after forming the patterned coating. In certain embodiments of the preceding Embodiments C, the method further comprises applying a conventional liquid coating to the metal substrate to form an all-over coating before forming the patterned coating.

Embodiment C-9 is the method of any of the preceding Embodiments C, wherein: providing a metal packaging powder coating composition comprises providing multiple metal packaging powder coating compositions, wherein each powder coating composition comprises powder polymer particles (preferably, chemically produced powder polymer particles, such as those produced by spray drying or limited coalescence), and at least two of the multiple metal packaging powder coating compositions are different; directing the powder coating composition comprises directing each of the multiple powder coating compositions to at least a portion of the metal substrate such that at least one powder coating composition is optionally deposited on another different powder coating composition to form a coating; and providing conditions comprise providing conditions effective for each of the multiple powder coating compositions to form a hardened, preferably continuous, adherent coating.

Embodiment C-10 is the method of Embodiment C-8 or C-9, wherein providing conditions comprise providing conditions effective for each of the powder coating compositions to form a hardened, preferably continuous, adherent coating between depositing layers of different powder coating compositions.

Embodiment C-11 is the method of Embodiment C-8 or C-9, wherein providing conditions effective comprises providing conditions effective for each of the powder coating compositions to form a hardened, preferably continuous, adherent coating after depositing all the layers of different powder coating compositions.

Embodiment C-12 is the method of any of Embodiments C-8 through C-11, wherein the different powder coating compositions are chemically different.

Embodiment C-13 is the method of Embodiment C-12, wherein the different powder coating compositions are in different colors, and the method results in color-on-color printing.

Embodiment C-14 is the method of Embodiment C-13, wherein the powder coating composition deposited as the outermost (i.e., top) coating forms a clear coating.

Embodiment C-15 is the method of any of Embodiments C-8 through C-14, wherein the different powder coating compositions provide different functions.

Embodiment C-16 is the method of Embodiment C-15, wherein a first powder coating composition is deposited to provide a relatively soft, flexible, primer layer, and a second powder coating composition is deposited on the first powder coating composition to provide a relatively hard, abrasion-resistant top coating.

Embodiment C-17 is the method of any of Embodiments C-8 through C-16, wherein the different powder coating compositions are deposited in different amounts to form coating layers having different thicknesses.

Embodiment C-18 is the method of any of the preceding Embodiments C, wherein the one or more powder coating compositions are deposited in a manner to form a textured surface, or in a manner to form a smooth surface.

Embodiment C-19 is the method of any of the preceding Embodiments C, wherein the one or more powder coating compositions are deposited in a manner to form a gradient pattern.

Embodiment C-20 is the method of any of the preceding Embodiments C, wherein the metal substrate is a cryogenically cleaned metal substrate.

Embodiment C-21 is the method of any of the preceding Embodiments C, further comprising cryogenically cleaning the metal substrate prior to directing each of the powder coating composition(s) to at least a portion of the metal substrate.

Embodiment C-22 is the method of any of the preceding Embodiments C, wherein the metal substrate has an average thickness of up to 635 microns (or up to 375 microns).

Embodiment C-23 is the method of any of the preceding Embodiments C, wherein the metal substrate has an average thickness of at least 125 microns.

Embodiment C-24 is the method of any of the preceding Embodiments C, wherein the hardened adherent patterned coating has an average total thickness of up to 100 microns, or a maximum total thickness up to 100 microns.

Embodiment C-25 is the method of Embodiment C-24, wherein the hardened adherent patterned coating has an average total thickness of up to 50 microns, preferably up to 25 microns (e.g., up to 20 microns, up to 15 microns, up to 10 microns, or up to 5 microns).

Embodiment C-26 is the method of any of the preceding Embodiments C, wherein the hardened adherent patterned coating has an average total thickness, or a minimum thickness, of at least 1 micron (or at least 2 microns, at least 3 microns, or at least 4 microns).

Embodiment C-27 is the method of any of the preceding Embodiments C, wherein one or more of the powder coating compositions comprise powder polymer particles (preferably, chemically produced powder polymer particles, such as those produced by spray drying or limited coalescence) comprising a polymer having a number average molecular weight of at least 2000 Daltons (or at least 5,000 Daltons, at least 10,000 Daltons, or at least 15,000 Daltons).

Embodiment C-28 is the method of any of the preceding Embodiments C, wherein one or more of the powder coating compositions comprise powder polymer particles comprising a polymer having a number average molecular weight of up to 10,000,000 Daltons (or up to 1,000,000 Daltons, up to 100,000 Daltons, or up to 20,00 Daltons).

Embodiment C-29 is the method of any of the preceding Embodiments C, wherein one or more of the powder coating compositions comprise powder polymer particles comprising a polymer having a polydispersity index (Mw/Mn) of less than 4 (or less than 3, less than 2, or less than 1.5).

Embodiment C-30 is the method of any of Embodiments C-27 through C-29, wherein one or more of the powder coating compositions comprise the polymer in an amount of at least 40 wt-%, at least 50 wt-%, at least 60 wt-%, at least 70 wt-%, at least 80 wt-%, at least 90 wt-%, or at least 95 wt-%.

Embodiment C-31 is the method of any of the preceding Embodiments C, wherein one or more of the powder coating compositions comprise powder polymer particles having a particle size distribution having a D50 of less than 25 microns (or less than 20 microns, less than 15 microns, or less than 10 microns).

Embodiment C-32 is the method of any of the preceding Embodiments C, wherein one or more of the powder coating compositions comprise powder polymer particles having a particle size distribution having a D90 of less than 25 microns (or less than 20 microns, less than 15 microns, or less than 10 microns).

Embodiment C-33 is the method of any of the preceding Embodiments C, wherein one or more of the powder coating compositions comprise the powder polymer particles in an amount of at least 40 wt-%, at least 50 wt-%, at least 60 wt-%, at least 70 wt-%, at least 80 wt-%, or at least 90 wt-%.

Embodiment C-34 is the method of any of the preceding Embodiments C, wherein one or more of the powder coating compositions comprise the powder polymer particles in an amount of up to 100 wt-%, up to 99.99 wt-%, up to 95 wt-%, or up to 90 wt-%.

Embodiment C-35 is the method of any of the preceding Embodiments C, wherein one or more of the powder coating compositions comprise one or more charge control agents in contact with the powder polymer particles, and/or magnetic carrier particles, which may or may not be in contact with the powder polymer particles.

Embodiment C-36 is the method of Embodiment C-35, wherein one or more of the powder coating compositions comprise one or more charge control agents in an amount of at least 0.01 wt-%, at least 0.1 wt-%, or at least 1 wt-%.

Embodiment C-37 is the method of Embodiment C-35 or C-36, wherein one or more of the powder coating compositions comprise one or more charge control agents in an amount of up to 10 wt-%, up to 9 wt-%, up to 8 wt-%, up to 7 wt-%, up to 6 wt-%, up to 5 wt-%, up to 4 wt-%, or up to 3 wt-%.

Embodiment C-38 is the method of any of Embodiments C-35 through C-37, wherein the one or more charge control agents enables the powder polymer particles to efficiently accept a triboelectric charge to facilitate application to a substrate.

Embodiment C-39 is the method of any of Embodiments C-35 through C-38, wherein the one or more charge control agents comprise particles having particle sizes in the sub-micron range (e.g., less than 1 micron, 100 nanometers or less, 50 nanometers or less, or 20 nanometers or less).

Embodiment C-40 is the method of any of Embodiments C-35 through C-39, wherein the one or more charge control agents comprise hydrophilic fumed aluminum oxide particles, hydrophilic precipitated sodium aluminum silicate particles, metal carboxylate and sulfonate particles, quaternary ammonium salts (e.g., quaternary ammonium sulfate or sulfonate particles), polymers containing pendant quaternary ammonium salts, ferromagnetic pigments, transition metal particles, nitrosine or azine dyes, copper phthalocyanine pigments, metal complexes of chromium, zinc, aluminum, zirconium, calcium, or combinations thereof.

Embodiment C-41 is the method of any of Embodiments C-35 through C-40, wherein the one or more charge control agents comprise inorganic particles.

Embodiment C-42 is the method of any of the preceding Embodiments C, wherein directing one or more of the powder coating composition comprises directing one or more of the powder coating compositions (preferably, triboelectrically charged powder coating composition) to at least a portion of the metal substrate by means of an electric or electromagnetic field, or any other suitable type of applied field.

Embodiment C-43 is the method of Embodiment C-42, wherein directing one or more of the powder coating compositions comprise directing one or more of the powder coating compositions to at least a portion of the metal substrate by means of an electric field.

Embodiment C-44 is the method of any of the preceding Embodiments C, wherein directing one or more of the powder coating compositions to at least a portion of the metal substrate comprises: feeding one or more of the powder coating compositions to one or more transporters; and directing the one or more of the powder coating compositions from the one or more transporters to at least a portion of the metal substrate by means of an electromagnetic field. The one or more transporter may comprise a transporter surface, imaging member, and/or intermediate transfer member.

Embodiment C-45 is the method of Embodiment C-44, wherein directing one or more of the powder coating composition from the one or more transporters comprise directing the one or more of the powder coating compositions from the one or more transporters to at least a portion of the metal substrate by means of an electric field between the transporter and the metal substrate.

Embodiment C-46 is the method of Embodiment C-44 or C-45, wherein directing one or more of the powder coating compositions from the one or more transporters comprise: directing the one or more of the powder coating compositions from the one or more transporters to one or more transfer members by means of an electric field between the transporter and the transfer member; and transferring the one or more of the powder coating compositions from the one or more transfer members to at least a portion of the metal substrate. Or, directing the one or more of the powder coating compositions from the one or more transporters to one or more imaging members by means of an electric field between the transporter and the imaging member, and directing the powder coating composition from the one or more imaging members to the one or more transfer members by means of an electric field between the imaging member and the transfer member; and transferring the one or more of the powder coating compositions from the one or more transfer members to at least a portion of the metal substrate.

Embodiment C-47 is the method of Embodiment C-46, wherein the one or more transfer members comprises a semiconductive or insulative polymeric belt

Embodiment C-48 is the method of Embodiment C-46 or C-47, wherein transferring the one or more of the powder coating compositions from the one or more transfer members to at least a portion of the metal substrate comprises applying thermal energy, or electrical, electrostatic, or mechanical forces to effect the transfer.

Embodiment C-49 is the method of any of Embodiments C-44 through C-48, wherein the one or more transporters comprise a magnetic roller, polymeric conductive roller, polymeric semiconductive roller, metallic belt, polymeric conductive belt, or polymeric semiconductive belt; and the one or more of the powder coating compositions comprise magnetic carrier particles.

Embodiment C-50 is the method of any of the preceding Embodiments C, wherein providing conditions effective for one or more of the powder coating compositions to form a hardened coating on at least a portion of the metal substrate comprises applying thermal energy (e.g., using a convection oven or induction coil), UV radiation, IR radiation, or electron beam radiation to the one or more of the powder coating compositions.

Embodiment C-51 is the method of Embodiment C-50, wherein providing conditions comprise applying thermal energy.

Embodiment C-52 is the method of Embodiment C-51, wherein applying thermal energy comprises applying thermal energy at a temperature of at least 100° C. or at least 177° C.

Embodiment C-53 is the method of Embodiment C-51 or C-52, wherein applying thermal energy comprises applying thermal energy at a temperature of up to 300° C. or up to 250° C.

Embodiment C-54 is the method of any of the preceding Embodiments C, wherein the metal substrate comprises steel, stainless steel, electrogalvanized steel, tin-free steel (TFS), tin-plated steel, electrolytic tin plate (ETP), or aluminum.

Embodiment C-55 is the method of any of the preceding Embodiments C, wherein one or more of the powder coating compositions comprise chemically produced powder polymer particles (as opposed to mechanically produced (e.g., ground) polymer particles). Embodiment C-56 is the method of any of the preceding Embodiments C, wherein one or more of the powder coating compositions comprise powder polymer particles having a shape factor of 100-140 (spherical and potato shaped) (or 120-140 (e.g., potato shaped)).

Embodiment C-57 is the method of any of the preceding Embodiments C, wherein one or more of the powder coating compositions comprise powder polymer particles having a compressibility index of 1 to 50 (or 1 to 10, 11 to 15, 16 to 20, 21 to 35, or 36 to 50), and a Haussner Ratio of 1.00 to 2.00 (or 1.00 to 1.11, 1.12 to 1.18, 1.19 to 1.25, 1.26 to 1.50, or 1.51 to 2.00).

Embodiment C-58 is the method of any of the preceding Embodiments C, wherein one or more of the powder coating compositions comprise powder polymer particles comprising a thermoplastic polymer.

Embodiment C-59 is the method of any of the preceding Embodiments C, wherein one or more of the powder coating compositions comprise powder polymer particles comprising a polymer having a melt flow index greater than 15 grams/10 minutes, greater than 50 grams/10 minutes, or greater than 100 grams/10 minutes, and preferably, a melt flow index of up to 200 grams/10 minutes, or up to 150 grams/10 minutes.

Embodiment C-60 is the method of any of the preceding Embodiments C, wherein one or more of the powder coating compositions comprise powder polymer particles comprising a polymer having a glass transition temperature (Tg) of at least 40° C., at least 50° C., at least 60° C., or at least 70° C.

Embodiment C-61 is the method of any of the preceding Embodiments C, wherein one or more of the powder coating compositions comprise powder polymer particles comprising a polymer having a Tg of up to 150° C., up to 125° C., up to 110° C., up to 100° C., or up to 80° C.

Embodiment C-62 is the method of any of the preceding Embodiments C, wherein the hardened coating does not have any detectable Tg.

Embodiment C-63 is the method of any of the preceding Embodiments C, wherein one or more of the powder coating compositions comprise powder polymer particles comprising a crystalline or semi-crystalline polymer having a melting point of at least 40° C. and up to 300° C.

Embodiment C-64 is the method of any of the preceding Embodiments C, wherein one or more of the powder coating compositions comprise powder polymer particles comprising a polymer selected from a polyacrylic (e.g., a solution-polymerized acrylic polymer, an emulsion polymerized acrylic polymer, or combination thereof), polyether, polyolefin, polyester, polyurethane, polycarbonate, polystyrene, or a combination thereof (i.e., copolymer or mixture thereof such polyether-acrylate copolymer).

Embodiment C-65 is the method of Embodiment C-64, wherein one or more of the powder coating compositions comprise powder polymer particles comprising a polymer selected from a polyacrylic, polyether, polyolefin, polyester, or a combination thereof.

Embodiment C-66 is the method of any of the preceding Embodiments C, wherein one or more of the powder coating compositions comprise one or more optional additives selected from lubricants, adhesion promoters, crosslinkers, catalysts, colorants (e.g., pigments or dyes), ferromagnetic pigments, degassing agents, levelling agents, wetting agents, matting agents, surfactants, flow control agents, heat stabilizers, anti-corrosion agents, adhesion promoters, inorganic fillers, metal driers, and combinations thereof.

Embodiment C-67 is the method of Embodiment C-66, wherein one or more of the powder coating compositions comprise one or more lubricants, which is incorporated into the hardened coating.

Embodiment C-68 is the method of any of the preceding Embodiments C, further comprising depositing a powdered lubricant on the patterned coating.

Embodiment C-69 is the method of Embodiment C-67 or C-68, wherein the one or more lubricants are present in or on the hardened coating in an amount of at least 0.1 wt-%, at least 0.5 wt-%, or at least 1 wt-%, based on the total weight of the overall hardened coating.

Embodiment C-70 is the method of any of Embodiments C-67 through C-69, wherein the one or more lubricants are present in or on the hardened coating in an amount of up to 4 wt-%, up to 3 wt-%, or up to 2 wt-%, based on the total weight of the overall hardened coating.

Embodiment C-71 is the method of any of Embodiments C-67 through C-70, wherein the lubricant comprises carnauba wax, synthetic wax (e.g., Fischer-Tropsch wax), polytetrafluoroethylene (PTFE) wax, polyolefin wax (e.g., polyethylene (PE) wax, polypropylene (PP) wax, and high-density polyethylene (HDPE) wax), amide wax (e.g., micronized ethylene-bis-stearamide (EBS) wax), combinations thereof, and modified version thereof (e.g., amide-modified PE wax, PTFE-modified PE wax, and the like).

Embodiment C-72 is the method of any of the preceding Embodiments C, wherein one or more of the powder polymer compositions comprise powder polymer particles comprising agglomerates (i.e., clusters) of primary polymer particles.

Embodiment C-73 is the method of any of the preceding Embodiments C, wherein one or more of the powder coating compositions are substantially free of each of bisphenol A, bisphenol F, and bisphenol S.

Embodiment C-74 is the method of any of the preceding Embodiments C, wherein one or more of the powder coating compositions are substantially free of all bisphenol compounds, except for TMBPF.

Embodiment C-75 is the method of any of the preceding Embodiments C, wherein one or more of the powder coating compositions are substantially free of each of formaldehyde and formaldehyde-containing ingredients (e.g., phenol-formaldehyde resins).

Embodiment C-76 is the method of any of the preceding Embodiments C, wherein the hardened coating includes less than 50 ppm, less than 25 ppm, less than 10 ppm, or less than 1 ppm, extractables, if any, when tested pursuant to the Global Extraction Test.

Embodiment C-77 is the method of any of the preceding Embodiments C, wherein the hardened coating adheres to a substrate, such as a metal substrate, according to the Adhesion Test with an adhesion rating of 9 or 10, preferably 10.

Embodiment C-78 is the method of any of the preceding Embodiments C, wherein the hardened coating is free of pinholes and other coating defects that result in exposed substrate.

Embodiment C-79 is the method of any of the preceding Embodiments C, wherein one or more of the powder coating compositions which, when applied to a cleaned and pretreated aluminum panel and subjected to a curative bake for an appropriate duration to achieve a 242° C. peak metal temperature (PMT) and a dried film thickness of approximately 7.5 milligram per square inch and formed into a fully converted 202 standard opening beverage can end, pass less than 5 milliamps of current while being exposed for 4 seconds to an electrolyte solution containing 1% by weight of NaCl dissolved in deionized water.

Embodiment C-80 is the method of any of the preceding Embodiments C, wherein the metal substrate is provided as a coil and the method is a coil-coating process.

Embodiment C-81 is the method of any of Embodiments C-1 through C-80, wherein the metal substrate is provided as a sheet and the method is a sheet-coating process.

Embodiment C-82 is the method of any of Embodiments C-1 through C-81, wherein the metal substrate is provided as a preformed container (e.g., can or cup).

Embodiment C-83 is a pattern-coated metal substrate having a surface at least partially coated with a coating prepared by the method of any of the preceding Embodiments C.

Embodiment C-84 is a pattern-coated metal substrate suitable for use in forming metal packaging (e.g., a food, beverage, aerosol, or general packaging container (e.g., can or cup), portion thereof, metal closure, or pull tab for an easy open end), wherein at least a portion of the metal substrate has a surface coated with a hardened adherent patterned coating comprising fused powder polymer particles (preferably, chemically produced powder polymer particles, such as those produced by spray drying or limited coalescence).

Embodiment C-85 is the pattern-coated metal substrate of Embodiment C-84, wherein the substrate is a drawn and redrawn substrate.

Embodiment C-86 is the pattern-coated metal substrate of Embodiment C-84, wherein the metal substrate is tab stock.

Embodiment C-87 is the pattern-coated metal substrate of Embodiment C-84, wherein the metal substrate is aluminum coil for making beverage can ends.

Embodiment C-88 is the pattern-coated metal substrate of any one of Embodiments C-83 through C-87, wherein at least a portion of the patterned coating has a glossy finish.

Embodiment C-89 is the pattern-coated metal substrate of any one of Embodiments C-83 through C-88, wherein at least a portion of the patterned coating has a matte finish.

Embodiment C-90 is metal packaging (e.g., a metal packaging container such as a food, beverage, aerosol, or general packaging container (e.g., can or cup), a portion thereof, a metal closure, or pull tab) comprising a metal substrate having a surface at least partially coated with a coating prepared by the method of any of Embodiments C-1 through C-82.

Embodiment C-91 is metal packaging (e.g., a metal packaging container such as a food, beverage, aerosol, or general packaging container (e.g., can or cup), a portion thereof, a metal closure, or pull tab) comprising the pattern-coated metal substrate of any of Embodiments C-83 through C-90.

Embodiment C-92 is the metal packaging of Embodiment C-90 or C-91, wherein the surface is an interior surface, an exterior surface, or both, of a container (e.g., can or cup) body.

Embodiment C-93 is the metal packaging of any of Embodiments C-90 through C-92, wherein the surface is a surface of a riveted can end and/or a pull tab.

Embodiment C-94 is the metal packaging of any of Embodiments C-90 through C-93, which is filled with a food, beverage, or aerosol product.

Embodiment C-95 is a packaging coating system for patterned coating, comprising: one or more metal packaging powder coating compositions; wherein each powder coating composition comprises powder polymer particles comprising a polymer having a number average molecular weight of at least 2000 Daltons, wherein the powder polymer particles have a particle size distribution having a D50 of less than 25 microns (wherein the powder polymer particles are preferably formed, e.g., via spray drying or limited coalescence, to have a suitable regular particle shape and morphology—unlike ground particles); and instructions comprising: directing the one or more powder coating compositions to at least a portion of the metal substrate to form a patterned coating; and providing conditions effective for the one or more powder coating compositions to form a hardened adherent patterned coating (which may or may not be continuous) on at least a portion of the metal substrate.

Embodiment C-96 is the system of Embodiment C-95 comprising at least two different metal packaging powder coating compositions that differ in one or more chemical or physical properties.

Embodiment C-97 is the system of Embodiment C-96, wherein the properties include polymer particle properties (such as molecular weight, density, glass transition temperature (Tg), melting temperature (Tm), intrinsic viscosity (IV), melt viscosity (MV), melt index (MI), crystallinity, arrangement of blocks or segments, availability of reactive sites, reactivity, acid number), and coating composition properties (such as surface energy, hydrophobicity, oleophobicity, moisture or oxygen permeability, transparency, heat resistance, resistance to sunlight or ultraviolet energy, adhesion to metals, color or other visual effects, and recyclability).

Embodiment C-98 is the system of Embodiment C-96 or C-97, wherein a particular property of at least two different powder coating compositions differ by at least ±5%, at least +10%, at least ±15%, at least ±25%, at least ±50%, at least ±100%, or more.

Embodiment C-99 is the system of any of Embodiment A-95 to A-98, wherein the system comprises a plurality of cartridges, wherein each cartridge of the plurality of cartridges contains a powder coating composition, and wherein at least two cartridges of the plurality of cartridges contain different powder coating compositions.

Embodiment C-100 is the system of Embodiment C-99, wherein the different powder coating compositions comprise differently colored powder coating composition.

Embodiment C-101 is the system of Embodiment C-99 or C-100, wherein the cartridges are refillable and reusable.

Embodiment C-102 is the method of any one of Embodiments C-1 to C-82, wherein the method comprises electrically grounding the metal substrate while directing at least one powder coating composition of the multiple powder coating compositions to the at least a portion of the substrate.

Embodiment C-103 is the method of Embodiment C-102, wherein the method comprises electrostatically adhering at least one powder coating of the multiple powder coating compositions to a transporter surface, imaging member, and/or intermediate transfer member, before directing each of the multiple powder coating compositions to at least a portion of the metal substrate; wherein electrostatically adhering the at least one powder coating composition comprises electrically biasing the transporter surface, imaging member, and/or intermediate transfer member to a non-zero voltage before electrostatically adhering the at least one powder coating composition to the transporter surface, imaging member, and/or intermediate transfer member.

Embodiment C-104 is the method of Embodiment C-103, wherein a first deposited powder coating composition is at a first polarity, and the method further includes changing the first polarity of the first deposited powder coating composition to a second polarity, and applying a second coating composition at a second polarity to the first deposited powder coating composition.

### Embodiments D: Methods of Making Metal Packaging—all in One Location and/or in One Continuous Manufacturing Line or Process

Embodiment D-1 is a method of making metal packaging (e.g., a metal packaging container such as a food, beverage, aerosol, or general packaging container (e.g., can or cup), a portion thereof, or a metal closure such as for a metal packaging container or a glass jar) in one location and/or in one continuous manufacturing line or process, the method comprising: providing a metal substrate; providing a metal packaging powder coating composition, wherein the powder coating composition comprises powder polymer particles (preferably, chemically produced powder polymer particles, such as those produced by spray drying or limited coalescence); directing the powder coating composition to at least a portion of the metal substrate; providing conditions effective for the powder coating composition to form a hardened, preferably continuous, adherent coating on at least a portion of the metal substrate; and forming the at least partially coated metal substrate into at least a portion of a metal packaging container (e.g., a food, beverage, aerosol, or general packaging container (e.g., can or cup)), a portion thereof, or a metal closure (e.g., for a metal packaging container or a glass jar).

Embodiment D-2 is the method of Embodiment D-1, wherein directing the powder coating composition to at least a portion of the metal substrate comprise forming a patterned coating (as described in Embodiments C).

Embodiment D-3 is the method of Embodiment D-1 or D-2, wherein: providing a metal packaging powder coating composition comprises providing multiple metal packaging powder coating compositions, wherein each powder coating composition comprises powder polymer particles (preferably, chemically produced powder polymer particles, such as those produced by spray drying or limited coalescence), and at least two of the multiple metal packaging powder coating compositions are different; directing the powder coating composition comprises directing each of the multiple powder coating compositions to at least a portion of the metal substrate such that at least one powder coating composition is optionally deposited on another different powder coating composition to form a coating (as described in Embodiments B); and providing conditions comprises providing conditions effective for each of the multiple powder coating compositions to form a hardened, preferably continuous, adherent coating.

Embodiment D-4 is the method of Embodiment D-3, wherein providing conditions comprises providing conditions effective for each of the powder coating compositions to form a hardened, preferably continuous, adherent coating between depositing layers of different powder coating compositions.

Embodiment D-5 is the method of Embodiment D-3, wherein providing conditions effective comprises providing conditions effective for each of the powder coating compositions to form a hardened, preferably continuous, adherent coating after depositing all the layers of different powder coating compositions.

Embodiment D-6 is the method of any of Embodiments D-3 through D-5, wherein the different powder coating compositions are chemically different.

Embodiment D-7 is the method of Embodiment D-6, wherein the different powder coating compositions are in different colors, and the method results in color-on-color printing.

Embodiment D-8 is the method of Embodiment D-7, wherein the powder coating composition deposited as the outermost (i.e., top) coating forms a clear coating.

Embodiment D-9 is the method of any of Embodiments D-3 through D-8, wherein the different powder coating compositions provide different functions.

Embodiment D-10 is the method of Embodiment D-9, wherein a first powder coating composition is deposited to provide a relatively soft, flexible, primer layer, and a second powder coating composition is deposited on the first powder coating composition to provide a relatively hard, abrasion-resistant top coating.

Embodiment D-11 is the method of any of Embodiments D-3 through D-10, wherein the different powder coating compositions are deposited in different amounts to form coating layers having different thicknesses.

Embodiment D-12 is the method of any of the preceding Embodiments D, wherein the patterned coating forms a textured surface.

Embodiment D-13 is the method of any of Embodiments D-1 through D-11, wherein the multiple powder coating compositions are deposited in a manner to form a smooth surface.

Embodiment D-14 is the method of any of the preceding Embodiments D, wherein the patterned coating forms markings.

Embodiment D-15 is the method of any of the preceding Embodiments D, wherein the metal substrate is a cryogenically cleaned metal substrate.

Embodiment D-16 is the method of any of the preceding Embodiments D, further comprising cryogenically cleaning the metal substrate prior to directing each of the powder coating composition(s) to at least a portion of the metal substrate.

Embodiment D-17 is the method of any of the preceding Embodiments D, wherein the metal substrate has an average thickness of up to 635 microns (or up to 375 microns).

Embodiment D-18 is the method of any of the preceding Embodiments D, wherein the metal substrate has an average thickness of at least 125 microns.

Embodiment D-19 is the method of any of the preceding Embodiments D, wherein the hardened adherent coating has an average total thickness of up to 100 microns, or a maximum thickness up to 100 microns.

Embodiment D-20 is the method of Embodiment D-19, wherein the hardened adherent coating has an average total thickness of up to 50 microns, preferably up to 25 microns (e.g., up to 20 microns, up to 15 microns, up to 10 microns, or up to 5 microns).

Embodiment D-21 is the method of any of the preceding Embodiments D, wherein the hardened adherent coating has an average total thickness, or a minimum thickness, of at least 1 micron (or at least 2 microns, at least 3 microns, or at least 4 microns).

Embodiment D-22 is the method of any of the preceding Embodiments D, wherein one or more of the powder coating compositions comprise powder polymer particles (preferably, chemically produced powder polymer particles, such as those produced by spray drying or limited coalescence) comprising a polymer having a number average molecular weight of at least 2000 Daltons (or at least 5,000 Daltons, at least 10,000 Daltons, or at least 15,000 Daltons).

Embodiment D-23 is the method of any of the preceding Embodiments D, wherein one or more of the powder coating compositions comprise powder polymer particles comprising a polymer having a number average molecular weight of up to 10,000,000 Daltons (or up to 1,000,000 Daltons, up to 100,000 Daltons, or up to 20,00 Daltons).

Embodiment D-24 is the method of any of the preceding Embodiments D, wherein one or more of the powder coating compositions comprise powder polymer particles comprising a polymer having a polydispersity index (Mw/Mn) of less than 4 (or less than 3, less than 2, or less than 1.5).

Embodiment D-25 is the method of any of the preceding Embodiments D, wherein one or more of the powder coating compositions comprise the polymer in an amount of at least 40 wt-%, at least 50 wt-%, at least 60 wt-%, at least 70 wt-%, at least 80 wt-%, at least 90 wt-%, or at least 95 wt-%.

Embodiment D-26 is the method of any of the preceding Embodiments D, wherein one or more of the powder coating compositions comprise powder polymer particles having a particle size distribution having a D50 of less than 25 microns (or less than 20 microns, less than 15 microns, or less than 10 microns).

Embodiment D-27 is the method of any of the preceding Embodiments D, wherein one or more of the powder coating compositions comprise powder polymer particles having a particle size distribution having a D90 of less than 25 microns (or less than 20 microns, less than 15 microns, or less than 10 microns).

Embodiment D-28 is the method of any of the preceding Embodiments D, wherein one or more of the powder coating compositions comprise the powder polymer particles in an amount of at least 40 wt-%, at least 50 wt-%, at least 60 wt-%, at least 70 wt-%, at least 80 wt-%, or at least 90 wt-%.

Embodiment D-29 is the method of any of the preceding Embodiments D, wherein one or more of the powder coating compositions comprise the powder polymer particles in an amount of up to 100 wt-%, up to 99.99 wt-%, up to 95 wt-%, or up to 90 wt-%.

Embodiment D-30 is the method of any of the preceding Embodiments D, wherein one or more of the powder coating compositions comprise one or more charge control agents in contact with the powder polymer particles, and/or magnetic carrier particles, which may or may not be in contact with the powder polymer particles.

Embodiment D-31 is the method of Embodiment D-30, wherein one or more of the powder coating compositions comprise one or more charge control agents in an amount of at least 0.01 wt-%, at least 0.1 wt-%, or at least 1 wt-%.

Embodiment D-32 is the method of Embodiment D-30 or D-31, wherein one or more of the powder coating compositions comprise one or more charge control agents in an amount of up to 10 wt-%, up to 9 wt-%, up to 8 wt-%, up to 7 wt-%, up to 6 wt-%, up to 5 wt-%, up to 4 wt-%, or up to 3 wt-%.

Embodiment D-33 is the method of any of Embodiments D-30 through D-32, wherein the one or more charge control agents enables the powder polymer particles to efficiently accept a triboelectric charge to facilitate application to a substrate.

Embodiment D-34 is the method of any of Embodiments D-30 through D-33, wherein the one or more charge control agents comprise particles having particle sizes in the sub-micron range (e.g., less than 1 micron, 100 nanometers or less, 50 nanometers or less, or 20 nanometers or less).

Embodiment D-35 is the method of any of Embodiments D-30 through D-34, wherein the one or more charge control agents comprise hydrophilic fumed aluminum oxide particles, hydrophilic precipitated sodium aluminum silicate particles, metal carboxylate and sulfonate particles, quaternary ammonium salts (e.g., quaternary ammonium sulfate or sulfonate particles), polymers containing pendant quaternary ammonium salts, ferromagnetic pigments, transition metal particles, nitrosine or azine dyes, copper phthalocyanine pigments, metal complexes of chromium, zinc, aluminum, zirconium, calcium, or combinations thereof.

Embodiment D-36 is the method of any of Embodiments D-30 through D-35, wherein the one or more charge control agents comprise inorganic particles.

Embodiment D-37 is the method of any of the preceding Embodiments D, wherein directing one or more of the powder coating composition comprises directing one or more of the powder coating compositions (preferably, triboelectrically charged powder coating composition) to at least a portion of the metal substrate by means of an electric or electromagnetic field, or any other suitable type of applied field.

Embodiment D-38 is the method of Embodiment D-37, wherein directing one or more of the powder coating compositions comprise directing one or more of the powder coating compositions to at least a portion of the metal substrate by means of an electric field.

Embodiment D-39 is the method of any of the preceding Embodiments D, wherein directing one or more of the powder coating compositions to at least a portion of the metal substrate comprises: feeding one or more of the powder coating compositions to one or more transporters; and directing the one or more of the powder coating compositions from the one or more transporters to at least a portion of the metal substrate by means of an electromagnetic field.

Embodiment D-40 is the method of Embodiment D-39, wherein directing one or more of the powder coating composition from the one or more transporters comprise directing the one or more of the powder coating compositions from the one or more transporters to at least a portion of the metal substrate by means of an electric field between the transporter and the metal substrate.

Embodiment D-41 is the method of Embodiment D-39 or D-40, wherein directing one or more of the powder coating compositions from the one or more transporters comprise: directing the one or more of the powder coating compositions from the one or more transporters to one or more transfer members by means of an electric field between the transporter and the transfer member; and transferring the one or more of the powder coating compositions from the one or more transfer members to at least a portion of the metal substrate.

Embodiment D-42 is the method of Embodiment D-41, wherein the one or more transfer members comprises a conductive metallic drum.

Embodiment D-43 is the method of Embodiment D-41 or D-42, wherein transferring the one or more of the powder coating compositions from the one or more transfer members to at least a portion of the metal substrate comprises applying thermal energy, or electrical, electrostatic, or mechanical forces to effect the transfer.

Embodiment D-44 is the method of any of Embodiments D-40 through D-44, wherein the one or more transporters comprise a magnetic roller, polymeric conductive roller, polymeric semiconductive roller, metallic belt, polymeric conductive belt, or polymeric semiconductive belt; and the one or more of the powder coating compositions comprise magnetic carrier particles.

Embodiment D-45 is the method of any of the preceding Embodiments D, wherein providing conditions effective for one or more of the powder coating compositions to form a hardened adherent coating on at least a portion of the metal substrate comprises applying thermal energy (e.g., using a convection oven or induction coil), UV radiation, IR radiation, or electron beam radiation to the one or more of the powder coating compositions.

Embodiment D-46 is the method of Embodiment D-45, wherein providing conditions comprise applying thermal energy.

Embodiment D-47 is the method of Embodiment D-46, wherein applying thermal energy comprises applying thermal energy at a temperature of at least 100° ° C. or at least 177° C.

Embodiment D-48 is the method of Embodiment D-46 or D-47, wherein applying thermal energy comprises applying thermal energy at a temperature of up to 300° C. or up to 250° C.

Embodiment D-49 is the method of any of the preceding Embodiments D, wherein the metal substrate comprises steel, stainless steel, electrogalvanized steel, tin-free steel (TFS), tin-plated steel, electrolytic tin plate (ETP), or aluminum.

Embodiment D-50 is the method of any of the preceding Embodiments D, wherein one or more of the powder coating compositions comprise chemically produced powder polymer particles (as opposed to mechanically produced (e.g., ground) polymer particles).

Embodiment D-51 is the method of any of the preceding Embodiments D, wherein one or more of the powder coating compositions comprise powder polymer particles having a shape factor of 100-140 (spherical and potato shaped) (or 120-140 (e.g., potato shaped)).

Embodiment D-52 is the method of any of the preceding Embodiments D, wherein one or more of the powder coating compositions comprise powder polymer particles having a compressibility index of 1 to 50 (or 1 to 10, 11 to 15, or 16 to 20), and a Haussner Ratio of 1.00 to 2.00 (or 1.00 to 1.11, 1.12 to 1.18, 1.19 to 1.25, 1.26 to 1.50, or 1.51 to 2.00).

Embodiment D-53 is the method of any of the preceding Embodiments D, wherein one or more of the powder coating compositions comprise powder polymer particles comprising a thermoplastic polymer.

Embodiment D-54 is the method of any of the preceding Embodiments D, wherein one or more of the powder coating compositions comprise powder polymer particles comprising a polymer having a melt flow index greater than 15 grams/10 minutes, greater than 50 grams/10 minutes, or greater than 100 grams/10 minutes, and preferably, a melt flow index of up to 200 grams/10 minutes, or up to 150 grams/10 minutes.

Embodiment D-55 is the method of any of the preceding Embodiments D, wherein one or more of the powder coating compositions comprise powder polymer particles comprising a polymer having a glass transition temperature (Tg) of at least 40° C., at least 50° C., at least 60° C., or at least 70° C.

Embodiment D-56 is the method of any of the preceding Embodiments D, wherein one or more of the powder coating compositions comprise powder polymer particles comprising a polymer having a Tg of up to 150° C., up to 125° C., up to 110° C., up to 100° C., or up to 80° C.

Embodiment D-57 is the method of any of the preceding Embodiments D, wherein the hardened coating does not have any detectable Tg.

Embodiment D-58 is the method of any of the preceding Embodiments D, wherein one or more of the powder coating compositions comprise powder polymer particles comprising a crystalline or semi-crystalline polymer having a melting point of at least 40° C. and up to 300° C.

Embodiment D-59 is the method of any of the preceding Embodiments D, wherein one or more of the powder coating compositions comprise powder polymer particles comprising a polymer selected from a polyacrylic (e.g., a solution-polymerized acrylic polymer, an emulsion polymerized acrylic polymer, or combination thereof), polyether, polyolefin, polyester, polyurethane, polycarbonate, polystyrene, or a combination thereof (i.e., copolymer or mixture thereof such polyether-acrylate copolymer).

Embodiment D-60 is the method of Embodiment D-59, wherein one or more of the powder coating compositions comprise powder polymer particles comprising a polymer selected from a polyacrylic, polyether, polyolefin, polyester, or a combination thereof.

Embodiment D-61 is the method of any of the preceding Embodiments D, wherein one or more of the powder coating compositions comprise one or more optional additives selected from lubricants, adhesion promoters, crosslinkers, catalysts, colorants (e.g., pigments or dyes), ferromagnetic pigments, degassing agents, levelling agents, wetting agents, matting agents, surfactants, flow control agents, heat stabilizers, anti-corrosion agents, adhesion promoters, inorganic fillers, metal driers, and combinations thereof.

Embodiment D-62 is the method of Embodiment D-61, wherein one or more of the powder coating compositions comprise one or more lubricants, which is incorporated into the hardened coating.

Embodiment D-63 is the method of any of the preceding Embodiments D, further comprising depositing a powdered lubricant on the patterned coating.

Embodiment D-64 is the method of Embodiment D-62 or D-63, wherein the one or more lubricants are present in or on the hardened coating in an amount of at least 0.1 wt-%, at least 0.5 wt-%, or at least 1 wt-%, based on the total weight of the overall hardened coating.

Embodiment D-65 is the method of any of Embodiments D-62 through D-64, wherein the one or more lubricants are present in or on the hardened coating in an amount of up to 4 wt-%, up to 3 wt-%, or up to 2 wt-%, based on the total weight of the overall hardened coating.

Embodiment D-66 is the method of any of Embodiments D-62 through D-65, wherein the lubricant comprises carnauba wax, synthetic wax (e.g., Fischer-Tropsch wax), polytetrafluoroethylene (PTFE) wax, polyolefin wax (e.g., polyethylene (PE) wax, polypropylene (PP) wax, and high-density polyethylene (HDPE) wax), amide wax (e.g., micronized ethylene-bis-stearamide (EBS) wax), combinations thereof, and modified version thereof (e.g., amide-modified PE wax, PTFE-modified PE wax, and the like).

Embodiment D-67 is the method of any of the preceding Embodiments D, wherein one or more of the powder polymer compositions comprise powder polymer particles comprising agglomerates (i.e., clusters) of primary polymer particles.

Embodiment D-68 is the method of any of the preceding Embodiments D, wherein one or more of the powder coating compositions are substantially free of each of bisphenol A, bisphenol F, and bisphenol S.

Embodiment D-69 is the method of any of the preceding Embodiments D, wherein one or more of the powder coating compositions are substantially free of all bisphenol compounds, except for TMBPF.

Embodiment D-70 is the method of any of the preceding Embodiments D, wherein one or more of the powder coating compositions are substantially free of each of formaldehyde and formaldehyde-containing ingredients (e.g., phenol-formaldehyde resins).

Embodiment D-71 is the method of any of the preceding Embodiments D, wherein the hardened coating includes less than 50 ppm, less than 25 ppm, less than 10 ppm, or less than 1 ppm, extractables, if any, when tested pursuant to the Global Extraction Test.

Embodiment D-72 is the method of any of the preceding Embodiments D, wherein the hardened coating adheres to a substrate, such as a metal substrate, according to the Adhesion Test with an adhesion rating of 9 or 10, preferably 10.

Embodiment D-73 is the method of any of the preceding Embodiments D, wherein the hardened coating is free of pinholes and other coating defects that result in exposed substrate.

Embodiment D-74 is the method of any of the preceding Embodiments D, wherein one or more of the powder coating compositions which, when applied to a cleaned and pretreated aluminum panel and subjected to a curative bake for an appropriate duration to achieve a 242° ° C. peak metal temperature (PMT) and a dried film thickness of approximately 7.5 milligram per square inch and formed into a fully converted 202 standard opening beverage can end, pass less than 5 milliamps of current while being exposed for 4 seconds to an electrolyte solution containing 1% by weight of NaCl dissolved in deionized water.

Embodiment D-75 is the method of any of the preceding Embodiments D, wherein forming the substrate into at least a portion of a metal packaging container comprises forming the substrate into a container (e.g., can or cup) body.

Embodiment D-76 is the method of Embodiment D-75, wherein forming the substrate into a container body comprises forming the substrate into a container body such that the hardened, preferably continuous, adherent coating forms an interior surface, an exterior surface, or both, of the container (e.g., can or cup) body.

Embodiment D-77 is the method of any of the preceding Embodiments D, wherein forming the substrate into at least a portion of a metal packaging container comprises forming the substrate into a metal closure (e.g., a twist-off cap for a metal packaging container or a glass jar).

Embodiment D-78 is the method of any of the preceding Embodiments D, wherein forming the substrate into at least a portion of a metal packaging container comprises forming the substrate into a riveted can end.

Embodiment D-79 is the method of any of the preceding Embodiments D, further comprising filling the metal packaging with a food, beverage, or aerosol product.

Embodiment D-80 is the method of any of the preceding Embodiments D, wherein providing a metal substrate comprises feeding the metal substrate at a rate of 50-100 feet, or 15-30 meters, per minute into a coating apparatus wherein the powder coating composition is directed to at least a portion of the metal substrate.

Embodiment D-81 is the method of any of the preceding Embodiments D, wherein before or after forming the at least partially coated metal substrate into at least a portion of a metal packaging container, a portion thereof, or a metal closure, the method includes a quality inspection step (e.g., visual inspection) to ensure proper formation of the hardened, preferably continuous, adherent coating.

Embodiment D-82 is the method of any one of Embodiments D, wherein the method comprises electrically grounding the metal substrate while directing at least one powder coating composition of the multiple powder coating compositions to the at least a portion of the substrate.

Embodiment D-83 is the method of Embodiment D-82, wherein the method comprises electrostatically adhering at least one powder coating of the multiple powder coating compositions to a transporter surface, imaging member, and/or intermediate transfer member, before directing each of the multiple powder coating compositions to at least a portion of the metal substrate; wherein electrostatically adhering the at least one powder coating composition comprises electrically biasing the transporter surface, imaging member, and/or intermediate transfer member to a non-zero voltage before electrostatically adhering the at least one powder coating composition to the transporter surface, imaging member, and/or intermediate transfer member.

Embodiment D-84 is the method of Embodiment D-83, wherein a first deposited powder coating composition is at a first polarity, and the method further includes changing the first polarity of the first deposited powder coating composition to a second polarity, and applying a second coating composition at a second polarity to the first deposited powder coating composition.

### Test Methods

Unless indicated otherwise, the following test methods may be utilized.

### Adhesion Test

Adhesion testing was performed according to ASTM D 3359-17 (2017), Test Method B, for coatings≤125 microns thick, using SCOTCH 610 tape (available from 3M Company of Saint Paul, MN) and a lattice pattern consisting of 4 scratches across and 4 scratches down (roughly 1-2 mm apart). The test is typically repeated 3 times per sample. Adhesion is rated on a scale of 0-10 where a rating of “10” indicates no adhesion failure, a rating of “9” indicates 90% of the coating remains adhered, a rating of “8” indicates 80% of the coating remains adhered, and so on. Adhesion ratings of 9 or 10 are typically desired for commercially viable coatings. Thus, herein, an adhesion rating of 9 or 10, preferably 10, is considered to be adherent.

### Differential Scanning Calorimetry for Tg

Samples of powder composition for differential scanning calorimetry (“DSC”) testing are weighed into standard sample pans, and analyzed using the standard DSC heat-cool-heat method. The samples are equilibrated at −60° C., then heated at 20° C. per minute to 200° C., cooled to −60° C., and then heated again at 20° C. per minute to 200° C. Glass transition temperatures are calculated from the thermogram of the last heat cycle. The glass transition is measured at the inflection point of the transition.

### Molecular Weight Determination by Gel Permeation Chromatography

Samples for Gel Permeation Chromatography (“GPC”) testing are prepared by first dissolving the powder polymer in a suitable solvent (e.g., THF if appropriate for a given powder polymer). An aliquot of this solution is then analyzed by GPC along with mixtures of polystyrene (“PS”) standards. The molecular weights of the samples are calculated after processing the GPC runs and verifying the standards.

### Global Extraction Test

The global extraction test is designed to estimate the total amount of mobile material that can potentially migrate out of a coating and into food packed in a coated can. Typically, a coated substrate is subjected to water or solvent blends under a variety of conditions to simulate a given end-use.

Acceptable extraction conditions and media can be found in 21 CFR § 175.300, paragraphs (d) and (e). The extraction procedure used in the current disclosure was conducted in accordance with the Food and Drug Administration (FDA) “Preparation of Premarket Submission for Food Contact Substances: Chemistry Recommendations,” (December 2007). The allowable global extraction limit as defined by the FDA regulation is 50 parts per million (ppm).

The single-sided extraction cells are made according to the design found in the Journal of the Association of Official Analytical Chemists, 47(2):387(1964), with minor modifications. The cell is 9 in (inches)×9 in×0.5 in with a 6 in×6 in open area in the center of the TEFLON spacer. This allows for 36 in² or 72 in² of test article to be exposed to the food simulating solvent. The cell holds 300 mL of food simulating solvent. The ratio of solvent to surface area is then 8.33 mL/in² and 4.16 mL/in² when 36 in² and 72 in² respectively of test article are exposed.

For the purpose of this disclosure, the test articles consist of 0.0082-inch-thick 5182 aluminum alloy panels, pretreated with PERMATREAT 1903 (supplied by Chemetall GmbH, Frankfurt am Main, Germany). These panels are coated with the test coating (completely covering at least the 6 in×6 in area required to fit the test cell) to yield a final, dry film thickness of 11 grams per square meter (gsm) following a 10 second curative bake resulting in a 242° ° C. peak metal temperature (PMT). Two test articles are used per cell for a total surface area of 72 in² per cell. The test articles are extracted in quadruplicate using 10% aqueous ethanol as the food-simulating solvent. The test articles are processed at 121° C. for two hours, and then stored at 40° C. for 238 hours. The test solutions are sampled after 2, 24, 96 and 240 hours. The test article is extracted in quadruplicate using the 10% aqueous ethanol under the conditions listed above.

Each test solution is evaporated to dryness in a preweighed 50 mL beaker by heating on a hot plate. Each beaker is dried in a 250° F.)(121° ° C. oven for a minimum of 30 minutes. The beakers are then placed into a desiccator to cool and then weighed to a constant weight. Constant weight is defined as three successive weighings that differ by no more than 0.00005 g.

Solvent blanks using Teflon sheet in extraction cells are similarly exposed to simulant and evaporated to constant weight to correct the test article extractive residue weights for extractive residue added by the solvent itself. Two solvent blanks are extracted at each time point and the average weight is used for correction.

Total nonvolatile extractives are calculated as follows:

$${E}_{x} = \frac{e}{s}$$

where: Ex=Extractive residues (mg/in²)
   e=Extractives per replicate tested (mg)
   S=Area extracted (in²)

Preferred coatings give global extraction results of less than 50 ppm, more preferred results of less than 10 ppm, even more preferred results of less than 1 ppm. Most preferably, the global extraction results are optimally non-detectable.

### Flat Panel Continuity Test

This test measures the continuity of a coating applied to a flat metal substrate and indicates the presence or absence of a continuous film, largely free of pores, cracks, or other defects that could expose the metal substrate. This method may be used for both laboratory and commercially coated steel and aluminum substrates. A test assembly is employed that consists of: a non-conducting, solid base (large enough to support the test panel); a hinged clamping mechanism that is mounted to the base; a non-conductive electrolyte holding cell, connected to the clamping mechanism in such a way that it can be lowered and sealed onto the test panel (resulting in a 6 inch-diameter, circular area on the test panel being exposed to the electrolyte); a hole in the electrolyte holding cell large enough to fill the cell with electrolyte; and an electrode inserted into the electrolyte holding cell. A WACO Enamel Rater II (available from the Wilkens-Anderson Company, Chicago, IL), with an output voltage of 6.3 volts is used in conjunction with the test assembly (as described below) to measure metal exposure in the form of electrical current. The electrolyte solution used in the following test consists of 1%-by-weight Sodium Chloride dissolved in deionized water.

An 8-inch by 8-inch panel of metal is coated and cured with the coating to be tested, as prescribed by the formula or technical data sheet. If no coating thickness or cure schedule is prescribed for the test coating, test panels should be coated in such a way to yield a final, dry film thickness of 11 grams per square meter (gsm) utilizing a curative bake with an appropriate duration to achieve a 242° C. peak metal temperature (PMT). Each test panel may only be used once and should be visibly free of scratches or abrasions. The test panel is placed in the test assembly with the test coating facing up. The electrolyte holding cell is then lowered onto the test panel and locked in place by closing the clamp. The positive lead wire from the enamel rater is connected to the edge of the panel in an area free of coating. A small area may need to be sanded or scraped to expose the bare metal substrate. The electrolyte cell is then filled with enough electrolyte solution to ensure contact with the cell's negative post. The negative lead wire from the enamel rater is connected to the negative post on top of the cell. Finally, the probe on the Waco enamel rater is lowered to activate the test current.

Film imperfections/failure will be indicated by a current flow measured in milliamps (mA). The initial milliamp reading is recorded for each panel tested, and results are reported in milliamps. If more than one determination per variable is run, the average reading is reported.

For purposes of this application, a continuous coating passes less than 200 mA when evaluated according to this test. Preferred coatings of the present disclosure pass less than 100 milliamps (mA), more preferably less than 50 mA, less than 10 mA, or less than 5 mA, most preferably less than 2 mA, and optimally less than 1 mA, according to this test.

### Flexibility Test

This test measures the ability of a coated substrate to retain its integrity as it undergoes the formation process necessary to produce a fabricated article such as a riveted beverage can end. It is a measure of the presence or absence of cracks or fractures in the formed end. The end is typically placed on a cup filled with an electrolyte solution. The cup is inverted to expose the surface of the end to the electrolyte solution. The intensity of the current that passes through the end is then measured. If the coating remains intact (no cracks or fractures) after fabrication, minimal current will pass through the end.

For the present evaluation, fully converted 202 standard opening beverage ends were exposed for a period of 4 seconds to a room-temperature electrolyte solution comprised of 1% NaCl by weight in deionized water. The coating to be evaluated was present on the interior surface of the beverage end at a dry film thickness of 6 to 7.5 milligrams per square inch (“msi”) (or 9.3 to 11.6 grams per square meter), with 7 msi being the target thickness and having been cured as prescribed by the formula or technical data sheet. If no cure schedule is prescribed for the test coating, test panels should be coated utilizing a curative bake with an appropriate duration to achieve a 242° C. peak metal temperature (PMT). Metal exposure was measured using a WACO Enamel Rater II (available from the Wilkens-Anderson Company, Chicago, IL) with an output voltage of 6.3 volts. The measured electrical current intensity, in milliamps, is reported. End continuities are typically tested initially and then after the ends are subjected to pasteurization, Dowfax, or retort.

Coatings of the present disclosure initially “pass” this test if they pass less than 200 milliamps (mA) of current. Preferred coatings of the present disclosure initially pass less than 100 milliamps (mA), more preferably less than 50 mA, less than 10 mA, or less than 5 mA, most preferably less than 2 mA, and optimally less than 1 mA, according to this test.

After pasteurization, Dowfax detergent test, or retort, preferred coatings give continuities of less than 20 mA, more preferably less than 10 mA, even more preferably less than 5 mA, and even more preferably less than 1 mA.

The complete disclosures of the patents, patent documents, and publications cited herein are incorporated by reference in their entirety as if each were individually incorporated. To the extent that there is any conflict or discrepancy between this specification as written and the disclosure in any document that is incorporated by reference herein, this specification as written will control. Various modifications and alterations to this disclosure will become apparent to those skilled in the art without departing from the scope and spirit of this disclosure. It should be understood that this disclosure is not intended to be unduly limited by the illustrative Embodiments And examples set forth herein and that such examples and Embodiments Are presented by way of example only with the scope of the disclosure intended to be limited only by the embodiments set forth herein as follows.

1. A cartridge-based delivery system comprising:
a plurality of cartridges, wherein each cartridge of the plurality of cartridges comprises:
a body defining an enclosed volume containing a metal packaging powder coating composition;
a dispensing port arranged to provide a path for the metal packaging powder coating composition during dispensing of the metal packaging powder coating composition from the cartridge; and
an optional inlet port configured to allow makeup air to enter the enclosed volume as the metal packaging powder coating composition is dispensed from the dispensing port;
wherein the metal packaging powder coating composition comprises powder polymer particles comprising a polymer having a number average molecular weight of at least 2000 Daltons, wherein the powder polymer particles have a particle size distribution having a D50 of less than 25 microns.

2. The cartridge-based delivery system of claim 1, wherein the enclosed volume of each cartridge of the plurality cartridges contains 0.001 cubic meter or more of the powder coating composition.

3. The cartridge-based delivery system of claim 1, wherein each cartridge comprises desiccant material exposed within the enclosed volume such that the makeup air passes through the desiccant material when entering the enclosed volume.

4. The cartridge-based delivery system of claim 1, wherein the powder polymer particles comprise powder polymer particles prepared by spray drying or limited coalescence.

5. The cartridge-based delivery system of claim 1, wherein the powder coating composition further comprises one or more charge control agents in contact with the powder polymer particles, and/or magnetic carrier particles, which may or may not be in contact with the powder polymer particles.

6. A method of coating a metal substrate suitable for use in forming metal packaging, the method comprising:
providing a metal substrate;
providing multiple metal packaging powder coating compositions, wherein at least two of the multiple metal packaging powder coating compositions are different;
directing each of the multiple powder coating compositions to at least a portion of the metal substrate such that at least one powder coating composition is deposited on another different powder coating composition; and
providing conditions effective for the multiple powder coating compositions to form a hardened continuous adherent coating on at least a portion of the metal substrate;
wherein each metal packaging powder coating composition comprises powder polymer particles comprising a polymer having a number average molecular weight of at least 2000 Daltons, wherein the powder polymer particles have a particle size distribution having a D50 of less than 25 microns.

7. The method of claim 6, wherein the powder polymer particles comprise powder polymer particles prepared by spray drying or limited coalescence.

00. The method of claim 6, wherein the powder coating composition further comprises one or more charge control agents in contact with the powder polymer particles, and/or magnetic carrier particles, which may or may not be in contact with the powder polymer particles.

9. The method of claim 6, wherein the method comprises electrically grounding the metal substrate while directing at least one powder coating composition of the multiple powder coating compositions to the at least a portion of the substrate.

10. The method of claim 9, wherein the method comprises electrostatically adhering at least one powder coating of the multiple powder coating compositions to a transporter surface, imaging member, and/or intermediate transfer member, before directing each of the multiple powder coating compositions to at least a portion of the metal substrate; wherein electrostatically adhering the at least one powder coating composition comprises electrically biasing the transporter surface, imaging member, and/or intermediate transfer member to a non-zero voltage before electrostatically adhering the at least one powder coating composition to the transporter surface, imaging member, and/or intermediate transfer member.

11. The method of claim 10, wherein a first deposited powder coating composition is at a first polarity, and the method further includes changing the first polarity of the first deposited powder coating composition to a second polarity, and applying a second coating composition at the second polarity to the first deposited powder coating composition.

12. A method of coating a metal substrate suitable for use in forming metal packaging, the method comprising:
providing a metal substrate;
providing a metal packaging powder coating composition, wherein the powder coating composition comprises powder polymer particles;
selectively applying the powder coating composition on at least a portion of the metal substrate to form a patterned coating; and
providing conditions effective for the powder coating composition to form a hardened adherent patterned coating on at least a portion of the metal substrate.

13. The method of claim 12, wherein the powder polymer particles comprise powder polymer particles prepared by spray drying or limited coalescence.

14. The method of claim 12, wherein the powder coating composition further comprises one or more charge control agents in contact with the powder polymer particles, and/or magnetic carrier particles, which may or may not be in contact with the powder polymer particles.

15. The method of claim 12, wherein the method comprises electrically grounding the metal substrate while selectively applying the powder coating composition on the at least a portion of the substrate.

16. The method of claim 15, wherein the method comprises electrostatically adhering at least one powder coating of the multiple powder coating compositions to a transporter surface, imaging member, and/or intermediate transfer member, before directing each of the multiple powder coating compositions to at least a portion of the metal substrate; wherein electrostatically adhering the at least one powder coating composition comprises electrically biasing the transporter surface, imaging member, and/or intermediate transfer member to a non-zero voltage before electrostatically adhering the at least one powder coating composition to the transporter surface, imaging member, and/or intermediate transfer member.

17. A method of making metal packaging in one location and/or in one continuous manufacturing line or process, the method comprising:
providing a metal substrate;
providing a metal packaging powder coating composition, wherein the powder coating composition comprises powder polymer particles;
directing the powder coating composition to at least a portion of the metal substrate;
providing conditions effective for the powder coating composition to form a hardened continuous adherent coating on at least a portion of the metal substrate; and
forming the at least partially coated metal substrate into at least a portion of a metal packaging container, a portion thereof, or a metal closure.

18. The method of claim 17, wherein the powder polymer particles comprise powder polymer particles prepared by spray drying or limited coalescence.

19. The method of claim 17, wherein the powder coating composition further comprises one or more charge control agents in contact with the powder polymer particles, and/or magnetic carrier particles, which may or may not be in contact with the powder polymer particles.

20. The method of claim 17, wherein the method comprises electrically grounding the metal substrate while directing the powder coating composition to at least the portion of the metal substrate.
